(19) United States
(12) Patent Application Publication
(10) Pub. No.: US 2023/0287224 A1
(43) Pub. Date: Sep. 14, 2023

(54) pH-SENSITIVE CAPSULE AND RELEASE SYSTEM

(71) Applicants: Chao LI, Columbus, OH (US); Xiaolei GUO, Columbus, OH (US); Gerald FRANKEL, Columbus, OH (US); Ohio State Innovation Foundation, Columbus, OH (US)

(72) Inventors: Chao LI, Columbus, OH (US); Xiaolei GUO, Columbus, OH (US); Gerald FRANKEL, Columbus, OH (US)

(21) Appl. No.: 18/018,392

(22) PCT Filed: Jul. 29, 2021
(86) PCT No.: PCT/US21/43737

§ 371 Date: Jan. 27, 2023

Related U.S. Application Data
(60) Provisional application No. 63/058,328, filed on Jul. 29, 2020.

(51) Int. Cl. C09D 5/08; C09D 129/14; B01J 13/10; B01J 13/04

(52) U.S. Cl. CPC C09D 5/084; C09D 129/14; B01J 13/10; B01J 13/043

(57) ABSTRACT

A pH-sensitive release system comprising a capsule capable of releasing an agent in both low pH environments and high pH environments. The capsule encapsulates an SrCrO₄ agent and comprises at least two weak polyelectrolytes (e.g., PEI and PAA). The capsule responds to both low and high pH changes in the local environment by releasing the agent. The agent may include a corrosion inhibitor and may help prevent or ameliorate the effects of corrosion.

### CROSS-REFERENCE TO RELATED APPLICATION

This application claims the benefit of U.S. Provisional Patent Application Ser. No. 63/058,328 entitled “PH-SENSITIVE CAPSULE AND RELEASE SYSTEM” filed on Jul. 29, 2020 which is incorporated by reference in its entirety herein.

### TECHNICAL FIELD

The innovation relates to a pH sensitive release system, e.g., a corrosion inhibitor release system capable of releasing inhibitors in both low pH environments and high pH environments.

### BACKGROUND

Some smart coatings used for corrosion protection can respond to stimuli resulting from the corrosion process and release functional species inside the coatings to repair damage and/or inhibit further corrosion. Redox reactions during the corrosion process can result in a change in the pH within a coating. The pH change that occurs during corrosion has been used as the stimulus to trigger the release of these functional species. However, current coatings are limited such that they release agents under either acidic or basic pH. Thus, any corrosion protection occurs only in the area where there is either a net anodic or cathodic reaction, leading to a limited corrosion protection performance.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

According to an aspect, the innovation provides a pH-sensitive release system capable of releasing an agent in both low pH and high pH environments. In one embodiment, the pH-sensitive release system is a corrosion inhibitor release system capable of releasing inhibitors in both low pH environments and high pH environments. This corrosion inhibitor release system is able to heal voids/defects created by inhibitor consumption, thus, improving the long-term corrosion performance of coatings. It is also easier and less expensive to manufacture.

In one embodiment, the coating may comprise an encapsulated corrosion inhibitor (e.g., a microsphere). In one embodiment, the corrosion inhibitor system may include a micro-container or a nano-container comprising two weak polyelectrolytes. In one embodiment, the polyelectrolytes may be polyethylenimine (PEI) and polyacrylic acid (PAA).

In one embodiment, the inhibitor-loaded micro/nanocontainer may have a core-shell structure comprising Ce(NO₃)₃ and chitosan/polyacrylic acid polyelectrolyte coacervate.

In one embodiment, the system may comprise a pH-sensitive inhibitor-loaded micro/nanocontainer using polyelectrolyte coacervates as a shell material for the micro/nanocontainer. In one embodiment, the polyelectrolyte coacervates may comprise two weak polyelectrolytes including, but not limited to, branched polyethylenimine (PEI) and polyacrylic acid (PAA). In one embodiment, the coating formed by dip-coating the PEI/PAA polyelectrolyte coacervate onto substrates preloaded with a corrosion inhibitor. In one embodiment, the corrosion inhibitor may be strontium chromate (SrCrO₄).

In one aspect, the innovation provides a method of forming a corrosion inhibitor release system comprising forming a micro-container or a nano-container that encapsulates a corrosion inhibitor.

In one aspect, the innovation provides a method of forming nanofibers containing a corrosion inhibitor. In one embodiment, the nanofibers have a core-shell structure with a Ce(NO₃)₃ core and a chitosan/polyacrylic acid polyelectrolyte coacervate as the shell. In one embodiment, the nanofibers containing corrosion inhibitors are made using an electrospinnig technique.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic diagram of an embodiment of a method according to the innovation of the fabrication of vanadate-loaded nano-/micro-capsules using electrospray technique.

FIG. 2 is a schematic diagram of an embodiment of a method according to the innovation of the fabrication of a corrosion protection system using electrospray technique.

FIG. 3 is a diagram depicting testing of the PEI/PAA coacervate of varying molar ratios in varying pH environments.

FIG. 4 depicts results of testing of the PEI/PAA coacervate having a molar ratio of 1:1.

FIG. 5 depicts results of testing of the PEI/PAA coacervate having a molar ratio of 2:1.

FIG. 6 depicts results of testing of the PEI/PAA coacervate having a molar ratio of 1:2.

FIG. 7 is a schematic illustration of the PEI/PAA coacervate.

FIG. 8 is a graph depicting FTIR spectra of PEI, PAA, and the PEI/PAA coacervate deposited on polystyrene substrates.

FIG. 9A is a graph depicting cumulative release profiles of SrCrO₄ loaded polymer coatings made by the PEI/PAA coacervate in DI water with varied pH.

FIG. 9B is a schematic illustration of the pH-responsive behavior of the PEI/PAA coacervate.

FIGS. 10A-10C are SEM images of morphologies of (PEI/PAA)₇ coated glass slides before (on the top) and after immersion (on the bottom) in DI water with a) pH 2.5, b) pH 7, and c) pH 11 for 6 h. Scale bar is 350 μm.

FIGS. 11A-11C are graphs depicting cyclic potentiodynamic polarization curves of AA2024-T3 substrates immersed in deaerated 10 mM NaCl solutions or released media. The pH of the solutions was FIG. 11A: 7, FIG. 11B 2.5, and FIG. 11C: 11, adjusted by H2SO₄/NaOH.

FIGS. 12A-12C depict the surface topography of AA2024-T3 after cyclic potentiodynamic polarization acquired by an optical profilometer. AA2024-T3 substrates were polarized in deaerated solutions with FIG. 12A: pH 7, FIG. 12B: pH2.5, and FIG. 12C: pH 11. Scale bar is 400 μm.

FIG. 13 depicts optical profilometry images of the Al alloy matrix after cyclic potentiodynamic polarization conducted in 10 mM NaCl at pH 11.

FIGS. 14A-14C depict SEM-EDS results of AA2024-T3 after cyclic potentiodynamic polarization. AA2024-T3 substrates were polarized in released media with FIG. 14A: pH 2.5, FIG. 14B: pH 11, and FIG. 14C: pH 7. Scale bar is 10 μm.

FIGS. 15A-15C depict SEM images of the surface morphologies of AA2024-T3 coated with FIG. 15A: (PEI/PAA)₇, FIG. 15B: SrCrO₄, and FIG. 15C: (SrCrO₄)₃/(PEI/PAA)₇. Scale bar is 50 μm.

FIGS. 16A and 16B are SEM images of coated AA2024-T3 at a predetermined tilted angle. FIG. 16A: AA2024-T3 coated with (PEI/PAA)₇, FIG. 16B: AA2024-T3 coated with (SrCrO₄)₃/(PEI/PAA)₇. Scale bar is 10 μm.

FIGS. 17A-17B depict images of the surface topography of AA2024-T3 coated with a) (PEI/PAA)₇ and b) (SrCrO₄)₃/(PEI/PAA)₇ before corrosion. The figures were acquired by optical profilometry. Scale bar is 160 μm.

FIGS. 18A-18C are images depicting surface wettability of FIG. 18A: bare AA2024-T3 substrate, FIG. 18B AA2024-T3 coated with (PEI/PAA)₇, FIG. 18C AA2024-T3 coated with (SrCrO₄)₃/(PEI/PAA)₇ before corrosion.

FIGS. 19A-19F are graphs depicting EIS results acquired from AA2024-T3 coated with different coatings and corroded in 5 mM Na₂SO₄ at different pH. FIG. 19A: (SrCrO₄)₃/(PEI/PAA)₇ coated sample at pH 2.5, FIG. 19B: (PEI/PAA)₇ coated sample at pH 2.5;

FIG. 19C: (SrCrO₄)₃/(PEI/PAA)₇ coated sample at pH 11, FIG. 19D: (PEI/PAA)₇ coated sample at pH 11; FIG. 19E: (SrCrO₄)₃/(PEI/PAA)₇ coated sample at pH 7, and FIG. 19F: (PEI/PAA)₇ coated sample at pH 7.

FIGS. 20A-20B depicts schematics of equivalent circuits used to fit EIS data. a) equivalent circuit with one time constant b) equivalent circuit with two time constants.

FIGS. 21A-21C are graphs depicting Rₜₒₜₐₗ of (SrCrO₄)₃/(PEI/PAA)₇ and (PEI/PAA)₇ coated AA2024-T3 as a function of immersion time at FIG. 21A pH 2.5, FIG. 21B pH 11, and FIG. 21C pH 7. Solid and dash lines represent data from two replicate experiments.

FIG. 22A-22D are graphs depicting XPS analysis of the oxidation state of Cr existing on the surface of (SrCrO₄)₃/(PEI/PAA)₇ coated AA2024-T3. FIGS. 22A-22C: Cr 2p spectra collected from samples after EIS measurements conducted at FIG. 22A: pH 2.5, FIG. 22B: pH 11, and FIG. 22C: pH 7. FIG. 22D: Cr 2p spectrum collected from SrCrO₄ deposited on AA2024-T3.

FIG. 23 is a graph depicting XPS analysis of the oxidation state of Cr existing on (SrCrO₄)₃/(PEI/PAA)₇ coated AA2024-T3 prior to EIS measurements.

FIGS. 24A and 24B are graphs depicting EIS results of a) (SrCrO₄)₃/(PEI/PAA)₇ and b) (PEI/PAA)₇ coated AA2024-T3 immersed in 50 mM NaCl solutions. The solution pH was not adjusted.

FIG. 25 is a graph depicting EIS results of (SrCrO₄)₃/(PEI/PAA)₇ coated AA2024-T3 immersed in 50 mM NaCl solutions. The solution pH was not adjusted.

FIG. 26 is a graph depicting Rₜₒₜₐₗ of (SrCrO₄)₃/(PEI/PAA)₇ and (PEI/PAA)₇ coated AA2024-T3 immersed in 50 mM NaCl solutions as a function of immersion time. Solid and dash lines represent data from two replicate experiments.

FIG. 27 is a graph depicting XPS analysis of the oxidation state of Cr existing on (SrCrO₄)₃/(PEI/PAA)₇ coated AA2024-T3 after EIS measurements. The EIS measurement was conducted in 50 mM NaCl solution.

FIGS. 28A and 28B are schematic illustration of FIG. 28A: the preparation of (BB)₃/(chitosan/PAA)₅, and 28B: the preparation of Ce(NO₃)₃-loaded nanofibers by a coaxial electrospinning technique.

FIGS. 29A-29C disclose the dual-pH sensitive behavior of chitosan/PAA polyelectrolyte coacervate, FIG. 29A: The release of BB in DI water with varied pH for 24 h.

FIG. 29B: The surface morphology of Ce(NO₃)₃-loaded nanofibers examined by SEM. FIG. 29C: Ce(NO₃)₃-loaded nanofibers observed by confocal spectroscopy. FIG. 29D The core-shell structure of an individual Ce(NO₃)₃-loaded nanofiber confirmed by TEM.

FIG. 30 depict optical microscopy images of the surface morphology of polyelectrolyte coacervate coating samples before (top) and after immersion for 24 h (bottom).

FIG. 31 depicts SEM-EDS analysis of the presence of cerium a) in Ce(NO₃)₃-loaded nanofibers. b) outside of Ce(NO₃)₃-loaded nanofibers.

FIG. 32A depicts cumulative release profiles of Ce(NO₃)₃-loaded nanofibers in DI water with varied pH.

FIG. 32B depicts the surface morphology of Ce(NO₃)₃-loaded nanofibers before and after the release study.

FIG. 33 is an SEM image with high magnification depicting the surface morphology of Ce(NO₃)₃-loaded nanofibers after the release study. The nanofibers were immersed in DI water at pH 10.

FIG. 34 is a graph depicting EIS results of AA2024-T3 coated with different coatings. The samples were corroded in 100 mM NaCl solution at neutral pH.

FIG. 35A depicts surface morphologies of coated samples made by the bar-coating (on the left) and the dip-coating (on the right) method.

FIG. 35B depicts the surface morphology of a bar-coated sample examined by SEM.

FIGS. 36A-36C depict surface morphologies of AA2024-T3 dip-coated with a) PVB, b) Fiber-PVB, c) Ce-Fiber-PVB examined by SEM.

FIGS. 37A-37F are graphs depicting EIS results of different coated samples corroded in 5 mM Na₂SO₄ with varied pH conditions: FIG. 37A: Fiber-PVB at pH 2.5; FIG. 37B Ce-Fiber-PVB at pH 2.5; FIG. 37C Fiber-PVB at pH 10; FIG. 37D: Ce-Fiber-PVB at pH 10; FIG. 37E Fiber-PVB at pH 7; and FIG. 37F: Ce-Fiber-PVB at pH 7.

FIGS. 38A-38C are graphs depicting the evolution of |Z|_{0.01 Hz} for Fiber-PVB and Ce-Fiber-PVB immersed in 5 mM Na₂SO₄ with pH FIG. 38A: 2.5, FIG. 38B: 10, FIG. 38C 7.

FIG. 39 is a schematic illustration of equivalent circuits used for fitting EIS data. a) equivalent circuit with two time constants b) equivalent circuit with one time constant.

FIGS. 40A-40C are graphs depicting the evolution of Rₚₒᵣₑ of Fiber-PVB and Ce-Fiber-PVB immersed in 5 mM Na₂SO₄ with pH FIG. 40A: 2.5, FIG. 40B: 10, FIG. 40C: 7.

FIGS. 41A-41C are graphs depicting the evolution of Rₚ of Fiber-PVB and Ce-Fiber-PVB immersed in 5 mM Na₂SO₄ with pH FIG. 41A: 2.5, FIG. 41B: 10, FIG. 41C 7.

FIGS. 42A-42C are graphs depicting the evolution of C_{coat} of Fiber-PVB and Ce-Fiber-PVB during EIS measurements. The coatings were immersed in 5 mM Na₂SO₄ with pH FIG. 42A: 2.5, FIG. 42B 10, FIG. 42C 7. The repeated EIS measurements were presented in the dashed line.

FIGS. 43A-43C are graphs depicting the evolution of C_{dl} of Fiber-PVB and Ce-Fiber-PVB during EIS measurements. The coatings were immersed in 5 mM Na₂SO₄ with pH FIG. 43A: 2.5, FIG. 43B: 10, and FIG. 43C 7. The repeated EIS measurements were presented in the dashed line.

FIGS. 44A-44C are graphs depicting EIS results of FIG. 44A: Fiber-PVB, FIG. 44B: Ce-Fiber-PVB, and FIG. 44C: PVB corroded in 100 mM NaCl.

FIG. 45 is a graph depicting the evolution of |Z|_{0.01 Hz} of PVB, Fiber-PVB, and Ce-Fiber-PVB immersed in 100 mM NaCl.

FIG. 46 is a graph depicting the evolution of Rₚₒᵣₑ of Fiber-PVB and Ce-Fiber-PVB immersed in 100 mM NaCl.

FIG. 47 is a graph depicting the evolution of C_{coat} of Fiber-PVB and Ce-Fiber-PVB during EIS measurements. The coatings were immersed in 100 mM NaCl. The repeated EIS measurements were presented in the dashed line.

FIGS. 48A and 48B are graphs depicting the evolution of |Z|_{0.01 Hz} of the scratched epoxy coating containing a) Ce(NO₃)₃-loaded microspheres and b) Ce(NO₃)₃-loaded nanofibers. The coating samples were immersed in 100 mM NaCl.

FIGS. 49A and 49B are graphs depicting the evolution of |Z|_{0.01 Hz} of the scratched epoxy coating containing a) Ce(NO₃)₃-loaded microspheres and b) Ce(NO₃)₃-loaded nanofibers. The coating samples were immersed in 100 mM NaCl.

FIG. 50A depicts a schematic illustration of the preparation of Ce(NO₃)₃-loaded microspheres by an electrospray technique, and the fabrication of pH-sensitive smart coatings by a bar-coating method.

FIG. 50B depicts the surface morphology of Ce(NO₃)₃-loaded microspheres examined by SEM.

FIG. 51A depicts the core-shell structure of an individual Ce(NO₃)₃-loaded microsphere observed by confocal spectroscopy.

FIG. 51B depicts an SEM image presenting the cross-section of a small Ce(NO₃)₃-loaded microsphere prepared by FIB.

FIG. 52 depicts cumulative release profiles of Ce(NO₃)₃-loaded microspheres in DI water with different pH.

FIGS. 53A-53C depict cyclic polarization curves of AA2024-T3 substrates corroded in 10 mM NaCl solutions or released media. The pH of the solutions was a) 2.5, b) 7, and c) 10.

FIGS. 54A-54C depict EDS result of AA2024-T3 after cyclic polarization scans. AA2024-T3 substrates were polarized in the released media of Ce(NO₃)₃-loaded microspheres. The pH of solutions was a) 2.5, b) 7, and c) 10. Scale bar is 10 μm.

FIGS. 55A-55D depict surface morphologies of AA2024-T3 coated with a) PVB, b) PEI/PAA-PVB, c) Ce-PVB, and d) Ce-PEI/PAA-PVB observed by SEM.

FIGS. 56A-56D depict EIS results of AA2024-T3 coated with different coatings. The samples were corroded in 5 mM Na₂SO₄ at pH 2.5.

FIGS. 57A-57D depicts EIS results of AA2024-T3 coated with different coatings. The samples were corroded in 5 mM Na₂SO₄ at pH 10.

FIGS. 58A-58D depict EIS results of AA2024-T3 coated with different coatings. The samples were corroded in 5 mM Na₂SO₄ at pH 7.

FIGS. 59A-59C depict evolution of |Z|_{0.01 Hz} for various coating systems during 58 h immersion. The coatings were immersed in 5 mM Na₂SO₄ with pH a) 2.5, b) 10, c) 7. Data from replicated tests are shown with either solid lines and filled symbols or dashed lines and open symbols as indicated.

FIGS. 60A-60C depict evolution of Rₚₒᵣₑ of varied coating systems during EIS measurements. The coatings were immersed in 5 mM Na₂SO₄ with pH a) 2.5, b) 10, c) 7.

FIGS. 61A-61B depict evolution of Rₚ of varied coating systems during EIS measurements. The coatings were immersed in 5 mM Na₂SO₄ with pH a) 2.5, b) 10.

FIGS. 62A-62D depict EIS results of AA2024-T3 coated with different coatings. The samples were corroded in 100 mM NaCl.

FIG. 63 depicts evolution of |Z|_{0.01 Hz} for various coating systems during 58 h immersion. The coatings were corroded in 100 mM NaCl.

FIGS. 64A-64B depict evolution of a) Rₚₒᵣₑ and b) Rₚ of varied coating systems immersed in 100 mM NaCl.

FIG. 65A depicts SEM-EDS analysis of the presence of cerium in three small and one large Ce(NO₃)₃-loaded microspheres.

FIG. 65B depicts the representative EDS spectrum of Ce(NO₃)₃-loaded microspheres.

FIG. 66 depicts cathodic polarization curves of AA2024-T3 substrates corroded in 10 mM NaCl containing 0.1 mM and 1 mM Ce(NO₃)₃. The pH of the solutions was 2.5.

FIGS. 67A-67B depict equivalent circuits used for fitting EIS data. a) equivalent circuit with two time constants b) equivalent circuit with one time constant.

FIGS. 68A-68C depict evolution of C_{coat} of varied coating systems during EIS measurements. The coatings were immersed in 5 mM Na₂SO₄ with pH a) 2.5, b) 10, c) 7. The repeated EIS measurements were presented in the dashed line.

FIGS. 69A-69B depict evolution of C_{dl} of different coating systems during EIS measurements. The coatings were immersed in 5 mM Na₂SO₄ with pH a) 2.5 and b) 10. The repeated EIS measurements were presented in the dashed line.

FIGS. 70A-70B depict evolution of a) C_{coat} and b) C_{dl} of different coating systems during EIS measurements. The coatings were immersed in 100 mM NaCl. The repeated EIS measurements were presented in the dashed line.

### DETAILED DESCRIPTION

In the following description, for purposes of explanation, numerous specific details are set forth in order to provide a thorough understanding of the subject innovation. It may be evident, however, that the innovation can be practiced without these specific details.

According to an aspect, the innovation provides a pH-sensitive release system. The pH-sensitive release system comprises capsules (e.g., PEI/PAA capsules) that respond to both low and high pH changes in the local environment. The pH in the local environment decreases to acidic values in regions where anodic reactions are localized owing to hydrolysis of metal cations. In contrast, the pH increases to alkaline values in regions where cathodic reactions occur. In some cases, the cathodic reactions occur in aqueous environments.

In embodiments, the capsules of the pH-sensitive release system according to the innovation may be useful in most any environment in which a pH change is indicative of a condition that would be improved by release of an encapsulated agent. For example, an increase or decrease of pH in an environment may be indicative of a risk for damage caused by corrosion. Release of a corrosion inhibitor in either of the circumstances (e.g., a change to low or high pH) could help to mitigate or prevent corrosion damage. In another example, a biological condition that manifests with an increase or decrease in pH could be treated by the release of a medication/compound to treat the condition with the use of a capsule according to the innovation. In yet another example, the capsule according to the innovation may be used in agricultural contexts. For, example, the capsules may encapsulate an agent that could improve soil conditions. The above examples are not meant to be an exhaustive list of potential uses for the capsule of the innovation. It is to be appreciated that the capsule may be used in many environments wherein a change in pH (e.g., a change to low or high pH) is indicative of a need to administer/release an agent.

In one embodiment, the pH-sensitive release system comprises a corrosion inhibitor for corrosion protection. The corrosion inhibitor may be loaded into a capsule that can respond to both low and high pH conditions. In one embodiment, the capsule may be a nano-/micro-capsule. A change in pH may be indicative of conditions that can lead to corrosion. This change in pH results in release of the encapsulated corrosion inhibitors. This is in contrast to agents directly embedded inside a barrier coating as the corrosion inhibitor loaded into a capsule is controllably released depending on pH to minimize the inhibitor depletion.

In one embodiment, the pH-sensitive release system according to the innovation may include an agent embedded into a barrier polymer matrix to achieve a smart coating for corrosion protection. There are a variety of applications for such a smart coating, including automotive, aerospace, marine and biomedical components. In one embodiment, the agent may be a corrosion inhibitor. By choosing appropriate corrosion inhibitors, this coating can be used for protection of a variety of metal substrates (e.g., Al, Mg and Cu and their alloys). The pH-sensitive release system according to the innovation may include additional functionality. For example, if used in a coating, the system could provide early detection of corrosion by impregnating a pH indicators inside a capsule. It is to be understood that the pH-sensitive release system according to the innovation may be used to detect changes in pH in most any suitable environment.

The capsules (e.g., PEI/PAA capsules) according to the innovation can release agents (e.g., corrosion inhibitors) much faster at low or at high pH compared to neutral pH. In environment prone to changes in pH, especially those prone to corrosion, these capsules are suitable for providing corrosion protection for substrates as a whole, especially metal substrates.

In one aspect, the innovation provides a corrosion inhibitor release system comprising an encapsulated corrosion inhibitor. In one embodiment, the corrosion inhibitor may be encapsulated within a micro-container or nano-container. In one embodiment, the micro-container or nano-container may be built using at least two weak polyelectrolytes. The weak polyelectrolytes may include a weak polycation and a weak polyanion. In one embodiment, the polyelectrolytes may be polyethylenimine (PEI) and polyacrylic acid (PAA).

In an aspect, the innovation provides a method of fabricating a capsule for encapsulating an agent. In one embodiment, the agent may include a corrosion inhibitor. In one embodiment, the method includes mixing two weak polyelectrolytes. In one embodiment, the method includes mixing a weak polycation and a weak polyanion (e.g., polyethylenimine (PEI) and polyacrylic acid (PAA)) to build a micro-container or nano-container for corrosion inhibitors. Upon mixing, the polyelectrolytes (e.g., PEI and PAA) can interact with each other via electrostatic interaction to form the coacervate. The coacervate can stably exist and a homogenous solution can be made without phase separation.

In one embodiment, PEI and PAA are used to fabricate nano-/micro-capsules for encapsulation of corrosion inhibitors. PEI and PAA are weak polyelectrolytes and carry positive (PEI) and negative (PAA) charge. Upon mixing, PEI (e.g., 75 mM with respect to amine groups) and PAA (e.g., 75 mM with respect to carboxylic acid groups) can interact spontaneously with each other via electrostatic interaction to form coacervates. Coacervates can stably exist and a homogenous solution can be made without phase separation by modifying the pH of the solutions and the ion concentration. In one embodiment, the pH of the solutions is controlled by adding acetic acid to have stable coacervates when PEI and PAA are mixed together.

The degree of ionization of PEI and PAA is pH sensitive. The pKa values of PEI are 4.5, 6.7 and 11.6 while the pKa of PAA is 5.5. At low pH (e.g., less than about 5.5) PEI carries more positive charge and PAA becomes neutral due to protonation. At high pH (e.g., greater than about 11), on the other hand, PEI loses charge and PAA is fully ionized and becomes more negative. In both low and high pH environments, the interaction between PEI and PAA becomes weaker and repulsion between species with the same charge becomes stronger, inducing the swelling or dissolution of PEI/PAA coacervates. As a result, inhibitors enclosed within a capsule comprising PEI/PAA coacervates can be released.

In one embodiment, the pH response of PEI/PAA coacervates can be modified by adjusting the molar ratio of PEI and PAA. As described in the Example below, three molar ratios were tested to determine pH response of the PEI/PAA coacervate. In one embodiment, the molar ratio of PEI/PAA may be selected from about 2:1, about 1:1, or about 1:2.

In one example, a release system according to the innovation was fabricated and tested. It was observed that the release of an organic dye from a film made by PEI/PAA coacervates was much faster at either low (2.5) or high pH (11) compared with neutral (7) pH.

According to an aspect, the innovation provides an electrospray method for fabricating a capsule that is pH-responsive. In one embodiment, PEI/PAA coacervates and corrosion inhibitors can be loaded into outer and inner tubes of an electrosprayer, respectively and, thus, micro- or nano-containers with a core-shell structure can be fabricated. In contrast with the traditional technique for fabrication of nano-containers (e.g., the layer-by-layer technique), the method according to the innovation is fast and easy and able to directly encapsulate any functional species. In one embodiment water-soluble salts may be encapsulated inside a polymeric capsule with high loading efficiency using a method according to the innovation.

To fabricate nano-/micro-capsules, there are numerous techniques including the layer-by-layer technique and in situ polymerization. These techniques, however, are time-consuming and suffer from a narrow range of feasible materials as well as low loading efficiency. When it comes to capsules made using polyelectrolytes, the layer-by-layer technique is most often used.

In one embodiment, a method according to the innovation includes the preparation of prepared polyelectrolyte coacervates to make capsules using electrospray techniques to fabricate core-shell structured capsules. This method is more cost- and time-efficient than currently used methods. Compared with existing techniques used for fabricating capsules (e.g., the layer-by-layer technique), preparation of polyelectrolyte complexes can be quickly finished by mixing two polyelectrolytes together, which, in some cases takes only seconds. Thus, the tedious and time-consuming preparation of polyelectrolyte multilayers can be avoided using methods according to an aspect of the innovation.

In one embodiment, for example, using the electrospray technique to enclose inhibitors within polyelectrolyte capsules can form core-shell structured capsules once solutions are ejected from an electrospray nozzle. In one embodiment, the electrospray technique may utilize an electrospray apparatus having multiple nozzles, thus allowing for capsule creation through multiple nozzles at the same time.

In one embodiment, the electrospray method is used to encapsulate corrosion inhibitors within PEI/PAA coacervates. In one embodiment PEI/PAA coacervates (0.5 wt %) in dichloromethane (DCM)/ethanol were prepared and sodium vanadate (NaVO₃) (0.1 M) in DI water was used as the corrosion inhibitor. DCM is an organic solvent used in electrospray and ethanol can help with fabricating stable, liquid-like PEI/PAA coacervates in organic solvents. In one embodiment, a coaxial electrospray nozzle may be used to fabricate core-shell structured nano-/micro-capsules.

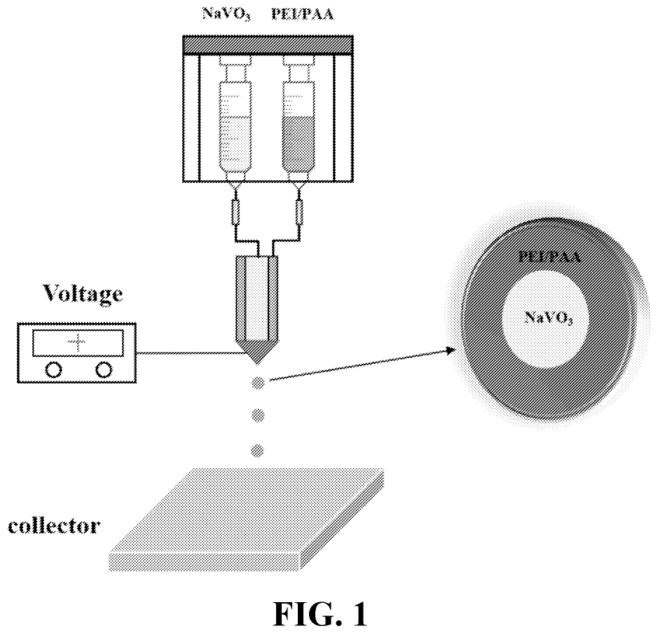

As shown in FIG. 1, in one embodiment, PEI/PAA coacervates are filled in the outer tube and NaVO₃ solution is in the inner tube of an electrosprayer so that PEI/PAA coacervates can form a polymer shell that is impregnated with NaVO₃. In the embodiment depicted in FIG. 1, the distance between the nozzle and the collector is set at 20 cm. The size of the resulting capsule and the thickness of the polymer shell may be modified by controlling the voltage applied to the coaxial nozzle and the outer and inner flow rates. It is to be appreciated that the NaVO₃ solution is but one example of an agent that may be encapsulated by the PEI/PAA coacervates. As described herein, the encapsulated agent is selectable.

In one embodiment, the nano-/micro-capsules may be combined with most any commercially available coating to protect a substrate. In one embodiment, the nano-/micro-capsules may be combined with a coating to provide corrosion protection for various substrates (e.g., metals, ceramics, etc.). To achieve corrosion protection of a metal substrate, these nano-/micro-capsules can be combined with any commercially available coating, such as epoxy and polyurethane coatings.

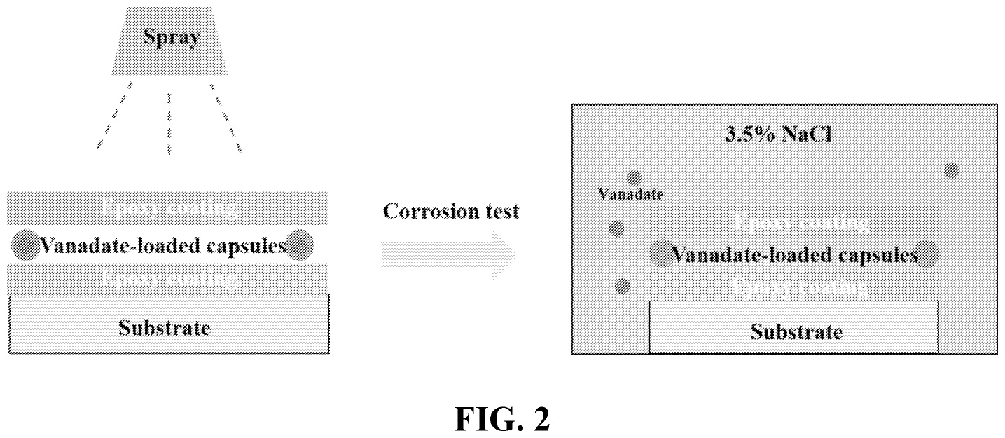

In one embodiment, the method may include electrospray technique to fabricate a corrosion protection system with a sandwich structure as depicted in FIG. 2. In this embodiment, an organic coating, e.g. an epoxy coating, may be sprayed onto a metal substrate (e.g., aluminum). Nano-/micro-capsules encapsulating a corrosion inhibitor may then be electrosprayed on top of the coating. In one embodiment, the nano-/micro-capsules may be vanadate-loaded nano-/micro-capsules. Another layer of coating (e.g., an epoxy coating) by spraying may be deposited on top of the nano-microcapsule layer.

In one embodiment according to the innovation, a wide variety of corrosion inhibitors can be impregnated/encapsulated within PEI/PAA coacervates. This can be accomplished while minimizing limitations associated with choosing proper inhibitors and solvents found with prior techniques. There are significant limitations associated with choosing inhibitors for existing inhibitor-loaded capsules preparation methods. For example, insoluble inhibitors or inhibitor-loaded templates are required if the layer-by-layer technique is used. Water-soluble inhibitors are required if water-in-oil emulsion is used to fabricate inhibitor-loaded capsules. In contrast, the electrospray technique according to the innovation uses a coaxial nozzle so that inhibitors and materials used for fabricating capsule shells separately flow through the inner tube and outer tube of the coaxial nozzle, respectively, minimizing the interaction between inhibitors and shell materials. Hence, a wider range of inhibitors can be used. In one embodiment, the corrosion inhibitor is sodium vanadate (NaVO₃). In one embodiment, the corrosion inhibitor is cerium nitrate (Ce(NO₃)₃). In one embodiment, the corrosion inhibitor is SrCrO₄.

According to an aspect, the innovation provides a coaxial electrospray technique to impregnate an inorganic corrosion inhibitor into microspheres. In one embodiment, the inorganic corrosion inhibitor comprises Ce(NO₃)₃. Ce(NO₃)₃ has high efficacy in the corrosion protection of aluminum alloys. Ce³⁺ ions can efficiently inhibit the cathodic reactions of aluminum alloys by forming an insoluble film covering the intermetallic particles on the metal surface, whereas nitrate ions can provide some extent of anodic inhibition. Hence, Ce(NO₃)₃ can be considered as a mixed corrosion inhibitor. Additionally, Ce(NO₃)₃ is prone to be oxidized to stable Ce(IV) species, subsequently generating Ce(OH)₄/CeO₂ films for corrosion protection. Unlike chromate inhibitors, Ce(NO₃)₃ is believed to be environmentally friendly and has a low toxicity, which raises less concern about health issues.

Inhibitor-loaded microspheres may be prepared by the electrospray technique according to the innovation. The microspheres may include Ce(NO₃)₃ and PEI/PAA polyelectrolyte coacervate as the core and shell materials, respectively. The as-fabricated Ce(NO₃)₃-loaded microspheres release corrosion inhibitors at both acidic and basic pH conditions at a faster rate than that at neutral pH. In one embodiment, Ce(NO₃)₃-loaded microspheres may be embedded into a PVB coating matrix to generate a dual-pH responsive coating, i.e. Ce-PEI/PAA-PVB.

Use of the electrospray technique according to the innovation can also address the issue of loading efficiency. The amount of inhibitors encapsulated within capsules using prior methods (e.g., layer-by-layer) has been found to be low in most studies (20-30%), while methods utilizing the electrospray techniques according to aspects of the innovation may enhance the loading efficiency to over 50%.

In one embodiment, the size of PEI/PAA capsules is controllable and PEI/PAA capsules are self-sealable. Defects or voids formed by the consumption of encapsulated inhibitors during the release process can create a potential pathway for electrolytes in a corrosive environment to penetrate the coating and interact with the metal substrate, causing local corrosion. To address this issue, in one embodiment, pore size may be controlled within a certain range to render a desired corrosion protection performance. Compared with other techniques, the size of capsules fabricated by electrospray is easier to be adjusted by controlling voltage and flow rates. In addition, previous studies have used strong polyelectrolytes as components of capsules while PEI and PAA used according to the innovation are weak polyelectrolytes. In addition, these weak polyelectrolytes have higher mobility when they are wet. Thus, in one embodiment, the PEI and PAA may diffuse with each other and seal voids/defects generated by the depletion of inhibitors.

According to an aspect, the innovation provides an electrospinning technique for fabricating nanofibers containing corrosion inhibitors. In one embodiment, the electrospinning technique is a coaxial electrospinning technique. The electrospinning technique may be a one-step technique that can produce long and continuous fibers with a diameter of nanometers or larger. The physical properties such as the morphology, porosity, and diameters of the fibers can be readily modified by tuning the electrospinning parameters, providing a possibility of manufacturing a variety of nanofibers with desired properties.

In one embodiment, the electrospinning technique according to the innovation may be used to encapsulate corrosion inhibitors into nanofibers. In one embodiment, the shell material for the nanofiber may be chitosan/PAA polyelectrolyte coacervate. In one embodiment, a chitosan/PAA polyelectrolyte coacervate may be electrospun to form nanofibers.

In an example according to the innovation, the applicability of generating corrosion inhibiting nanofibers was assessed by loading Ce(NO₃)₃ in the cores of the fibers via the coaxial electrospinning technique. Ce(NO₃)₃-loaded nanofibers were created by electrospinning, and their core-shell structure, morphology, and composition were characterized by confocal spectroscopy, transmission electron microscopy (TEM), and scanning electron microscopy (SEM) with energy dispersive spectroscopy (EDS). The release behavior of the nanofibers in response to pH alterations was monitored by UV-vis spectroscopy. Afterwards, a pH-sensitive coating was developed by embedding Ce(NO₃)₃-loaded nanofibers into a polyvinyl butyral (PVB) coating matrix and applied on a AA2024-T3 substrate. The corrosion resistance of the coated sample was studied comprehensively by electrochemical impedance spectroscopy (EIS). Furthermore, EIS was also conducted on a scratched coating sample to determine the self-healing capability over time.

### EXAMPLES

### Example 1

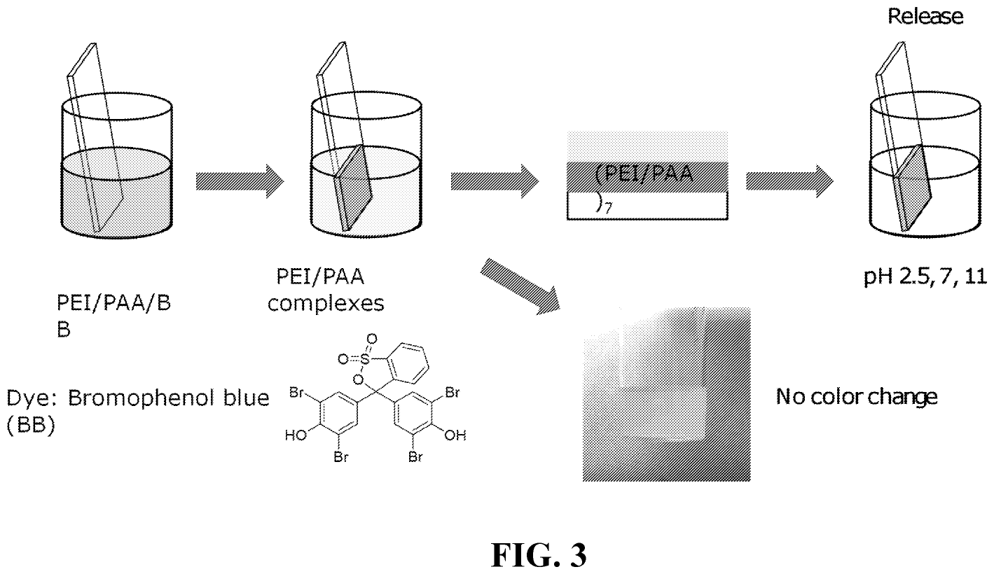

The PEI/PAA coacervate having three different molar ratios was tested to determine timing of release in different pH environments. The PEI/PAA coacervate having molar ratios of 1:1, 2:1, and 1:2 was tested. (FIG. 3.)

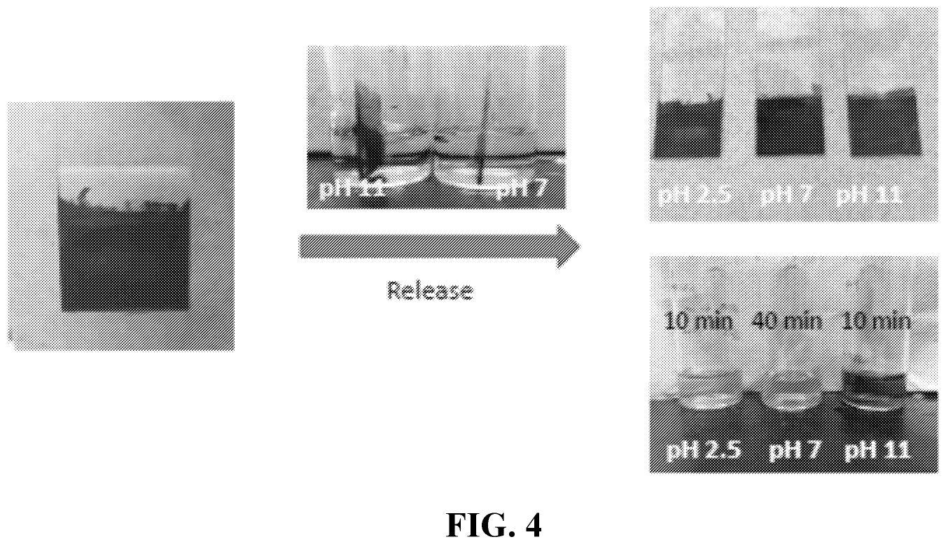

Release of an organic dye (bromophenol blue) from glass slides coated with the PEI/PAA coacervate was faster in low pH (2.5) and high pH (11) as compared with a neutral pH (7) for all of the tests. (See FIGS. 4-6.)

Release of the dye at pH 7 was very slow using PEI/PAA having a molar ratio of 1:1. As seen in FIG. 4, there was no color change in the solution after releasing for 40 minutes. Release at pH 2.5 and 11 was much faster. (See FIG. 4.)

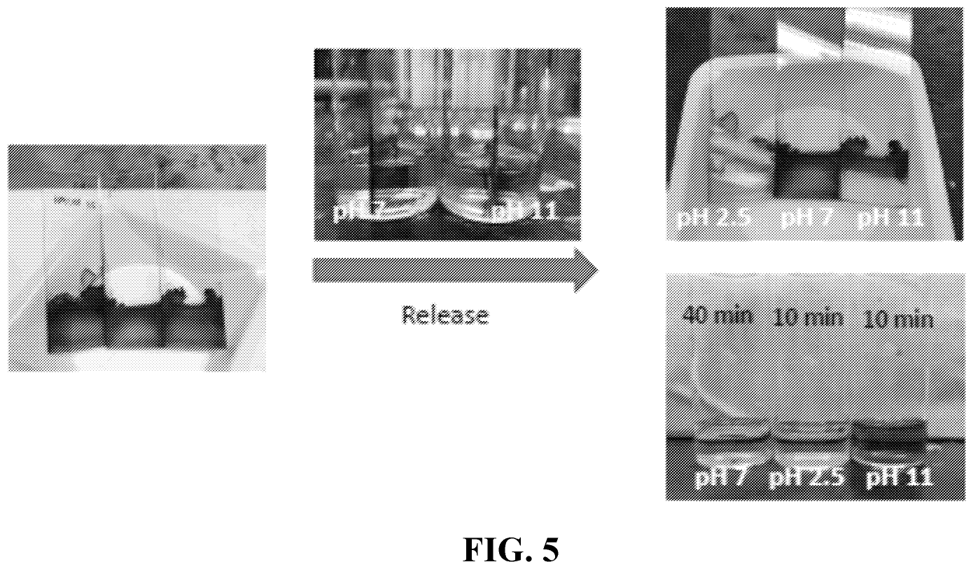

PEI/PAA with a molar ratio of 2:1 also showed that the release rate at pH 2.5 and pH 11 was faster than release at pH 7. Release at pH 11 was faster than release at pH 2.5. (FIG. 5).

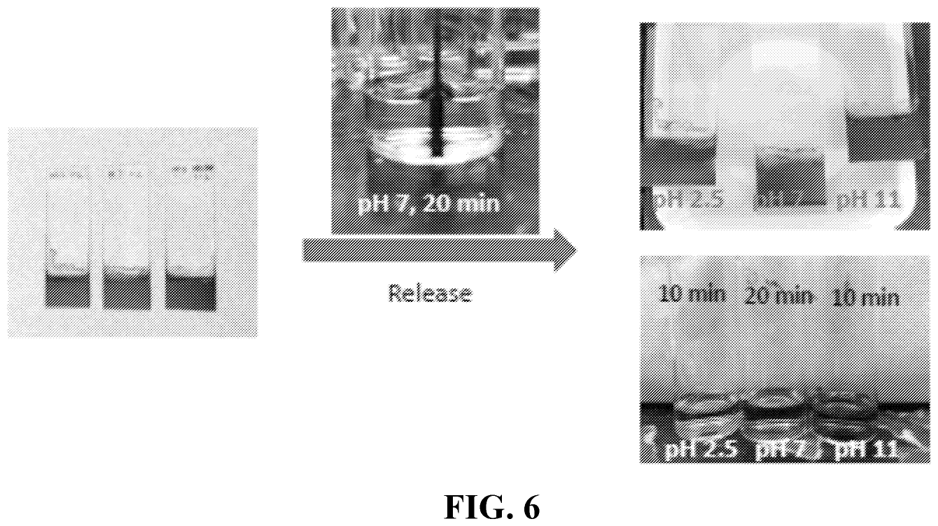

PEI/PAA with a molar ratio of 1:2 also showed that the release rate of the dye at pH 2.5 and pH 11 was faster than at pH 7. The release at pH was faster and a diffusion layer was observed after releasing for 20 minutes. (FIG. 6.)

### Example 2

### Materials

Branched polyethylenimine (PEI, M_{w}=25,000 g/mol), polyacrylic acid (PAA, Mᵥ=450,000 g/mol) and dichloromethane (DCM) were purchased from Sigma-Aldrich; sulfuric acid, sodium hydroxide, sodium chloride and sodium sulfate anhydrous from Fisher Scientific; acetic acid glacial from Mallinkrodt AR; and strontium chromate (SrCrO₄) from Noah Technologies. Aqueous solutions were prepared using deionized (DI) water with 18.2 MΩ cm resistivity from a Milli-Q© filtration system. All materials were used as received without further purification. Aluminum alloy 2024-T3 substrates were ground to 1200 grit with SiC paper in water and fully rinsed with ethanol before drying. No visible pitting was seen after polishing.

### Preparation of PEI/PAA Polyelectrolyte Coacervates and Application of Polymer Coatings

PEI and PAA solutions were prepared at a concentration of 75 mM with respect to the amine groups and carboxylic acid groups, respectively. A mixture of ethanol, DCM and acetic acid with the volume ratio of 3:3:4 was used to dissolve the PEI while the volume ratio of 5:3:2 was chosen for dissolving PAA. Both PEI and PAA solutions were stirred overnight prior to the fabrication of the PEI/PAA coacervates. The PEI/PAA coacervates were prepared by adding PAA solution into PEI solution dropwise while stirring until achieving a PEI:PAA molar ratio of 1:2. After stabilization for 10 min, PEI/PAA coacervates were dipcoated on a substrate for 15 s, which was repeated 7 times to acquire a polymer coating denoted as (PEI/PAA)₇. To load the corrosion inhibitor SrCrO₄, 1% w/v SrCrO₄ was suspended in ethanol and dip coated on a substrate for 30 s, which was repeated three times. The 7 layers of PEI/PAA coacervates were deposited on top of the SrCrO₄ layer to ensure SrCrO₄ was fully covered by polymers and the resulted coating was denoted as (SrCrO₄)₃/(PEI/PAA)₇.

Release Study of Cr(VI) from PEI/PAA Coacervates

To examine the release kinetics of Cr(VI) from PEI/PAA coacervates, (SrCrO₄)₃/(PEI/PAA)₇ was coated on laboratory glass slides (40×25 mm). After drying, the coated glass samples were immersed in 10 mL of DI water with varied pH (e.g., pH 2.5, pH 7 and pH 11) adjusted by the addition of 0.1 M H₂SO₄ or 0.1 M NaOH solutions. At each analysis time, a solution aliquot of 5 mL was extracted and replaced with 5 mL of fresh DI water with the same pH. The absorbance of Cr(VI) in the extracted solution was measured by UV-vis at λₘₐₓ=350 nm for pH 2.5, 365 nm for pH 7 and 373 nm for pH 11, respectively, in line with the pH-dependent absorption behavior of Cr(VI) reported previously. Calibration curves were established at each pH condition and the concentration of released Cr(VI) was obtained by extrapolating from the calibration curves. The cumulative concentration of released Cr(VI), C_{cum}, was calculated by the following equation:

$${C}_{cum} = {C}_{t} + \frac{v}{V} {\sum }_{0}^{t - 1} {C}_{t} \qquad ( 1 )$$

Where Cₜ, v and V are the apparent concentration of released Cr(VI) at time t, the volume extracted for the UV analysis at time t and total volume of the released medium, respectively. The second term on the right hand side accounts for the fresh solution added after the removal of each aliquot for analysis.

### Fourier Transform Infrared Spectroscopy

Fourier transform infrared spectroscopy (FTIR) was performed by an FTIR spectrometer (Bruker Optics, Billerica, MA, USA) equipped with attenuated total reflectance (ATR) accessories to study the chemistry of the PEI/PAA coacervates. To get a better resolution, 10 layers of PEI, PAA or PEI/PAA coacervates were dip-coated on polystyrene substrates and analyzed after drying in lab air overnight.

### Cyclic Potentiodynamic Polarization

Cyclic potentiodynamic polarization was employed to investigate the corrosion inhibition property of released SrCrO₄ for bare AA2024-T3 substrates. A glass slide coated with (SrCrO₄)₃/(PEI/PAA)₇ was immersed in 10 mM NaCl with pH of 2.5, 7 or 11 for 1 h to induce SrCrO₄ release. The pH of solution was adjusted as described above and was not buffered during the release. A bare AA2024-T3 panel was immersed in the release medium and the system was deaerated with Ar for 1 h prior to the polarization scans, which were performed using a Gamry™ Reference 600 Potentiostat. A three-electrode cell was used, which consisted of a bare AA2024-T3 panel (working electrode), a platinum mesh (counter electrode) and a saturated calomel electrode (reference electrode). The open circuit potential (OCP) was stabilized for 1 h. Cyclic polarization was then performed from −0.1 V with respect to the OCP at a scan rate of 0.5 mV/s and the scanning direction was reversed when the current density reached 10 mA/cm.

### Surface Characterization After Polarization

After cyclic potentiodynamic polarization, OP (Veeco Wyko NT 1100) analysis was conducted to characterize the topography of the sample surface. The images were recorded by using a 5× objective in the vertical scanning interferometry mode with a white light source. A field of view of 1× was selected. The specimens were loaded on a motorized planar xy positioning stage, which was located beneath the objective. After the focal plane was found, an automatic vertical scanning was conducted on the specimens with a vertical and backscan length of 40 μm and 25 μm, respectively. The volume loss caused by corrosion was assessed from OP scans using Bruker Vision64 software. The presence of SrCrO₄ on second phase particles was examined by SEM coupled with EDS. An FEI Quanta 200 SEM with an EDS detector was used and the electron beam energy was 20 kV.

### Characterization of Coatings on AA2024-T3 Substrates

The morphology of as-prepared coatings on AA2024-T3 substrates was examined by SEM and the roughness of the coatings was investigated using OP. To assess the thickness of the coatings, a scribe was manually made on the surface. The scribed coating was then imaged by SEM at a desired tilted angle, followed by geometrical correction.

To study the surface wettability, the static water contact angle (CA) was measured by a CA goniometer (rame-hart instrument co., Succasunna, NJ, USA). 5 μL droplets were placed on the surface of the coated samples by an autodispenser. The CA was determined by the average of at least three measurements.

### Electrochemical Impedance Spectroscopy (EIS)

EIS was performed on AA2024-T3 substrates with the polymer coatings, i.e., (PEI/PAA)₇ and (SrCrO₄)₃/(PEI/PAA)₇. Samples were immersed in two sets of electrolyte solutions: (1) 5 mM Na₂SO₄ with pH 2.5, pH 7 or pH 11 adjusted by H₂SO₄/NaOH; (2) 50 mM NaCl. Impedance spectra were collected by applying a 10 mV sinusoidal perturbation with respect to the OCP over a frequency range of 10 Hz to 0.01 Hz. A three-electrode cell was used, which consisted of a platinum mesh as a counter electrode, a saturated calomel electrode (SCE) as a reference electrode, and the coated aluminum samples as working electrodes. To ensure reproducibility, all measurements were replicated at least twice.

### X-Ray Photoelectron Spectroscopy.

The existence and the chemical state of Cr after the EIS measurements were determined by a Kratos Axis Ultra XPS spectrometer with monochromatic Al Kα radiation (120 W) at a pressure below 1.0×10⁻⁹ Torr. A delay line detector coupled to a hemispherical analyzer was used and XPS analysis was performed at a pass energy of 80 eV. An analysis area was set to 300 μm×700 μm and the photoelectrons were collected at 0° with respect to the sample surface normal. The spectra were referenced with respect to the C is peak at 284.8 eV and analyzed by the CasaXPS software. A Shirley background subtraction was used and the fitting parameters including the line shapes, line widths and peak positions are listed in Table 1 to fit each component. The residual standard deviation (residual STD), which provides an assessment of the quality of XPS fitting results, was low for all spectra, indicating a reasonable fit.

TABLE 1
Fitting parameters used for XPS analysis. For each
component, peaks were fitted by using Gaussian (Y
%)-Lorentzian (X %), defined as GL(X) in CasaXPS.

| Element | Compound | BE (eV) | FWHM | Line Shape |
|---|---|---|---|---|
| Cr 2p_{3/2} | CrO₂ | 575.1 | 1.7 | (GL85) |
| | Cr₂O₃ | 576.7 | 1.8 | (GL50) |
| | Cr(OH)₃ | 577.7 | 1.6 | (GL50) |
| | CrO₄²⁻ | 579.6 | 1.4 | (GL50) |
| Cr 2p_{1/2} | CrO₂ | 584.6 | 1.7 | (GL65) |
| | Cr₂O₃ | 586.4 | 1.8 | (GL50) |
| | Cr(OH)₃ | 587.3 | 1.9 | (GL50) |
| | CrO₄²⁻ | 588.8 | 1.9 | (GL50) |

### Results

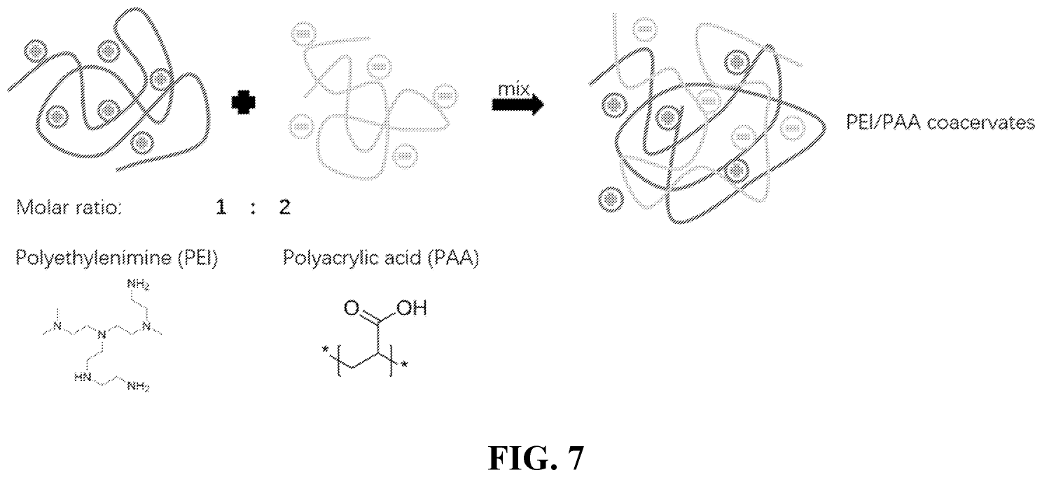

Polyelectrolyte coacervates were prepared by mixing two weak polyelectrolytes whose chemical structures are shown in FIG. 7. PAA solution was added dropwise to PEI solution while continuously stirring. Upon mixing, the solution became opaque, indicating the formation of polyelectrolyte coacervates via electrostatic attraction. To form a homogenous solution without precipitation, the pH of the solutions should be carefully controlled because the degree of ionization of both PEI and PAA is pH-dependent. Lowering the pH of the solution with acetic acid makes PAA carry less charge and hinders the electrostatic interaction between PAA and PEI, so a homogeneous solution can be generated (FIG. 7). Excess PAA can stabilize the polyelectrolyte coacervates, preventing precipitation, which is likely to occur with a PEI:PAA ratio of 1:1. Meanwhile, excess PAA can mitigate the electrostatic attraction between the positively charged PEI at low pH and the negatively charged chromate ions, which has a negative effect on the release of Cr(VI). Indeed, the release of Cr(VI) at pH 2.5 was not detected when the PEI:PAA was 1:1 (data not shown). A ratio of 1:2 of PEI:PAA was used.

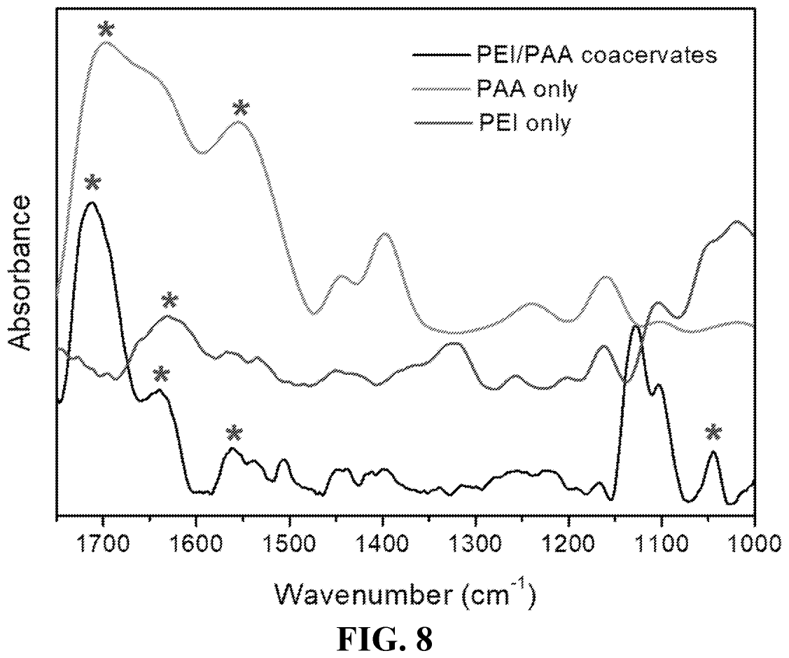

To confirm the formation of the PEI/PAA coacervates, FTIR was performed on dry films made of PEI, PAA and PEI/PAA coacervates (FIG. 8). The spectrum of the PEI/PAA coacervates exhibited absorbance peaks at 1050 cm⁻¹ from the CN— stretching band of the primary amine group, 1130 cm⁻¹ from the CN— stretching band of the secondary amine group, 1620 cm⁻¹ from the NH deformation band, 1550 cm⁻¹ from the COO— stretching band, [46,53] and 1710 cm⁻¹ from the C═O stretching band of COOH, suggesting the presence of both PEI and PAA in PEI/PAA coacervates. Compared with pure PEI and PAA, the intensity of the COO-band at 1550 cm¹ was diminished for PEI/PAA coacervates, which may offer evidence for the formation of PEI/PAA coacervates via electrostatic interaction between COO— groups and protonated amine groups.

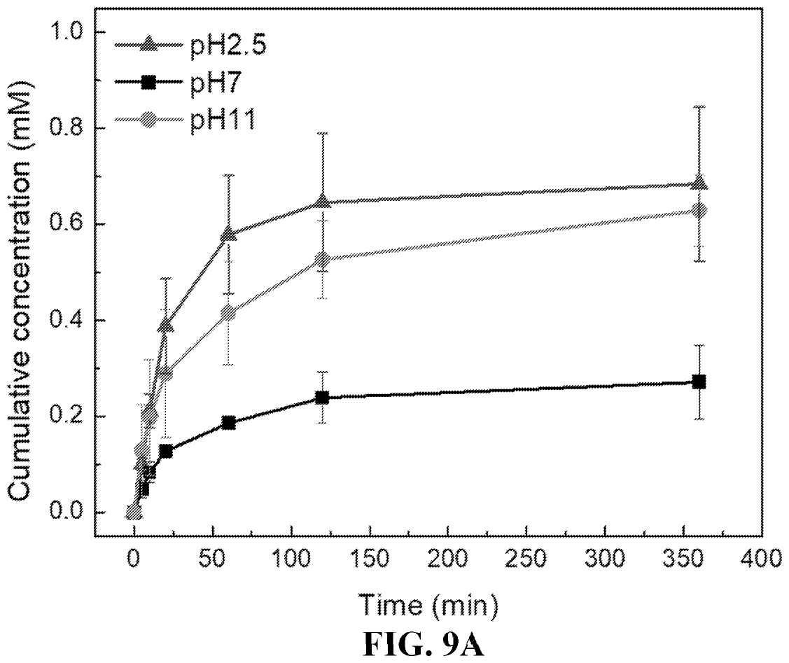

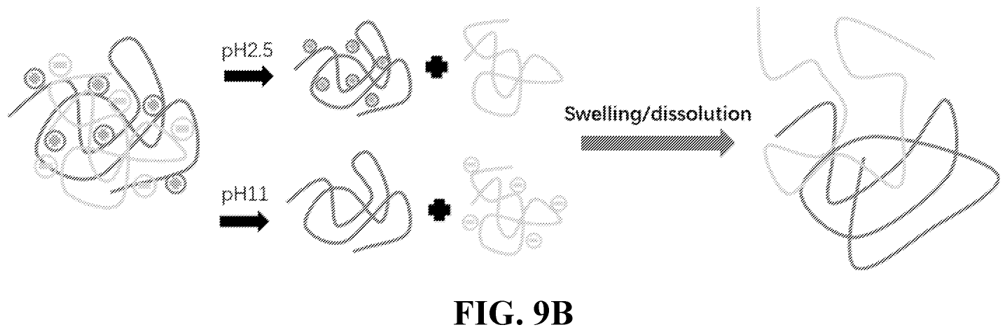

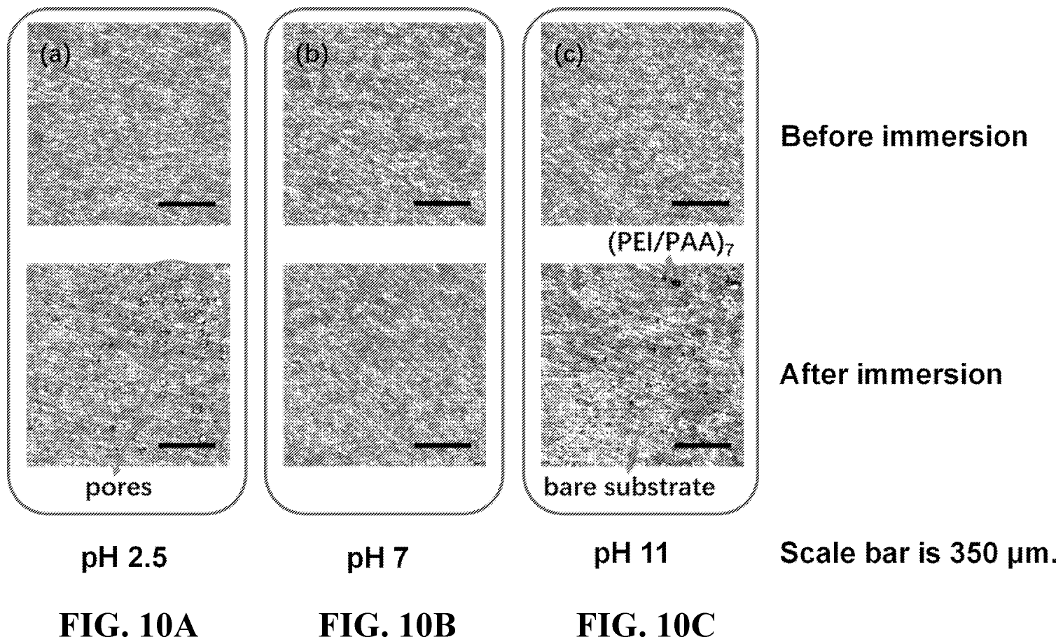

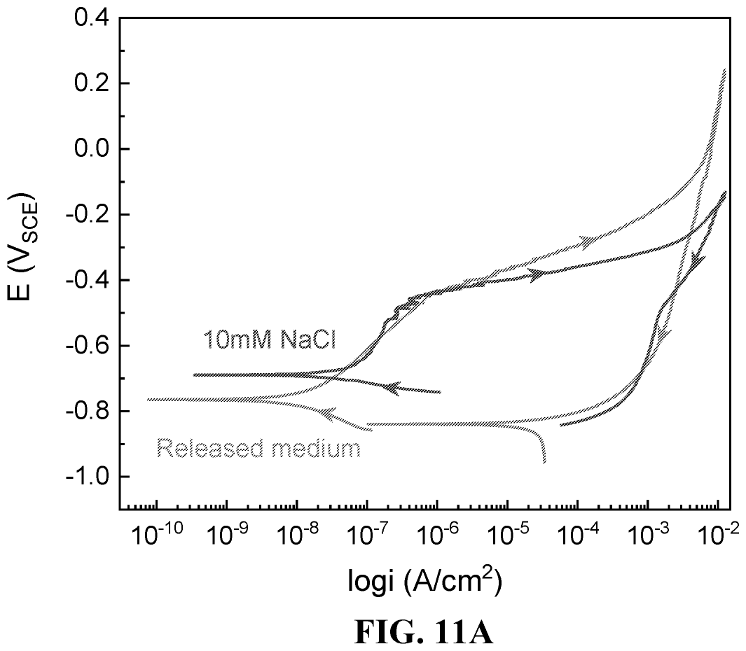

The pH response behavior of PEI/PAA coacervates was investigated by a release study. (SrCrO₄)₃/(PEI/PAA)₇ coated glass slides were immersed in DI water with pH 2.5, 7 or 11. The solutions gradually changed from colorless to yellow, indicating the presence of soluble Cr(VI) in solution. The concentration of the released Cr(VI) was measured by UV-vis spectroscopy (FIG. 9A). For all three pH conditions, the amount of released Cr(VI) increased with immersion time. The cumulative concentration of the released Cr(VI) quickly increased within one hour and gradually reached a steady-state plateau after 6 h. The final cumulative concentration of Cr(VI) ions was 0.68 mM at pH 2.5 and 0.63 mM at pH 11, both of which were over twice the value measured at pH 7, 0.27 mM. This indicates that the PEI/PAA coacervates are pH sensitive and can release Cr(VI) ions faster at both acidic and basic conditions, which can be attributed to the pH-dependent ionization of the polyelectrolytes. It has been reported that PAA possesses a pKa of 6.5, while PEI has three pKa values (4.5, 6.7, and 11.6). At pH 7, PEI and PAA are both charged, leading to moderate interactions between the functional groups (i.e., amine groups in PEI and carboxylic groups in PAA) in the form of ionic crosslinks. Without being bound by theory, it is believed that decreasing the pH to 2.5 protonates PAA, possibly keeping it uncharged while PEI is more charged. As a result, the stronger repulsion between the positively charged PEI chains and the insufficient interactions between the PEI and PAA induce swelling or partial dissolution of the PEI/PAA coacervates, generating voids/pores within the coatings. Similarly, at pH 11, PEI has a lower degree of ionization whereas PAA becomes more charged so voids/pores can also form (FIG. 9A). Subsequently, the encapsulated Cr(VI) can be released from the coatings at both low and high pH through these pores/voids. The higher release rate of Cr(VI) at pH 2.5 than that at pH 11 is possibly caused by the enhanced solubility of Cr(VI) at acidic conditions. The surface morphology of the (PEI/PAA)₇ coated AA20204-T3 after immersion in DI water with varied pH further confirmed the hypothesized pH-controlled release mechanism (FIGS. 10A-10C). Small pores were observed at pH 2.5 (FIG. 10A) and a large area of coatings was even dissolved at pH 11 (FIG. 10C), while the coatings were intact at pH 7 (FIG. 10B).

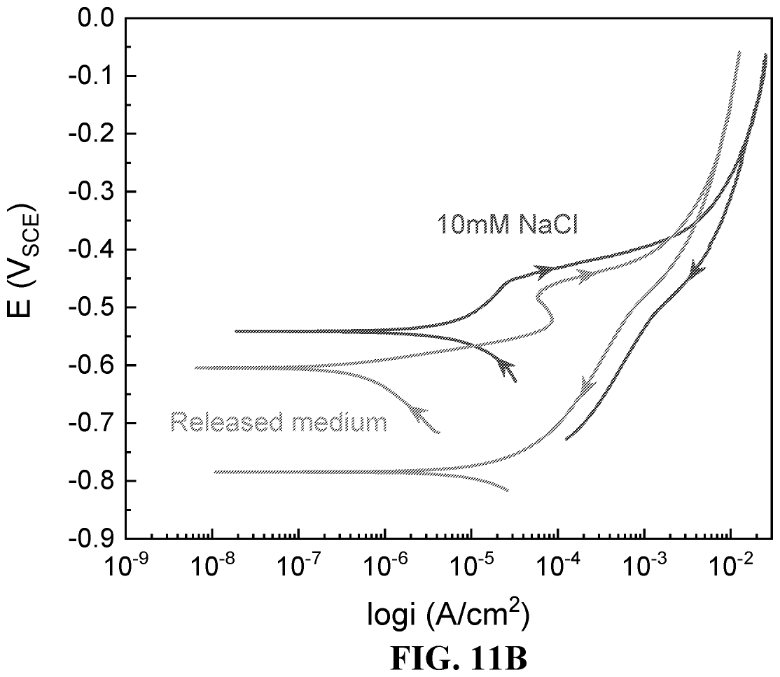

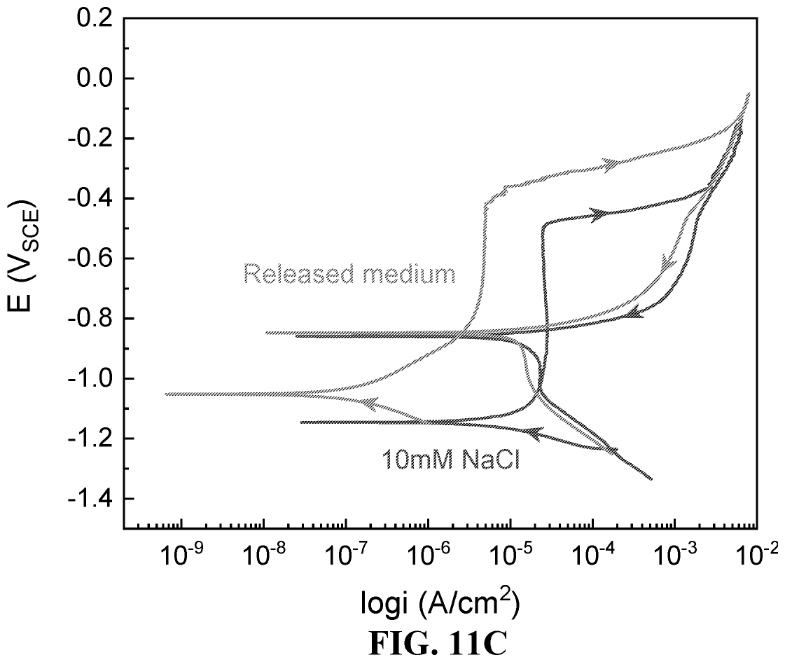

Potentiodynamic polarization of AA2024-T3 with/without released SrCrO₄ was performed to explore if the amount of released SrCrO₄ was enough to protect AA2024-T3 immersed in 10 mM NaCl with varied pH. The release of SrCrO₄ into the test solution was performed before the AA2024-T3 samples were immersed. UV-vis spectroscopy confirmed the amount of released SrCrO₄ was over 0.1 mM at both pH 2.5 and pH 11, but only 0.03 mM at pH 7, consistent with the release study. Although the pH of the solutions was not buffered, the pH change was negligible after the release of SrCrO₄. Since the PEI/PAA coacervates could also be dissolved into solution during immersion, the release experiments were also conducted on (PEI/PAA)₇ coatings without any inhibitor. The resulting solution was used as the test solution to examine the influence of PEI/PAA coacervates on the corrosion protection of AA2024-T3. It turned out that the released medium obtained from (PEI/PAA)₇ had a negligible corrosion protection effect on AA2024-T3 compared to that from (SrCrO₄)₃/(PEI/PAA)₇, even though the dissolved PEI/PAA coacervates may experience protonation/deprotonation and be adsorbed on active sites of the metal surface, which might attenuate AA2024-T3 corrosion. For simplicity, only the polarization curves of AA2024-T3 in NaCl solutions and released media containing SrCrO₄ are presented in FIGS. 11A-11C and corrosion current densities (icorr) from polarization curves are listed in Table 2. Under aerated conditions, the pitting potential of AA2024-T3 generally overlaps with the corrosion potential (E_{corr}). To investigate the effect of SrCrO₄ on the passivity of AA2024-T3, the solution was deaerated to lower E_{corr} and thus enable the observation of the passive region of AA2024-T3. As shown in FIG. 11A, although the passive current densities were similar, the cathodic current density of AA2024-T3 and E_{corr} decreased with SrCrO₄ present in the released medium at pH 7, suggesting a cathodic inhibition mechanism of SrCrO₄. The breakdown potential, E_{bd}, was also similar for the two solutions. At pH 2.5, the released SrCrO₄ also conferred cathodic inhibition on the AA2024-T3 substrate (FIG. 11B), as evidenced by over one order of magnitude decrease of the icorr and cathodic current density. In contrast to pH 7, the current density in the passive region at pH 2.5 was increased in the released medium, but E_{bd} remained similar to the AA2024-T3 polarized in 10 mM NaCl solution. The reason for the higher current density is not clear. The pH of 2.5 is below the pKa value of Cr³⁺, so a higher concentration of these soluble species may be adsorbed on the metal surface compared to those under pH 7 and 11 conditions. Therefore, the oxidation of such species may account for the enhanced anodic current density at pH 2.5, but this does not necessarily mean that the inhibition effect of SrCrO₄ was compromised under this condition. In the case of pH 11, both cathodic and anodic current densities were significantly reduced in the released medium indicating a mixed inhibition effect of SrCrO₄ (FIG. 11C). The icorr in the released medium was almost two orders of magnitude lower than that of AA2024-T3 polarized in the NaCl solution and E_{bd} was higher. These results suggest that the concentration of released SrCrO₄ exceeded the threshold for the corrosion inhibition of AA2024-T3, even in heavily corrosive conditions, i.e., pH 2.5 and pH 11. Although it is well known that SrCrO₄ is an effective inhibitor for the oxygen reduction reaction (ORR), the results described herein demonstrate that SrCrO₄ showed a good corrosion protection under deaerated conditions. Chromate adsorption either by the reduction of Cr(VI) to generate a Cr(III) oxyhydroxide monolayer or formation of Al (III)-Cr(VI) complex films can effectively protect the metal surface and retard Cl⁻ ion ingress, which may account for the good corrosion performance of released SrCrO₄ under deaerated conditions. Additionally, hydrogen bubbles were not observed on the metal surface with the presence of SrCrO₄, and thus the inhibition of hydrogen evolution may have occurred and contributed to the reduced corrosion rate.

TABLE 2
Comparison of the i_{corr} of AA2024-T3 immersed
in 10 mM NaCl and released medium.
i_{corr} (μA/cm [2])

| | pH 7 | pH 2.5 | pH 11 |
|---|---|---|---|
| 10 mM NaCl | 0.07 | 8.3 | 8.8 |
| Released medium | 0.01 | 0.56 | 0.1 |

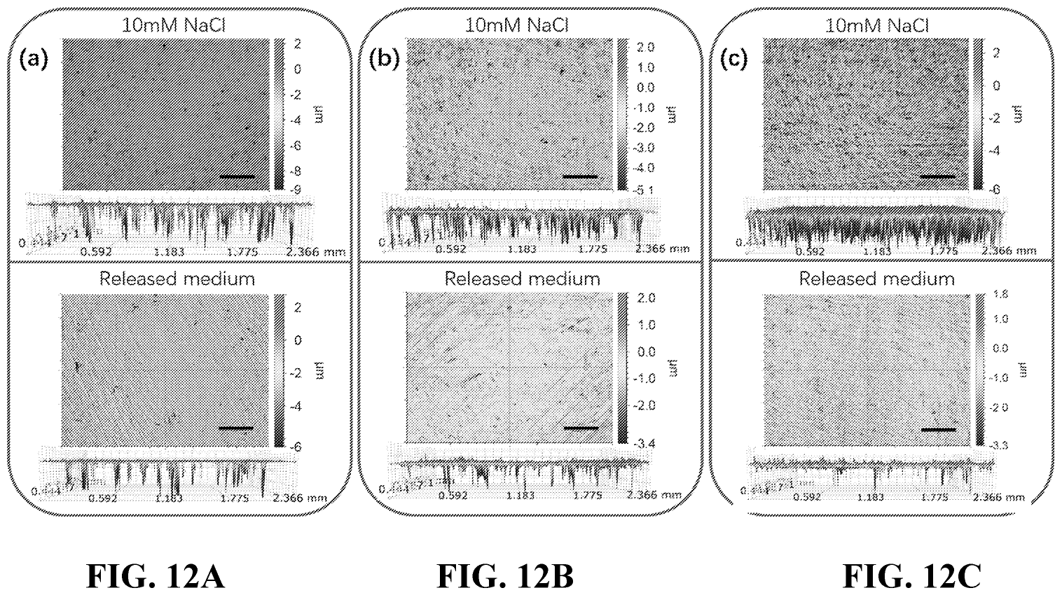

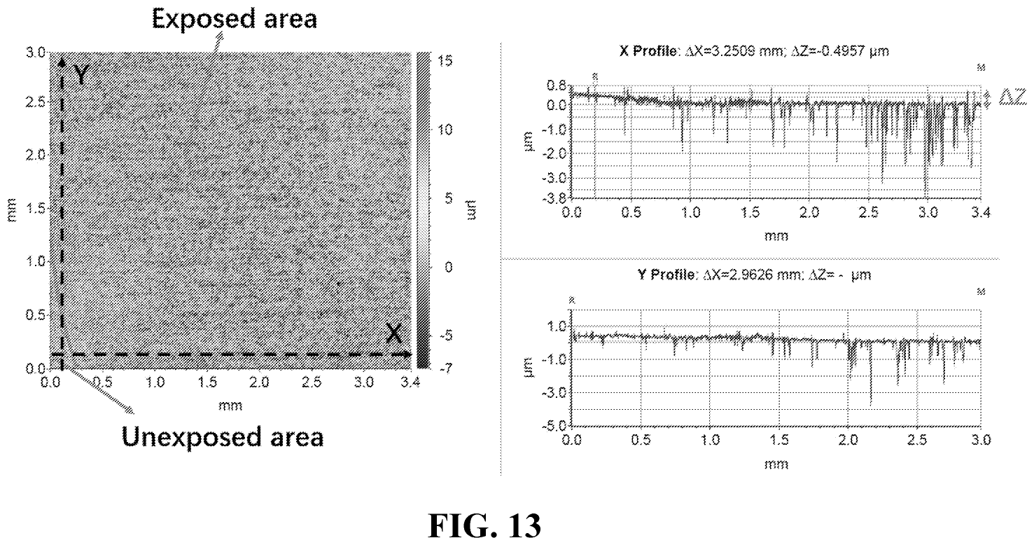

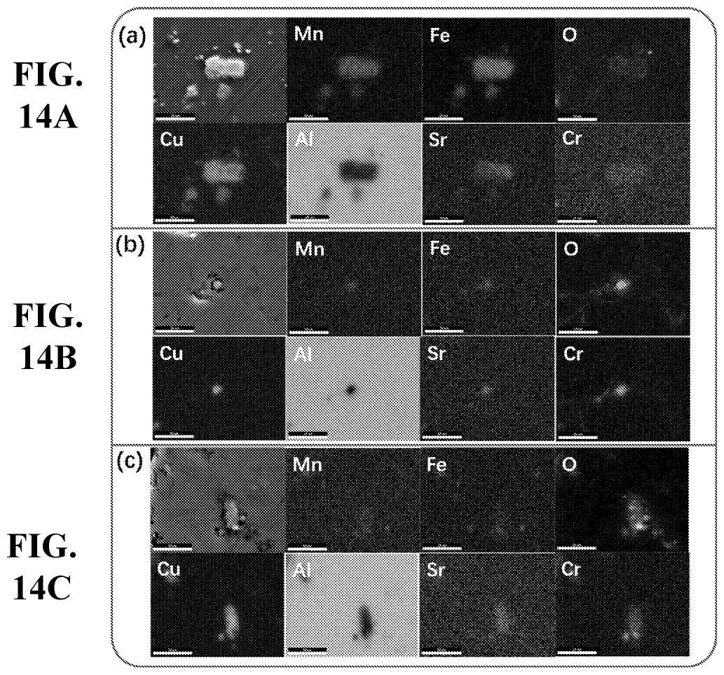

OP was utilized to analyze the topography of AA2024-T3 after cyclic potentiodynamic polarization. At neutral pH (FIG. 12A), although a few deep pits were observed, the majority of pits on AA2024-T3 polarized in NaCl solution had depths ranging from 0.1 μm-0.5 μm, and were probably metastable pits. For AA2024-T3 polarized in the released medium, the number of pits was greatly reduced whereas the pit depth remained similar, implying a more effective inhibition effect on pit initialization. Similarly, at both acidic and basic pH (FIGS. 12B and 12C), the pit depth slightly decreased but a significant decrease of pit density was observed for AA2024-T3 polarized in SrCrO₄ containing released medium compared to AA2024-T3 polarized in the NaCl solution, which is as expected. AA2024-T3 samples exhibited higher corrosion resistance when polarized in SrCrO₄ containing released medium than that of NaCl solutions, which is in agreement with the cyclic potentiodynamic polarization results shown in FIGS. 11A-11C.

In addition, while pits on AA2024 polarized in both NaCl solution and released medium had a depth of several micrometers, a general recession of the exposed area relative to the unexposed area of AA2024 was found by OP at all three pH conditions, indicating a certain degree of dissolution of the Al matrix (FIG. 13). The volume loss of AA2024 due to corrosion measured by OP was close to that calculated from the total anodic charge passed by using Faraday's law (Table 3). This may explain why the high current density was shown in polarization curves but few deep pits were observed in all pH cases. It should be mentioned that for all pH conditions, SrCrO₄ seems to have a greater effect on reducing pit density rather than the pit depth, suggesting that Cr(VI) is more effective in suppressing pit initialization than pit growth. Both pit depth and pit density were suppressed by SrCrO₄ under the alkaline condition, which may be associated with the higher instability of the native Al₂O₃ passive film at this condition. The introduction of SrCrO₄ in alkaline solutions may trigger the formation of a more robust Cr₂O₃ film on the AA2024-T3 surface, probably on intermetallic particles, which is more corrosion resistant than the native oxide. However, under acidic and neutral conditions, less change in pit depth and density relative to those under the alkaline condition was observed possibly because the reduction of Cr(VI) and the formation of a robust Cr₂O₃ film are limited by the local pH increase associated with cathodic reactions. This may lead to partial coverage of Cr₂O₃ film on cathodic intermetallic particles. In general, the enhanced corrosion resistance of AA2024-T3 throughout the cyclic potentiodynamic polarization is possibly due to the formation of a Cr₂O₃ film. As reported, a Cr₂O₃ film can be a barrier to Cl⁻ ion uptake by altering the metal surface and the electron transfer due to its nonconductive property, which may inhibit the cathodic reactions. Meanwhile, the reduction of Cr(VI) to Cr(III) during the cathodic polarization is irreversible, suggesting the film is likely to continue protecting the metal surface during anodic polarization.

TABLE 3
Comparison between volume loss of AA2024 calculated from the
total anodic charge by Faraday's law and that measured by OP.

| | | Volume loss in 10 mM | | Volume loss in released | |
|---|---|---|---|---|---|
| | | NaCl (μm [3]) | | medium (μm [3]) | |
| | | Charge | OP | Charge | OP |
| pH | 7 | 6.7 × 10 [7] | 6.4 × 10 [7] | 1.1 × 10 [8] | 7.1 × 10 [7] |
| pH | 2.5 | 2.4 × 10 [8] | 2.1 × 10 [8] | 1.3 × 10 [8] | 9.6 × 10 [7] |
| PH | 11 | 5.9 × 10 [7] | 7.1 × 10 [7] | 5.1 × 10 [7] | 4.5 × 10 [7] |

EDS results show that chromium existed on Cu—Fe—Mn—Al intermetallic particles under all three pH conditions (FIGS. 14A-14C), suggesting that SrCrO₄ was possibly reduced on these particles instead of the aluminum matrix. Although a significant amount of chromium was detected on the intermetallic particles, the anodic dissolution in the surrounding particles seemed not to be completely inhibited, as evidenced by the formation of pits and trenches. However, it should be noted that a trace of chromium is more likely to be found on these attached intermetallic particles. This suggests that Cr(VI) tended to be reduced on these particles and formed an insoluble film of Cr₂O₃ to retard the further corrosion of AA2024-T3.

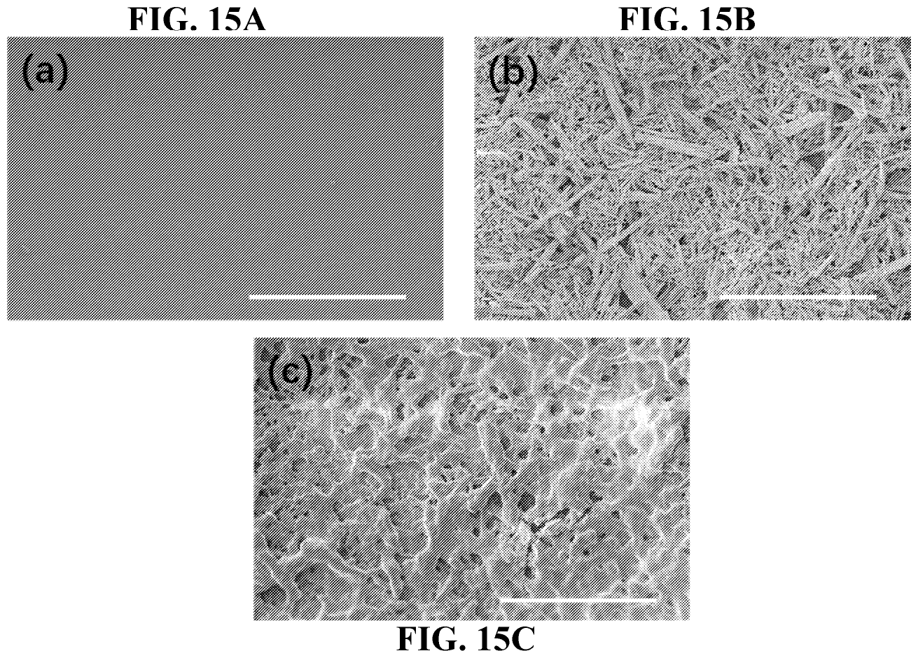

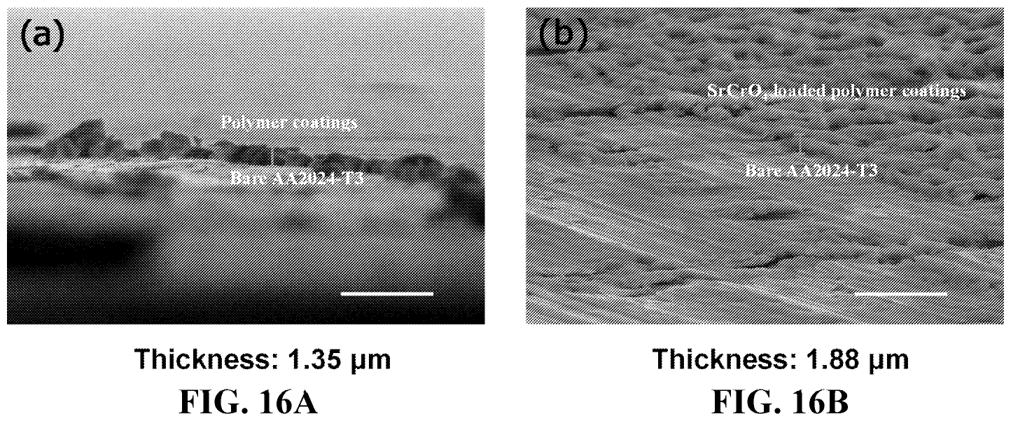

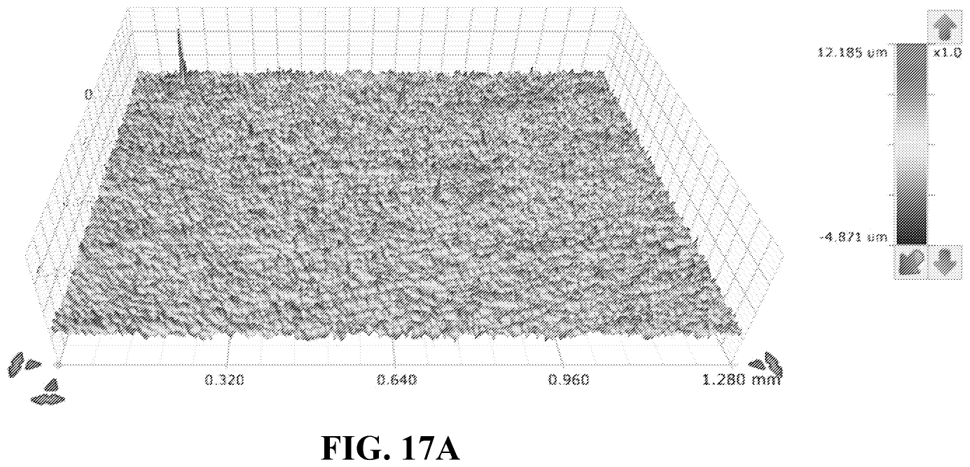

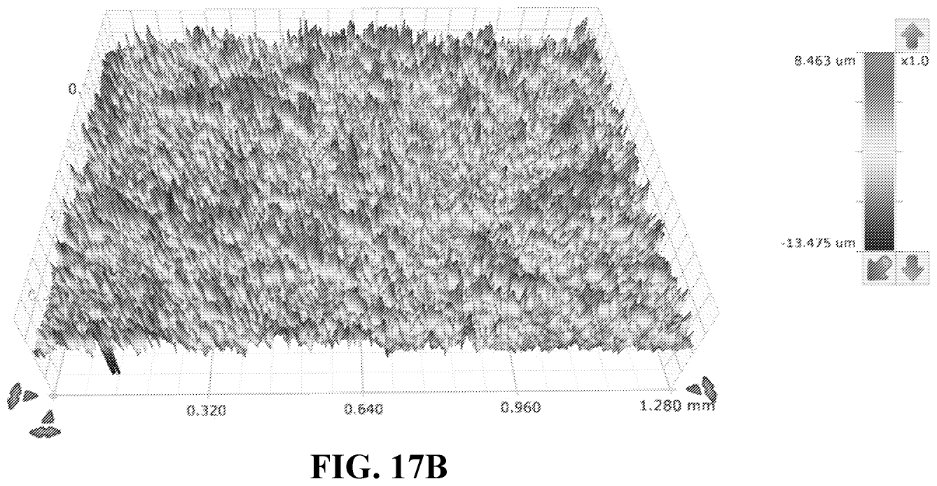

(PEI/PAA)₇ and (SrCrO₄)₃/(PEI/PAA)₇ were deposited on AA2024-T3 substrates and SEM was used to examine their surface morphology and the coating thickness. The (PEI/PAA)₇ coated sample exhibited a uniform and smooth surface morphology (FIG. 15A). In contrast, a rough surface with numerous flakes was formed when SrCrO₄ was directly deposited on the AA2024-T3 substrate (FIG. 15B). The (SrCrO₄)₃/(PEI/PAA)₇ coated sample showed a combined rough and porous morphology (FIG. 13C). The polymer from the (SrCrO₄)₃/(PEI/PAA)₇ coating seemed to fully cover the SrCrO₄ salts and the underlying metal substrate, although a certain degree of porosity still exists (FIGS. 15A-15C and FIGS. 16A and 16B). To measure the thickness of coatings, a scribe was made to expose the metal substrate so the top and bottom of coatings could be seen in SEM with a predetermined tilt angle (FIGS. 16A and 16B). The incorporation of SrCrO₄ in the polymer coating significantly altered the surface morphology but did not significantly affect the coating thickness. The thickness of both (PEI/PAA)₇ and (SrCrO₄)₃/(PEI/PAA)₇ films were both within the range of 1-2 μm. OP was performed to further investigate the roughness of the (PEI/PAA)₇ and (SrCrO₄)₃/(PEI/PAA)₇ coated samples, which revealed an enhanced roughness from 0.7 μm to 1.7 μm upon impregnating SrCrO₄ within the coating (FIGS. 17A-17B). This result was consistent with SEM observations.

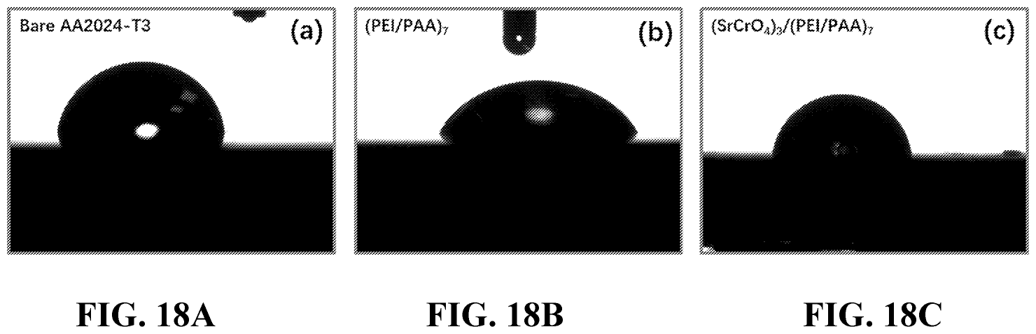

Moreover, the CA images of different coatings were recorded (FIGS. 18A-18C) to inspect the wettability of the coated surface and the results are presented in Table 4. As a control, the CA of bare metal surface was found to be 83.6±0.3°. The (PEI/PAA)₇ coated sample showed a lower CA value of 58.0±3.9° as a result of the hydrophilicity of both PEI and PAA. However, the (SrCrO₄)₃/(PEI/PAA)₇ coated samples exhibited a CA value of 76.1±1.6°. As shown by SEM and OP, the introduction of SrCrO₄ in the (PEI/PAA)₇ coating caused dramatic changes in the coating. Hierarchical microstructures in the form of microcavities and mounds were formed, resulting in a rough surface. Air entrapped within the microstructures is possibly the origin of the higher CA. However, it should be pointed out that the surface of (SrCrO₄)₃/(PEI/PAA)₇ remains hydrophilic (CA<90°) and water can still be gradually absorbed. This is beneficial for the ultimate applications because the films are not meant to be barrier layers and water is required for the release of chromate.

TABLE 4
Water content angle of bare AA2024-T3 substrate,
(PEI/PAA)₇ coated AA2024-T3 and
(SrCrO₄)₃/(PEI/PAA)₇ coated AA2024-T3.

| | | | (SrCrO₄)₃/ |
|---|---|---|---|
| | Bare | (PEL/PAA)₇ coated | (PEL/PAA)₇ coated |
| | AA2024-T3 | AA2024-T3 | AA2024-T3 |
| CA (°) | 83.6 ± 0.3 | 58.0 ± 3.9 | 76.1 ± 16 |

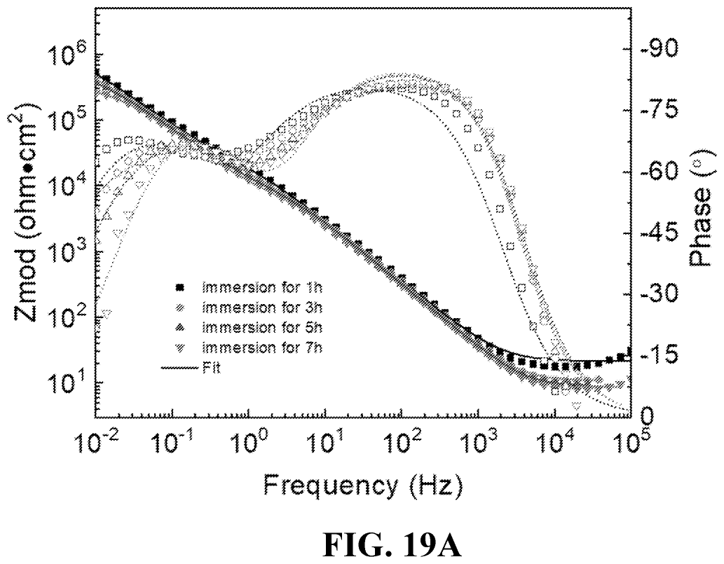

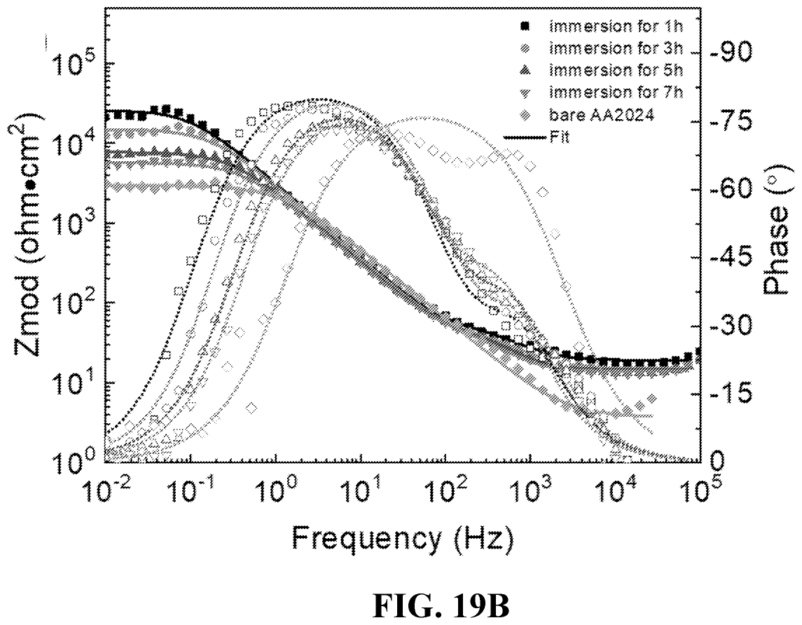

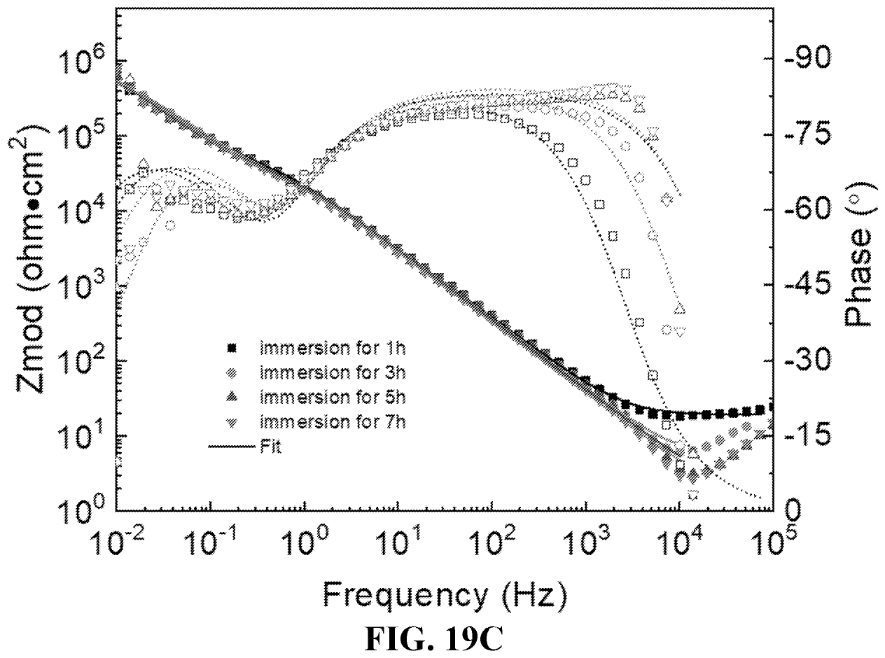

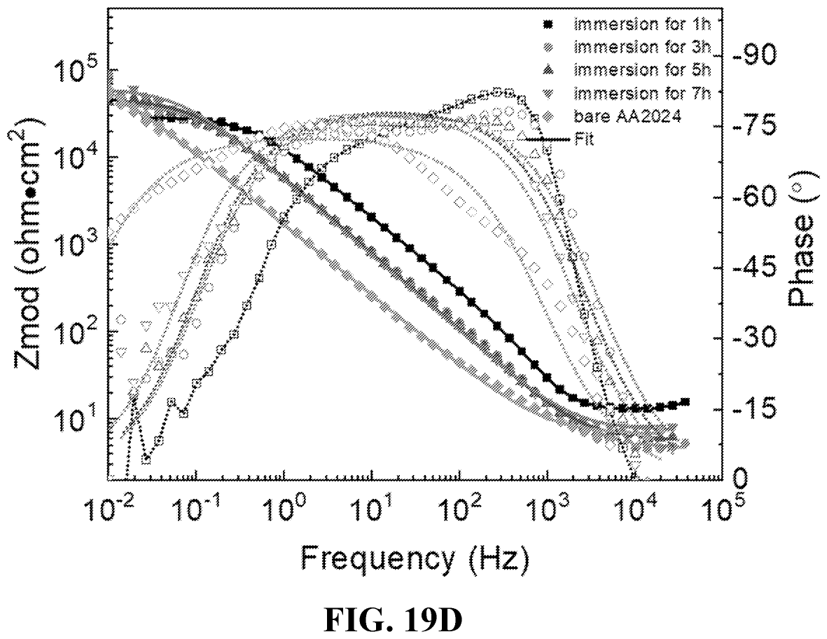

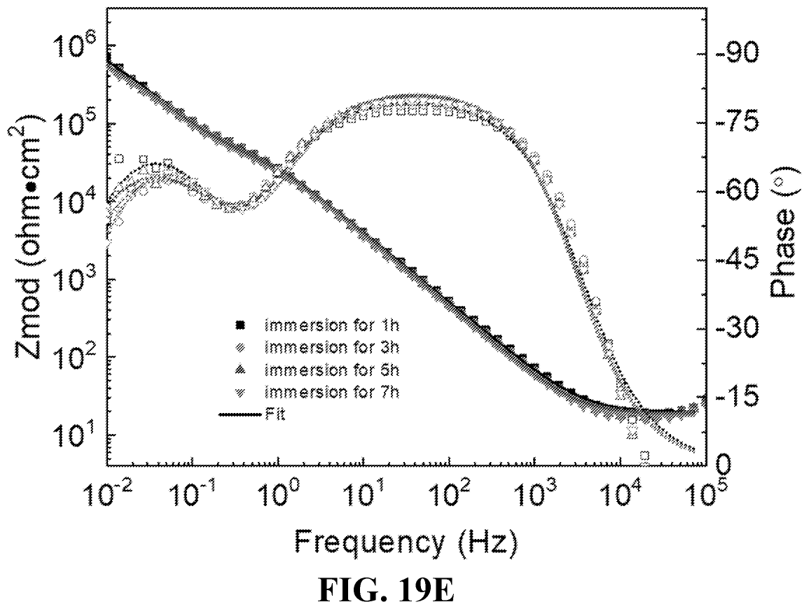

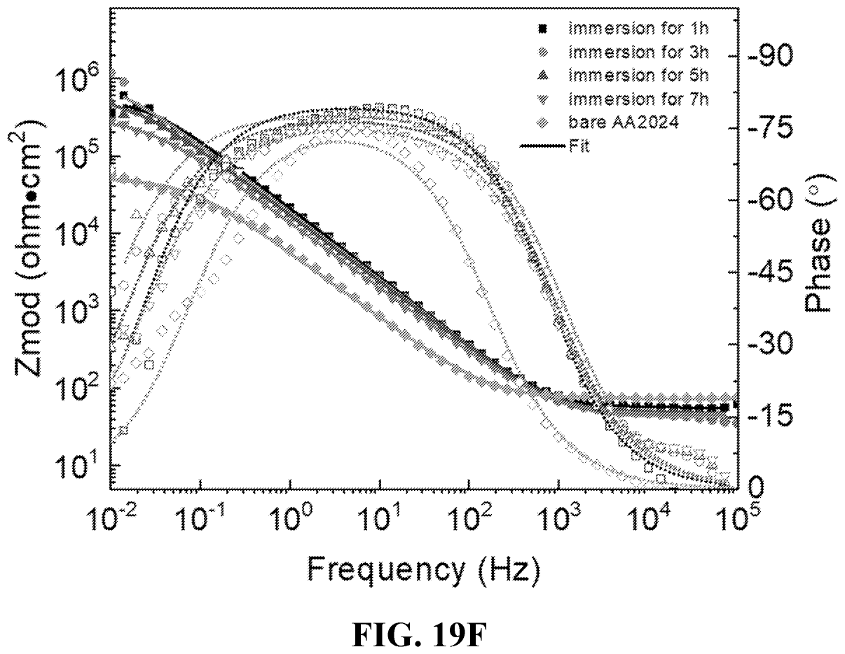

In a typical corrosion event, pH becomes more acidic at anodic sites and more basic at cathodic sites. To better evaluate the corrosion protection performance of (SrCrO₄)₃/(PEI/PAA)₇ and (PEP PAA)₇ coatings, EIS measurements were conducted in 5 mM Na₂SO₄ at both low and high pH to mimic the corrosion processes in anodic and cathodic regions, respectively. As a comparison, EIS measurements at neutral pH were also performed. EIS experiments were repeated twice and the representative EIS results of both coatings at varied pH are shown in FIGS. 19A-19F. For a (PEI/PAA)₇ coated sample corroded at pH 2.5, the impedance modulus at the frequency of 0.01 Hz (|Z_{0.01 Hz}|) gradually decreased from 2.1×10 to 5.3×10 ohm·cm during 7 h of immersion due to the degradation of coatings (FIG. 19B). However, the final |Z_{0.01 Hz}| value was still higher than that of the bare AA2024-T3 corroded at similar condition, indicating a corrosion protection from (PEI/PAA)₇ to bare metal substrates. Recalling the surface morphology of the (PEI/PAA)₇ coating immersed at pH 2.5 (FIGS. 10A-10C), small pores existed in the coating. Subsequently, the underlying AA2024-T3 substrate in these areas can be exposed to the corrosive environment, rendering an unsatisfying corrosion protection performance. In contrast, the |Z_{0.01 Hz}| value for the SrCrO₄ loaded sample was one order of magnitude higher than that of the (PEI/PAA)₇ coated sample (FIG. 19A). No significant decrease was observed after 7 h of immersion, indicating better protection to AA2024-T3. As shown in the phase plot, two time constants were observed for both (PEI/PAA)₇ and (SrCrO₄)₃/(PEI/PAA)₇ coated samples. The one at low frequency is controlled by the charge transfer polarization between coatings and substrates and the other at the frequency range of 10 Hz to 10 Hz reflects the property of coatings. For the (PEI/PAA)₇ coated sample, the time constant at low frequency dominated another time constant at middle/high frequency. Also, the maximum phase angle was shifted to higher frequency and became smaller with increasing immersion time, which was associated with the degradation of the coating. During immersion, pores were generated and the coating became less resistant so electrolyte gradually reached the metal substrate via pores with time, which resulted in the loss of capacitive response of the substrate/coating interface. On the other hand, little change was observed in the Bode phase plot of the (SrCrO₄)₃/(PEI/PAA)₇ coated sample, which further validated that the (SrCrO₄)₃/(PEI/PAA)₇ coating has a higher corrosion resistance than the (PEI/PAA)₇ coating. At pH 11, the impedance of (PEI/PAA)₇ coated sample at the middle frequency greatly decreased after the 3 h immersion, indicating fast water uptake and coating degradation, as shown in FIG. 19D. The |Z_{0.01 Hz}| value of the (PEI/PAA)₇ coated sample remained below 8×10 ohm·cm during the 7 h immersion and was similar to that of bare AA2024-T3. This was possibly due to the partial dissolution of the (PEI/PAA)₇ coating at basic conditions, which resulted in a large area of uncovered metal surface exposed to the aqueous environment (FIGS. 10A-10C). Accordingly, the (PEI/PAA)₇ coating barely protected AA2024-T3. Nevertheless, enclosing SrCrO₄ in PEI/PAA empowered the coating with strong corrosion protection to AA2024-T3 even in pH 11 solution as depicted in FIG. 19C. The |Z_{0.01 Hz}| value of the (SrCrO₄)₃/(PEI/PAA)₇ coating was nearly 8×10 ohm·cm, and it remained the same throughout the immersion. It should be mentioned that, at high frequency, the impedance increased with increasing frequency (FIG. 19C), which seems to be caused by experimental artifacts. The phase plots of the (SrCrO₄)₃/(PEI/PAA)₇ coated sample immersed at pH 11 were similar to those at pH 2.5. However, it is worth noting that there was a wide plateau at pH 11 from 1 Hz to 10 Hz in the phase plot of the (PEI/PAA)₇ coated sample instead of two distinct time constants as observed at pH 2.5. (PEI/PAA)₇ can be dissolved at pH 11, and AA2024-T3 is not fully covered by the coating. Therefore, it is can be difficult to observe the time constant associated with the property of the polymer. When the (PEI/PAA)₇ coated sample was immersed at pH 7, the |Z_{0.01 Hz}| value was around 8×10 ohm·cm at the beginning, which slightly decreased over time, suggesting a slow coating degradation, FIG. 19F. Compared with bare AA2024-T3, the |Z_{0.01 Hz}| value for the coated sample was one order of magnitude higher, suggesting good corrosion protection. The |Z_{0.01 Hz}| value for the (SrCrO₄)₃/(PEI/PAA)₇ coated sample, was similar to that of the (PEI/PAA)₇ coated sample, but it remained unchanged throughout the exposure, FIG. 19E. Again, in the phase plots, a wide plateau and two time constants were displayed in (PEI/PAA), coated sample and (SrCrO₄)₃/(PEI/PAA)₇ coated sample, respectively. At pH 7, PEI and PAA are partially charged, which can form a compact coating via ionic crosslinks. The crosslinks can be maintained at this pH condition, so the (PEI/PAA)₇ coating itself is capable of isolating the metal surface from the aqueous environment and providing protection without severe degradation within the exposure time. A wide plateau in the phase plot of (PEI/PAA)₇ possibly resulted from the uniform and compact coating formed on the AA2024-T3 substrate. In the case of the (SrCrO₄)₃/(PEI/PAA)₇ coated sample, two time constants were present and the time constant at 10 Hz-10 Hz is likely associated with the presence of the (PEI/PAA)₇ coating.

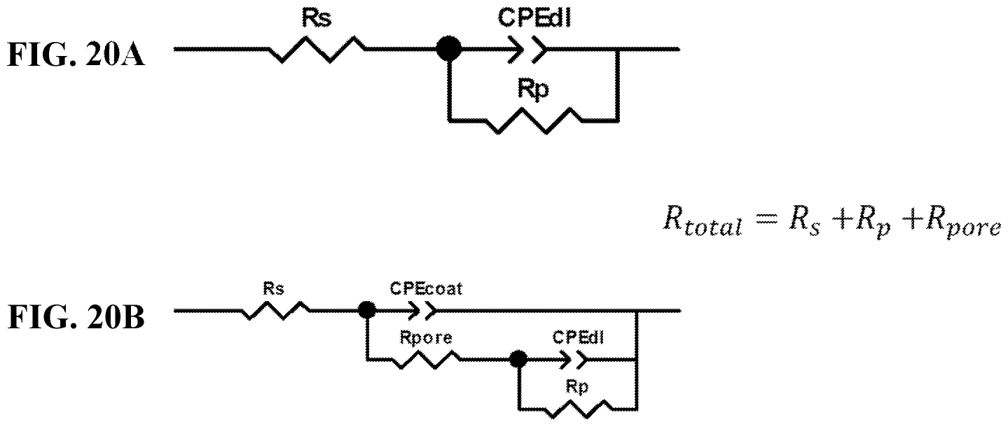

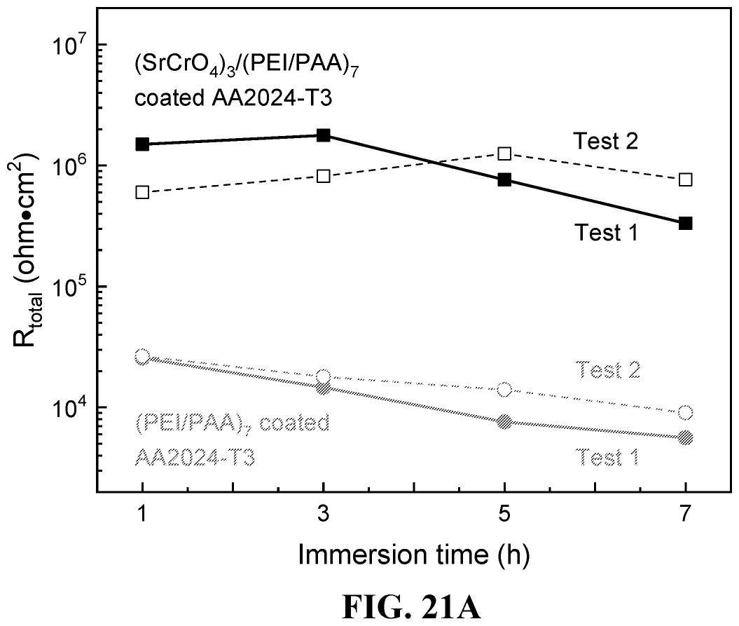

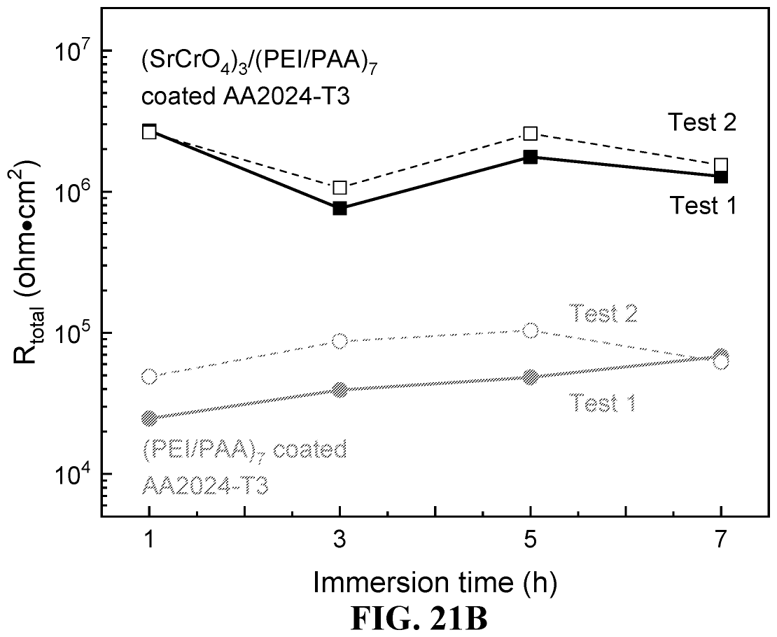

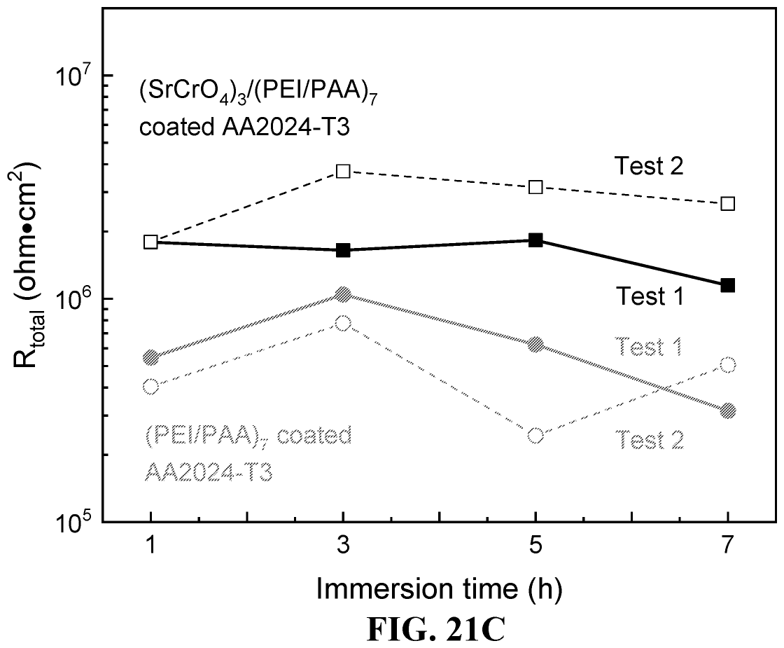

To quantitatively evaluate the corrosion protective properties of the (PEI/PAA)₇ and (SrCrO₄)₃/(PEI/PAA)₇ coatings, the EIS results were fitted with equivalent circuits. An equivalent circuit with one time constant was used to describe bare AA2024-T3 (FIG. 20A). Another equivalent circuit with two time constants was applied to fit (PEI/PAA)₇ coated samples and (SrCrO₄)₃/(PEI/PAA)₇ coated samples corroded at all pH (FIG. 20B). The higher frequency time constant described the properties of the coatings and the lower frequency time constant was related to the charge-transfer process at the interface of the metal surface and coatings. Constant phase elements (CPE) were applied to interpret the non-ideal capacitive behavior. Rₛ corresponds to the solution resistance. Rₚ and CPE_{dl} represent the polarization resistance of the metal substrate and the CPE of the double layer, respectively. Rₚₒᵣₑ and CPE_{coat} stand for the pore resistance and CPE of the coatings. The fitted curves are shown in Bode plots as solid lines (FIGS. 19A-F) and the fitted electrical parameter values are listed in Table 5. The sum of Rₛ, Rₚ and Rₚₒᵣₑ, denoted as Rₜₒₜₐₗ, of (PEI/PAA)₇ and (SrCrO₄)₃/(PEI/PAA)₇ coated samples was compared to illustrate the corrosion protection performance since a higher value of Rₜₒₜₐₗ reflects better corrosion resistance. Two replicates of EIS experiments were performed and Rₜₒₜₐₗ values from both experiments as function of immersion time are presented in FIGS. 21A-21C. At pH 2.5, the Rₜₒₜₐₗ of (PEI/PAA)₇ coated samples gradually decreased. In comparison, the Rₜₒₜₐₗ of the (SrCrO₄)₃/(PEI/PAA)₇ coated sample was around 1×10 ohm·cm with a slight decrease throughout the immersion. Regardless of immersion time, Rₜₒₜₐₗ of the (SrCrO₄)₃/(PEI/PAA)₇ coated sample was almost two orders of magnitude higher than that of the (PEI/PAA)₇ coated sample, which is an indication of enhanced corrosion protection for AA2024-T3 (FIG. 21A). At pH 11, Rₜₒₜₐₗ of (PEI/PAA)₇ coated sample was within the range of 2×10 to 7×10 ohm·cm with time. The values were close to that of bare AA2024-T3 corroded at the same pH, suggesting that the coating barely protects AA2024-T3 from corrosion. As previously mentioned, the coating was hydrophilic and could be dissolved at pH 11. However, the partially covered Al substrate still had a lower capacitance compared to the bare Al alloy, as indicated in the higher impedance value shown in the middle range frequency (FIG. 19D). During immersion, the water uptake of the PEI/PAA caused partial dissolution of the coatings, which led to the increase of capacitance value (data not shown). This may be the reason why the impedance in the middle frequency region decreased over time. Recall that Rₜₒₜₐₗ equals the sum of Rₛ, Rₚₒᵣₑ and Rₚ. Due to the high solubility of the coating, the Rₚₒᵣₑ value was small, so it did not contribute significantly to the Rₜₒₜₐₗ. An EIS test of bare AA2024 corroded at pH 11 for 7 h was also performed (data not shown) and the change of Rₜₒₜₐₗ was similar to that shown in the (PEI/PAA)₇ coated sample immersed at pH 11. This further indicates that the (PEI/PAA)₇ coating was partially dissolved and part of the metal surface was exposed to the aqueous environment throughout the immersion. This may explain why the Rₜₒₜₐₗ values were similar for the coated and noncoated Al substrates corroded at pH 11. On the other hand, Rₜₒₜₐₗ of (SrCrO₄)₃/(PEI/PAA)₇ coated sample fluctuated above 1×10 ohm·cm, presenting higher corrosion protection (FIG. 21B). Concerning pH 7, the Rₜₒₜₐₗ values of (PEI/PAA)₇ and (SrCrO₄)₃/(PEI/PAA)₇ coated samples were on the same order of magnitude and stayed around 1×10 ohm·cm throughout the EIS measurements (FIG. 21C). This suggests that both coatings provided good protection to the AA2024-T3 substrate owing to the less aggressive solution environment.

TABLE 5
Electrical elements fitted values for (PEI/PAA)₇ and (SrCrO₄)₃/(PEI/PAA)₇
coated AA2024-T3 immersed at 5 mM Na₂SO₄ solution with varied pH.

| | | Time | Rs | A_{coat} | | Rₚₒᵣₑ | A_{dl} | | Rₚ |
|---|---|---|---|---|---|---|---|---|---|
| | | (h) | (ohm · cm²) | (ohm⁻¹ · cm⁻² · s^{α}) | α_{coat} | (ohm · cm²) | (ohm⁻¹ · cm⁻² · s^{α}) | α_{dl} | (ohm · cm²) |
| (PEI/PAA)₇ | pH 2.5 | 1 | 20.0 | 3.19 × 10⁻⁵ | 0.90 | 0.89 × 10² | 2.41 × 10⁻⁵ | 0.99 | 2.55 × 10⁴ |
| | | 3 | 15.9 | 3.46 × 10⁻⁵ | 0.90 | 0.78 × 10² | 2.37 × 10⁻⁵ | 0.99 | 1.46 × 10⁴ |
| | | 5 | 14.9 | 4.44 × 10⁻⁵ | 0.89 | 1.01 × 10² | 2.42 × 10⁻⁵ | 0.99 | 7.46 × 10³ |
| | | 7 | 14.6 | 4.70 × 10⁻⁵ | 0.90 | 1.24 × 10² | 2.42 × 10⁻⁵ | 0.99 | 5.47 × 10³ |
| | pH 7 | 1 | 56.7 | 8.32 × 10⁻⁶ | 0.91 | 1.64 × 10⁵ | 2.74 × 10⁻⁶ | 0.99 | 3.80 × 10⁵ |
| | | 3 | 43.0 | 9.54 × 10⁻⁶ | 0.89 | 2.50 × 10⁵ | 4.89 × 10⁻⁶ | 0.99 | 7.93 × 10⁵ |
| | | 5 | 48.8 | 1.11 × 10⁻⁵ | 0.87 | 3.15 × 10⁵ | 1.05 × 10⁻⁵ | 0.99 | 3.08 × 10⁵ |
| | | 7 | 43.5 | 1.42 × 10⁻⁵ | 0.81 | 0.80 × 10² | 1.42 × 10⁻⁶ | 0.99 | 3.15 × 10⁵ |
| | pH 11 | 1 | 10.6 | 1.03 × 10⁻⁵ | 0.96 | 6.62 × 10³ | 1.23 × 10⁻⁵ | 0.99 | 1.81 × 10⁴ |
| | | 3 | 4.7 | 2.31 × 10⁻⁵ | 0.92 | 4.24 × 10³ | 1.20 × 10⁻⁵ | 0.99 | 3.51 × 10⁴ |
| | | 5 | 5.8 | 2.64 × 10⁻⁵ | 0.91 | 6.27 × 10³ | 8.33 × 10⁻⁶ | 0.99 | 3.73 × 10⁴ |
| | | 7 | 7.6 | 3.1 × 10⁻⁵ | 0.89 | 3.68 × 10⁴ | 1.42 × 10⁻⁴ | 0.99 | 3.14 × 10⁴ |
| (SrCrO₄)₃/ | pH 2.5 | 1 | 21.3 | 7.68 × 10⁻⁶ | 0.92 | 3.96 × 10⁴ | 1.12 × 10⁻⁵ | 0.82 | 1.46 × 10⁶ |
| (PEI/PAA)₇ | | 3 | 10.9 | 5.57 × 10⁻⁶ | 0.97 | 9.87 × 10³ | 1.25 × 10⁻⁵ | 0.71 | 1.77 × 10⁶ |
| | | 5 | 9.1 | 6.35 × 10⁻⁶ | 0.96 | 1.15 × 10⁴ | 1.42 × 10⁻⁵ | 0.78 | 7.51 × 10⁵ |
| | | 7 | 8.7 | 6.64 × 10⁻⁶ | 0.97 | 1.07 × 10⁴ | 1.52 × 10⁻⁵ | 0.85 | 3.22 × 10⁵ |
| | pH 7 | 1 | 19.7 | 5.98 × 10⁻⁶ | 0.90 | 7.34 × 10⁴ | 1.10 × 10⁻⁵ | 0.89 | 1.72 × 10⁶ |
| | | 3 | 18.9 | 5.75 × 10⁻⁶ | 0.92 | 6.06 × 10⁴ | 1.10 × 10⁻⁵ | 0.81 | 1.59 × 10⁶ |
| | | 5 | 18.9 | 5.84 × 10⁻⁶ | 0.92 | 5.86 × 10⁴ | 1.20 × 10⁻⁵ | 0.81 | 1.77 × 10⁶ |
| | | 7 | 17.5 | 6.02 × 10⁻⁶ | 0.93 | 5.19 × 10⁴ | 1.28 × 10⁻⁵ | 0.86 | 1.10 × 10⁶ |
| | pH 11 | 1 | 19.2 | 7.17 × 10⁻⁶ | 0.92 | 7.34 × 10⁴ | 1.26 × 10⁻⁵ | 0.86 | 2.64 × 10⁶ |
| | | 3 | 5.3 | 6.77 × 10⁻⁶ | 0.93 | 6.06 × 10⁴ | 1.07 × 10⁻⁵ | 0.90 | 7.10 × 10⁵ |
| | | 5 | 5.9 | 7.11 × 10⁻⁶ | 0.93 | 5.86 × 10⁴ | 1.35 × 10⁻⁵ | 0.88 | 1.71 × 10⁶ |
| | | 7 | 6.8 | 7.10 × 10⁻⁶ | 0.94 | 5.19 × 10⁴ | 1.20 × 10⁻⁵ | 0.88 | 1.24 × 10⁶ |

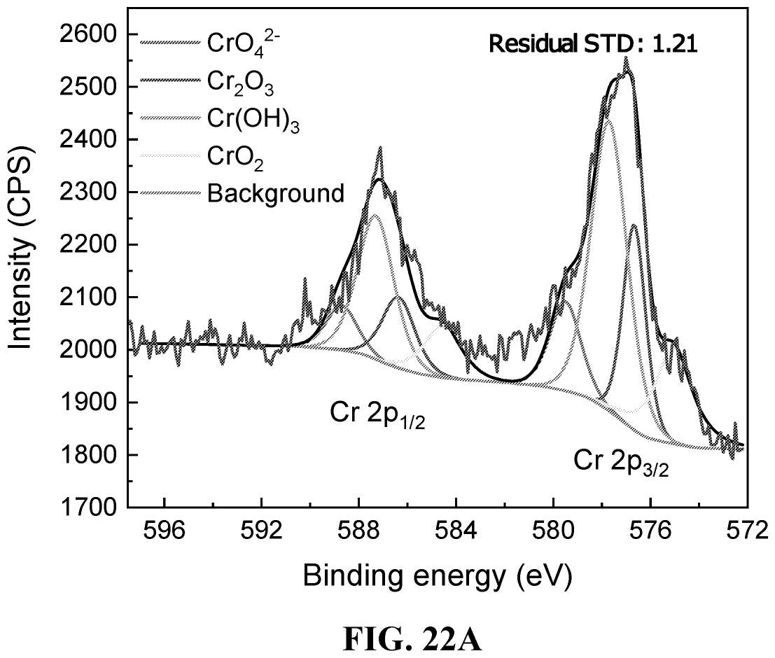

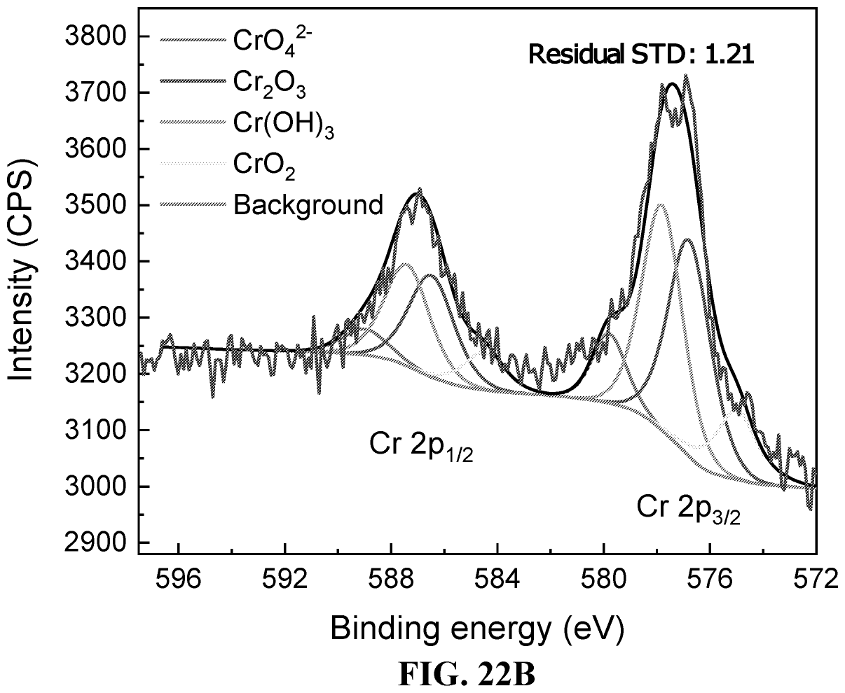

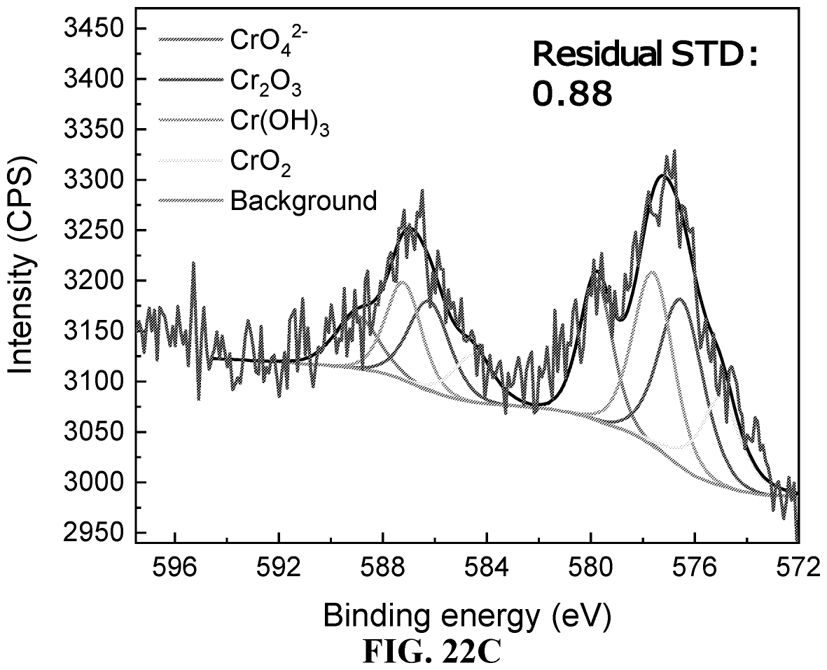

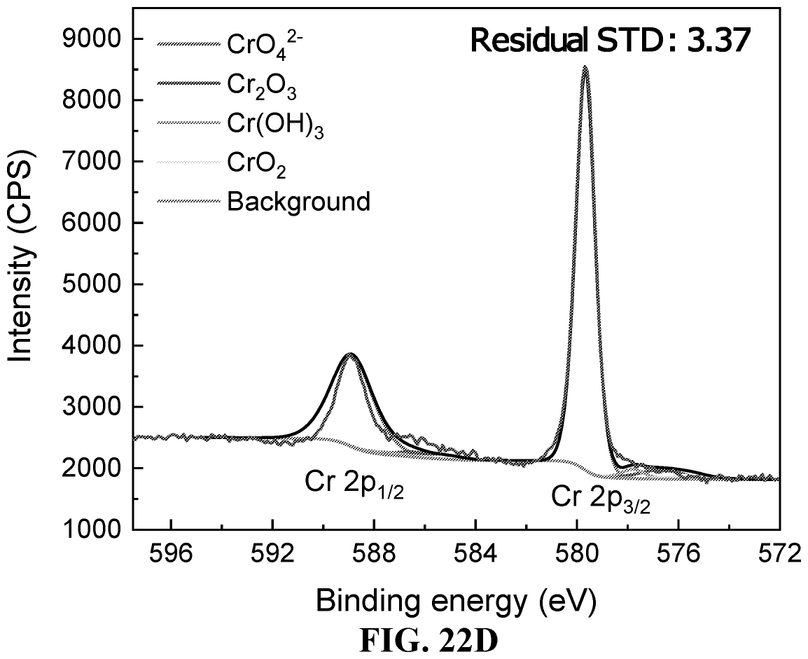

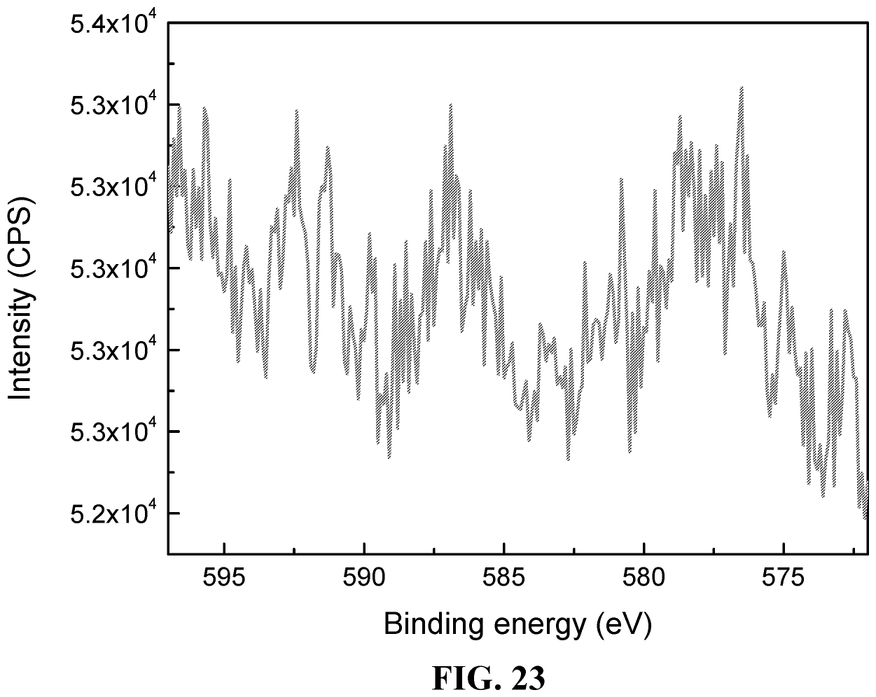

The introduction of SrCrO₄ in the (PEI/PAA)₇ coating had little influence on the thickness of the coatings. Although the morphology and wettability of the surface was greatly changed, the (SrCrO₄)₃/(PEI/PAA)₇ coated sample remained hydrophilic and could take up water with time. Additionally, microcavities generated by the incorporation of SrCrO₄ could be vulnerable sites for corrosion since they may act as pathways for the electrolyte to reach the metal surface. However, (SrCrO₄)₃/(PEI/PAA)₇ coated samples exhibited higher corrosion resistance during the EIS tests, and thus it is certain that SrCrO₄ provided additional protection to the AA2024-T3 substrates. To study the role of SrCrO₄ in the corrosion protection, XPS was used to analyze the oxidation state of chromium on the surface of the metal substrate after EIS measurement. It should be noted that the XPS signals were not very high, possibly due to the remained polymer coatings on the top of SrCrO₄, which prevented XPS from detecting the signals of SrCrO₄ beneath the polymer coating. As shown in FIG. 22A-22D Cr(VI) was reduced to Cr(III) and Cr(IV) after corrosion in all three pH conditions. Although the intermediate species Cr (IV) was observed, most reduced chromium was in the Cr(III) state. The percentage of remaining Cr(VI) was 13%, 22% and 10% at pH 2.5, 7 and 11, respectively. Photoreduction of chromium may occur during XPS. Hence, the oxidation state of chromium prior to corrosion was examined by XPS as a control group to determine the photoreduction effects. The intact polymer coating prevented XPS from detecting the signal of chromium beneath the coating (FIG. 23). Therefore, to increase the resolution of XPS, SrCrO₄ salts were deposited on an AA2024-T3 substrate and analyzed by XPS (FIG. 22D). The results showed that Cr(III) and Cr (IV) existed in the complex compound but the signal from Cr(VI) dominated. Therefore, it can be concluded that most Cr(VI) was reduced during corrosion and the reduction of chromium is not mainly caused by photoreduction during the XPS analysis. In the case of pH 7, despite of the hydrophilicity of PEI/PAA coacervates and the defects within polymer coatings, it is possible that coatings are capable of covering the majority of SrCrO₄. As shown in FIGS. 10A-10C, a compact coating was preserved at pH 7, possibly due to unweakened crosslinks within PEI/PAA coacervates, to retard the electrolyte ingress and protect SrCrO₄ beneath the coating from being reduced. Additionally, the reduction of Cr(VI) is limited by a lower oxidation rate of the intermetallic particles and matrix of AA2024-T3 at pH 7 compared to pH 2.5 and pH 11. Therefore, more Cr(VI) is present after EIS measurements. On the other hand, after immersion at acidic or basic conditions, ionic crosslinks between PEI and PAA failed, leading to the formation of pores and the ingress of electrolyte. Subsequently, the Cr(VI) species were released into the local electrolyte and reduced to Cr(III) and Cr (IV) on the metal surface, enabling the formation of an insoluble film that suppressed the corrosion of AA2024-T3.

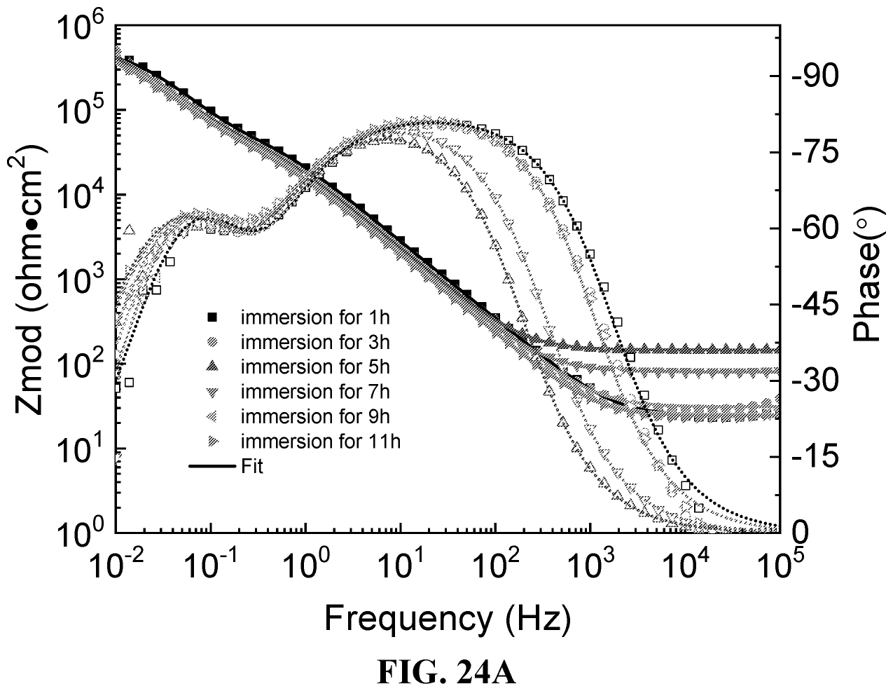

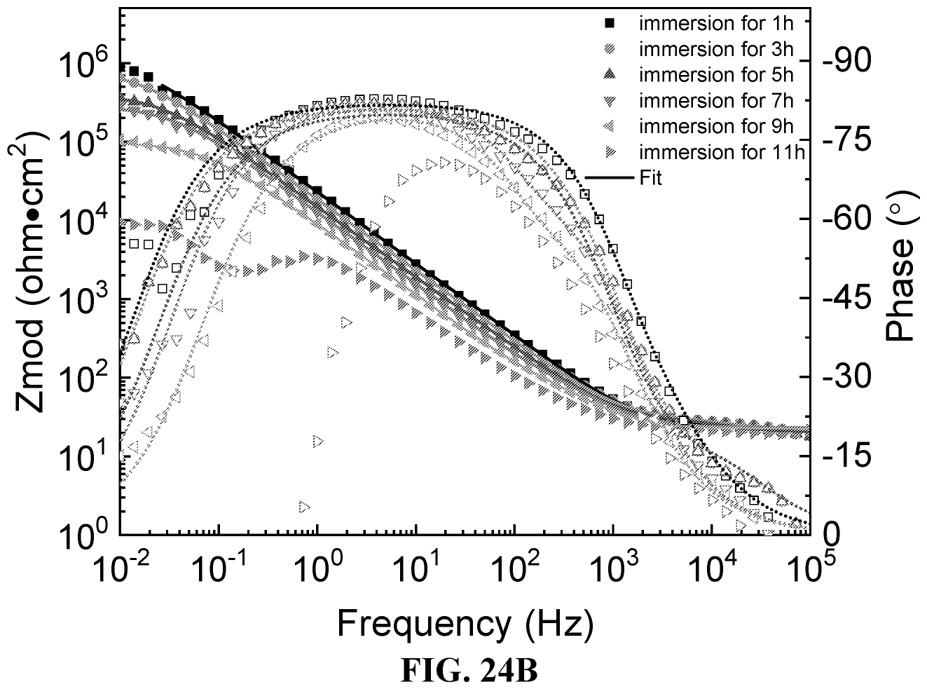

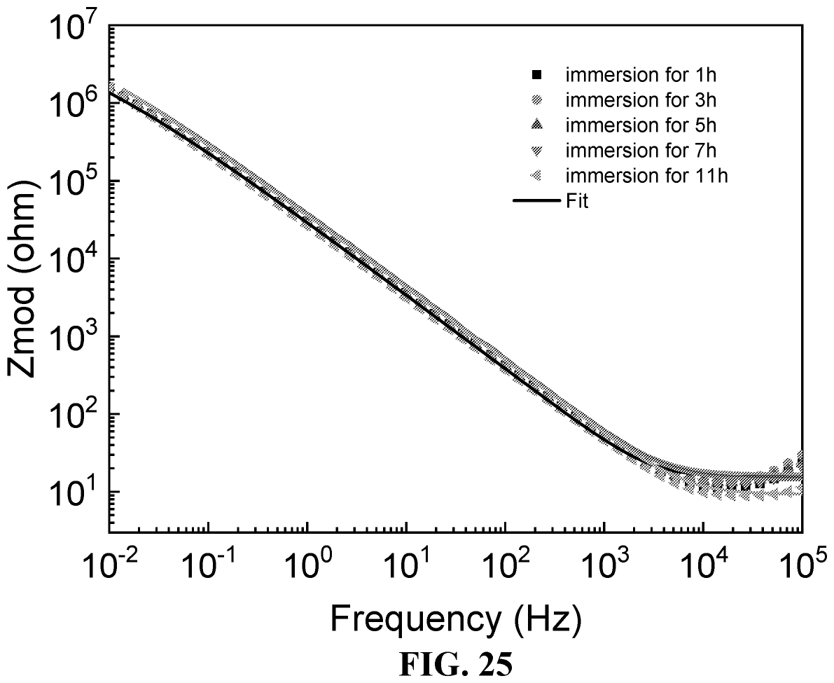

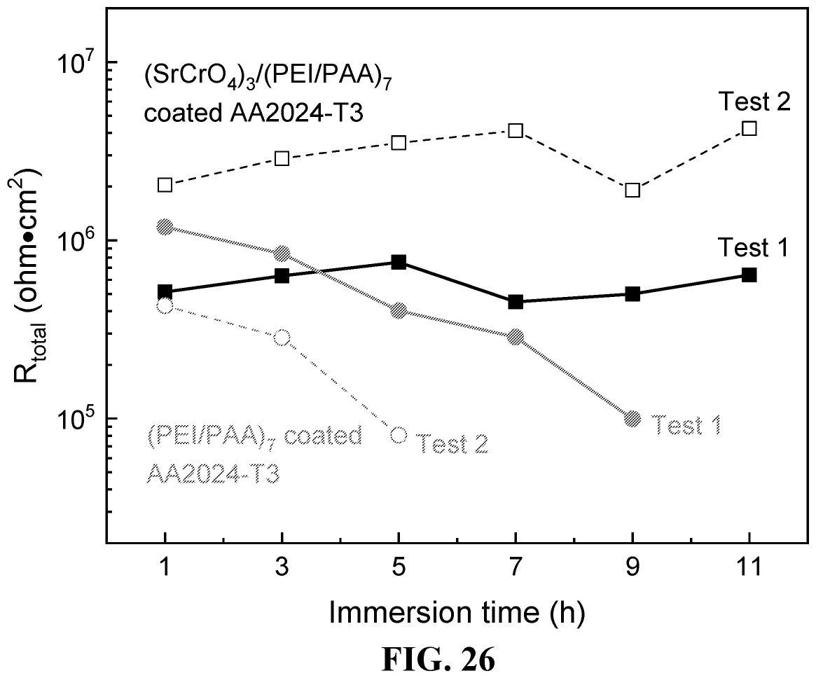

The corrosion resistance of (SrCrO₄)₃/(PEI/PAA)₇ coated samples was further investigated by EIS in air-exposed 50 mM NaCl for 11 h. The results are shown in FIG. 24A. The |Z_{0.01 Hz}| value of (SrCrO₄)₃/(PEI/PAA)₇ coated sample was consistently above 4×10 ohm·cm throughout the immersion period. However, the |Z_{0.01 Hz}| value of (PEI/PAA)₇ coated sample quickly decreased from 8×10 to 8×10 ohm·cm after 11 h due to the degradation of the coating (FIG. 24B). Additionally, in the Bode phase plot, the maximum phase angle of (PEI/PAA)₇ coated sample was reduced in value and shifted to a higher frequency, further indicating coating degradation probably caused by local pH changes and the presence of salts during corrosion. It should be noted that the impedance modulus at high frequency of (SrCrO₄)₃/(PEI/PAA)₇ coated sample exhibited a sudden increase after immersion for 5 h and 7 h (FIG. 24A) This is possibly due to experimental artifacts considering no such behavior was shown in the replicated EIS test (FIG. 25). The quantitative fitting of EIS spectra acquired from (PEI/PAA)₇ and (SrCrO₄)₃/(PEI/PAA)₇ coated samples in duplicated EIS experiments was achieved by using the aforementioned equivalent circuits with two time constants (FIG. 20B). The fitted results are listed in Table 6. Rₜₒₜₐₗ was compared to demonstrate the corrosion performance of the (PEI/PAA)₇ and (SrCrO₄)₃/(PEI/PAA)₇ coatings in NaCl solutions FIG. 26). Rₜₒₜₐₗ was unchanged after 11 h immersion for the (SrCrO₄)₃/(PEI/PAA)₇ coated sample but greatly dropped by one order of magnitude after 9 h of immersion for the (PEI/PAA)₇ coated sample during the first EIS measurement. The EIS data of (PEI/PAA)₇ coated sample after 11 h immersion were not fitted because the coating experienced massive failure (FIG. 24B). In the second EIS measurement, the (PEI/PAA)₇ coating experienced an even earlier breakdown and the coating failure was observed after 7 h immersion (data not shown), so Rₜₒₜₐₗ was only recorded in the early stage of immersion. On the other hand, Rₜₒₜₐₗ of the (SrCrO₄)₃/(PEI/PAA)₇ coated sample remained above 1×10 ohm·cm, indicating better corrosion protection of the (SrCrO₄)₃/(PEI/PAA)₇ coating.

TABLE 6
Electrical elements fitted values for (PEI/PAA)₇ and
(SrCrO₄)₃/(PEI/PAA)₇ coated AA2024-T3 immersed at 50 mM NaCl solution.

| | Time | Rs | A_{coat} | | Rₚₒᵣₑ | A_{dl} | | Rₚ |
|---|---|---|---|---|---|---|---|---|
| | (h) | (ohm · cm²) | (ohm⁻¹ · cm⁻² · s^{α}) | α_{coat} | (ohm · cm²) | (ohm⁻¹ · cm⁻² · s^{α}) | α_{dl} | (ohm · cm²) |
| (PEI/PAA)₇ | 1 | 22.0 | 7.33 × 10⁻⁶ | 0.90 | 0.87 × 10² | 8.07 × 10⁻⁷ | 0.99 | 1.18 × 10⁶ |
| | 3 | 23.9 | 8.91 × 10⁻⁶ | 0.88 | 1.06 × 10² | 1.41 × 10⁻⁶ | 0.99 | 8.41 × 10⁵ |
| | 5 | 23.5 | 1.12 × 10⁻⁵ | 0.89 | 3.69 × 10² | 1.56 × 10⁻⁶ | 0.99 | 4.02 × 10⁵ |
| | 7 | 23.1 | 1.27 × 10⁻⁵ | 0.89 | 4.73 × 10² | 1.99 × 10⁻⁶ | 0.99 | 2.85 × 10⁵ |
| | 9 | 22.5 | 1.84 × 10⁻⁵ | 0.87 | 3.52 × 10² | 3 × 10⁻⁶ | 0.99 | 9.91 × 10⁴ |
| (SrCrO₄)₃/ | 1 | 24.3 | 7.77 × 10⁻⁶ | 0.92 | 7.55 × 10⁴ | 1.2 × 10⁻⁵ | 0.96 | 4.37 × 10⁵ |
| (PEI/PAA)₇ | 3 | 31.0 | 8.78 × 10⁻⁶ | 0.93 | 6.55 × 10⁴ | 1.45 × 10⁻⁵ | 0.92 | 5.66 × 10⁵ |
| | 5 | 145.2 | 9.64 × 10⁻⁶ | 0.92 | 6.89 × 10⁴ | 1.45 × 10⁻⁵ | 0.88 | 6.84 × 10⁵ |
| | 7 | 80.0 | 1.05 × 10⁻⁵ | 0.92 | 7.85 × 10⁴ | 1.62 × 10⁻⁵ | 0.99 | 3.73 × 10⁵ |
| | 9 | 25.1 | 1.07 × 10⁻⁵ | 0.93 | 6.18 × 10⁴ | 1.49 × 10⁻⁵ | 0.92 | 4.37 × 10⁵ |
| | 11 | 24.1 | 1.1 × 10⁻⁵ | 0.93 | 5.52 × 10⁴ | 1.5 × 10⁻⁵ | 0.86 | 5.84 × 10⁵ |

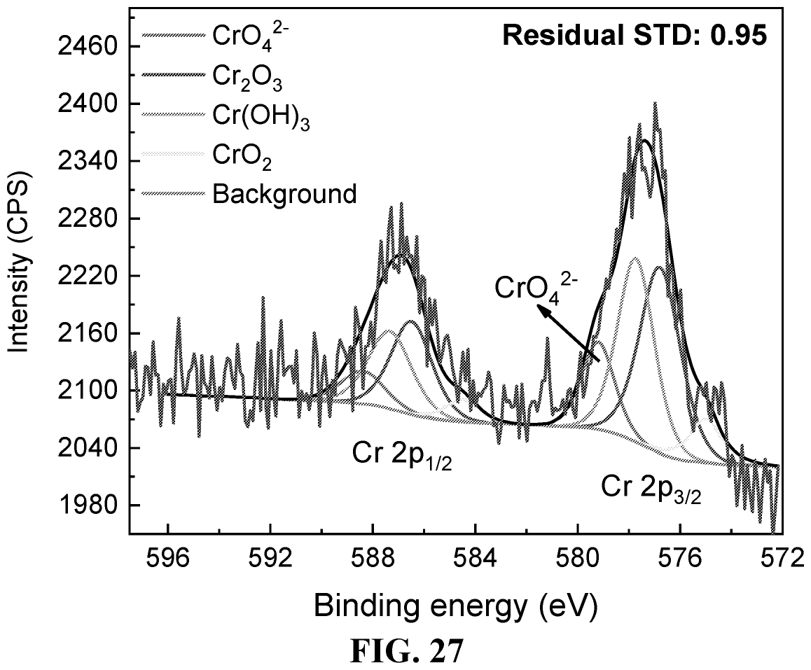

After the EIS measurement, the oxidation state of chromium on the (SrCrO₄)₃/(PEI/PAA)₇ coated sample was further examined by XPS. As shown in FIG. 27, more than 85% Cr(VI) was converted to Cr(III), suggesting that an insoluble oxide or hydroxide film of Cr(III) was formed and thus provided corrosion protection to AA2024-T3. Without additional support from SrCrO₄, (PEI/PAA)₇ coatings degraded much faster and displayed a deterioration of corrosion protection behavior with immersion time.

### Example 3

Ce(NO₃)₃-loaded nanofibers were fabricated by the coaxial electrospinning technique. Cerium salts were used as the corrosion inhibitor and confined within the core of the nanofibers, while the polyelectrolyte coacervate consisting of chitosan and PAA was employed as the shell material. The resulting nanofibers presented a dual-pH sensitive behavior, which could release Ce(NO₃)₃ faster when pH decreases or increases. Such nanofibers were added into a PVB coating matrix and did not substantially affect the barrier property of the coating matrix, especially for the samples prepared by the dip-coating method. EIS measurements were carried out on the intact coating samples, i.e. Fiber-PVB and Ce-Fiber-PVB, and demonstrated excellent corrosion resistance of Ce-Fiber-PVB. EIS tests were also conducted on damaged coated samples, and the result showed that corrosion inhibitors could transport through the nanofibers, guaranteeing the local supply of the inhibitors for repeated self-healing performance

### Materials

Chitosan (with a medium molecular weight and deacetylation degree of 75%-85%), PAA (Mᵥ=450,000 g/mol), and rhodamine B base were purchased from Sigma-Aldrich. Formic acid, Hoechst 33258 pentahydrate, and cerium(III) nitrate hexahydrate were obtained from Fisher Scientific. PVB was ordered from Pfaltz & Bauer, and acetic acid glacial was purchased from Mallinkrodt AR. All aqueous solutions were made using deionized (DI) water with a resistivity of 18.2 MΩ·cm from a Milli-Q® filtration system. Aluminum alloy 2024-T3 substrates were abraded using SiC papers from 240 up to 1200 grit with ethanol as a lubricant.

### Preparation of Organic Dye-Loaded Coatings.

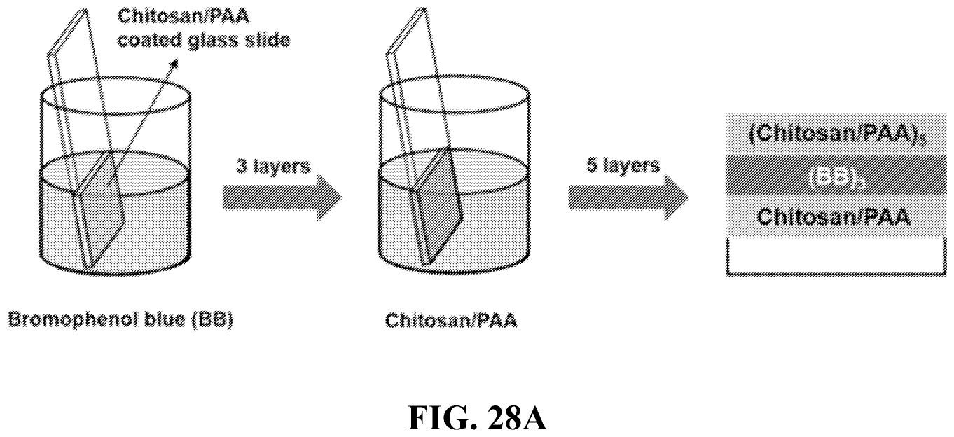

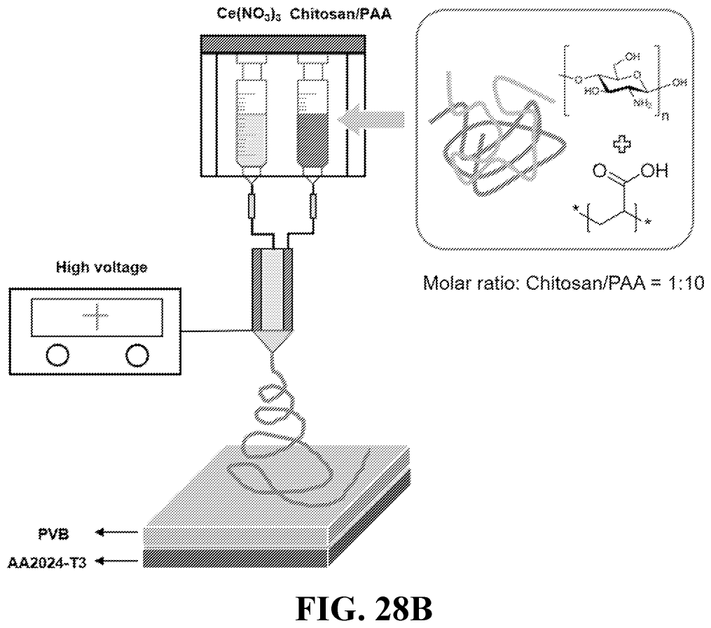

1.5 wt % Chitosan and 12 wt % PAA solutions were prepared in 60% aqueous formic acid and 90% aqueous acetic acid, respectively, following approaches described in the literature.²⁸ Both chitosan and PAA solutions were continuously stirred overnight at 50° C., and then the chitosan/PAA coacervate was prepared by adding the PAA solution into the chitosan solution dropwise while stirring until achieving a chitosan:PAA volume ratio of 2:1. To prepare organic dye loaded coating samples, a glass slide was firstly dip-coated with one layer of chitosan/PAA polyelectrolyte coacervate, followed by immersion in bromophenol blue (BB) solution three times with ethanol as the solvent. The subsequent deposition of 5 layers of the chitosan/PAA coacervate was performed by immersing the glass slide into the coacervate solution 5 times for a complete enclosure of organic dye (FIG. 28A). The duration for each immersion step was 10 s. The resulting organic dye-loaded coated sample was denoted as (BB)₃/(chitosan/PAA)₅.

### Release Study of BB and Morphology Characterization of Coatings.

To investigate the release behavior of BB from the chitosan/PAA coacervate, (BB)₃/(chitosan/PAA)₅ coated glass slides (40×25 mm) were immersed in 10 mL of DI water for 24 h. The pH of DI water was adjusted by 0.1 M H₂SO₄ or NaOH to pH 2.5, 7, or 10. After 24 h of immersion, the released media were collected, and the color of the released media was recorded by optical photography. To study the surface morphology of coatings, only 5 layers of the chitosan/PAA coacervate were dip-coated on silicon wafers that were then immersed in DI water with various pH (i.e. pH 2.5, 7, and 10) for 24 h. The morphology of the coatings before and after immersion was examined by optical microscopy.

Fabrication of Ce(NO₃)₃-Loaded Nanofibers

The Ce(NO₃)₃-loaded nanofibers were obtained by a coaxial electrospinning technique FIG. 28B. The chitosan/PAA coacervate solution and 0.5 M Ce(NO₃)₃ dissolved in acetone were used as the shell and core liquids, respectively. The solutions were fed through a coaxial nozzle consisting of two concentrically arranged needles. A potential of 15 kV was applied on the tip of the nozzle. The nozzle-to-collector distance was 20 cm. The diameters of the inner and outer needles were 0.64 and 1.02 mm, respectively. The injection rates of the core and shell solutions were 0.2 and 1.0 mL/h, respectively. The Ce(NO₃)₃-loaded nanofibers were collected on a grounded plate and then dried in an oven at 100° C. for 1 h to eliminate the residual solvents.

Characterization of Ce(NO₃)₃-Loaded Nanofibers

The morphology and composition of the Ce(NO₃)₃-loaded nanofibers were examined by SEM coupled with EDS under an acceleration voltage of 5 kV. To reveal the core-shell structure of the nanofibers, confocal spectroscopy (Olympus FV1000 Filter Confocal System) and TEM (FEI Tecnai G2 Biotwin System) were utilized. To achieve fluorescent signals for confocal spectroscopic analysis, the shell solution with Hoechst 33258 pentahydrate and the core solution with rhodamine B base were simultaneously electrospun during the electrospinning process, and the as-spun nanofibers were collected on a glass slide. Subsequently, the core-shell structure was inspected by confocal spectroscopy with a laser excitation wavelength of 544 nm for rhodamine B base and 355 nm for Hoechst 33258 pentahydrate, respectively. For TEM observation, the as-spun nanofibers were directly deposited onto a 200-mesh carbon-coated Cu grid and then examined by TEM to discriminate the core and shell regions of the nanofibers.

Release Study of Ce(III) from Ce(NO₃)₃-Loaded Nanofibers

The release of Ce(III) from Ce(NO₃)₃-loaded nanofibers was assessed by measuring the amount of released Ce(III) at specific time intervals with UV-vis spectroscopy at λₘₐₓ=250 nm. Typically, Ce(NO₃)₃-loaded nanofibers were electrospun on glass slides for 1 h. The nanofibers coated glass slides were then immersed in 10 mL of DI water with pH 2.5, 7, or 10, adjusted by 0.1 M H₂SO₄ or NaOH solutions. At each sampling time, a 4 mL aliquot was extracted from the release medium for UV-vis analysis and replaced with an equivalent volume of fresh DI water with the same pH. The amount of released Ce(III) in the withdrawn solution was extrapolated from a calibration curve and the cumulative concentration of released Ce(III) was plotted as a function of time. For the release study at each pH condition, three independent measurements were performed to ensure reproducibility.

The Effect of Ce(NO₃)₃-Loaded Nanofibers on the Integrity of the Coating Matrix

Two coating formulas derived from embedding Ce(NO₃)₃-loaded nanofibers or Ce(NO₃)₃-loaded microspheres in a PVB coating matrix were used to evaluate the influence of the additive on the protective property of the coating matrix. The fabrication procedure of electrospun Ce(NO₃)₃-loaded nanofibers is presented above, as is the fabrication of Ce(NO₃)₃-loaded microspheres by a coaxial electrospray method. To introduce Ce(NO₃)₃-loaded nanofibers or microspheres into the PVB coating matrix, the nanofibers or microspheres were directly deposited onto PVB bar-coated AA2024-T3 substrates during the electrospinning or the electrospraying process. Then another 3 layers of PVB were bar-coated to fully cover the nanofibers or the microspheres. The coated samples with a sandwich structure were obtained and subjected to EIS measurements in 100 mM NaCl with a neutral pH. The EIS tests were carried out using a Gamry™ Reference 600 potentiostat with a frequency range of 10⁵ Hz to 0.01 Hz. A three-electrode cell was used, consisting of a saturated calomel reference electrode (SCE), a platinum mesh counter electrode, and the coated substrate as a working electrode with an exposed area of 1 cm². After allowing the open circuit potential (OCP) to stabilize for 1 h, EIS spectra were recorded at the OCP with a 10 mV sinusoidal perturbation.

Surface Morphology Characterization of pH-Sensitive Coatings and Electrochemical Impedance Measurements.

pH-sensitive coatings were developed using a dip-coating method. Briefly, an AA2024-T3 substrate was firstly immersed in 1.25 wt % PVB ethanol solution for 10 s and then used as a collector to gather Ce(NO₃)₃-loaded nanofibers during the electrospinning process for 1 h. After drying the nanofibers in the oven at 100° C. for 1 h, the sample was immersed in PVB for 10 s three times to deposit three layers of PVB on top of the nanofibers. The resulted coating was denoted as Ce-Fiber-PVB. As a reference, nanofibers without Ce(NO₃)₃ were prepared by electrospinning the chitosan/PAA coacervate solution and acetone as the shell and core liquids, respectively. Then the inhibitor-free nanofibers were incorporated into the PVB coating with the same procedure, and the coating was named Fiber-PVB. The surface morphology of both coating samples was explored by SEM. Moreover, 4 individual layers of PVB were sequentially dip-coated on AA2024-T3 and the surface morphology was recorded by SEM as a control. To inspect the protectiveness of Ce-Fiber-PVB and Fiber-PVB, EIS measurements were conducted on these coated samples after acquiring the OCP for 1 h in two sets of electrolyte solutions: 100 mM NaCl with neutral pH and 5 mM Na₂SO₄ with pH 2.5, 7, or 10 adjusted by 0.1 M H₂SO₄ or NaOH. 100 mM NaCl solution was used to investigate the corrosion protection performance of coated samples in a corrosive environment, whereas Na₂SO₄ with various pH was chosen to evaluate the protective ability of coating samples under environments undergoing anodic and cathodic reactions during metal corrosion.

Scribe Protection of Coating with Ce(NO₃)₃-Loaded Nanofiber

To investigate if the Ce(NO₃)₃-loaded nanofibers can protect the metal substrate against corrosion repeatedly, the electrospun nanofibers were deposited on an AA2024-T3 substrate bar-coated with a single layer of PVB, followed by being fully dried in an oven at 100° C. for 1 h. Epoxy resin (EpoThin™ 2 No. 20-3440) and hardener (EpoThin™ 2 No. 20-3442) with a mass ratio of 100:45 were mixed, and the mixture was applied on top of the nanofibers with a brush. After being cured overnight at room temperature, a typical coating sample was obtained. An artificial scratch with a length of 1 cm was created on the coating by a diamond scriber and thus the underlying metal substrate was exposed. The diameter of the diamond tip is approximately 0.5 mm. Subsequently, the sample was immersed in 100 mM NaCl with a neutral pH, and the impedance was repeatedly measured for 18 h. Before each EIS measurement, the OCP was stabilized for 30 min. After 18 h immersion, the same location was prescribed to re-expose the bare metal for the following EIS tests. In comparison, another coated sample based on the encapsulation of Ce(NO₃)₃-loaded microspheres was prepared and tested in the same way to assess its repeated self-healing performance.

### Results

### Dual-pH Sensitive Behavior of Chitosan/PAA Polyelectrolyte Coacervate

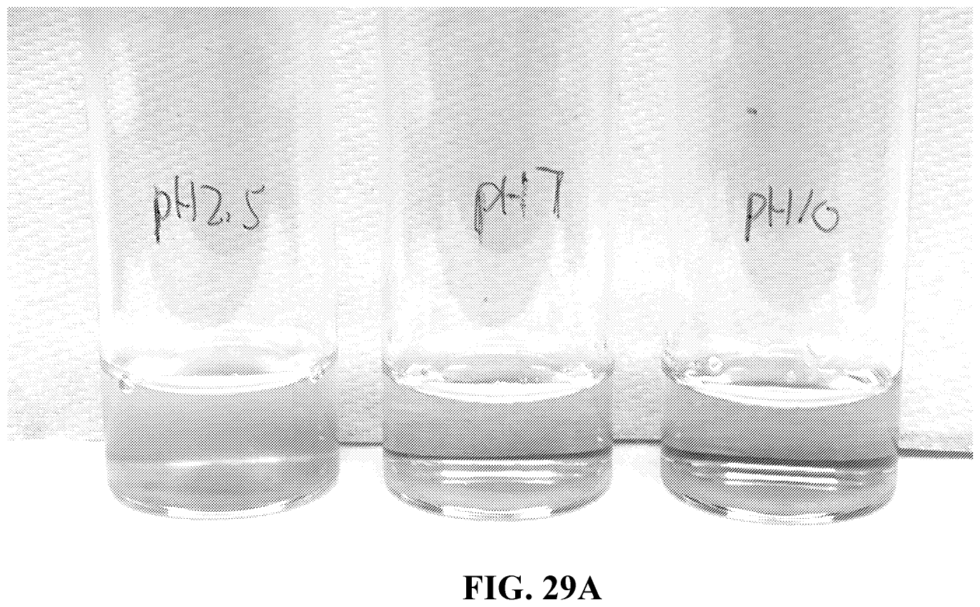

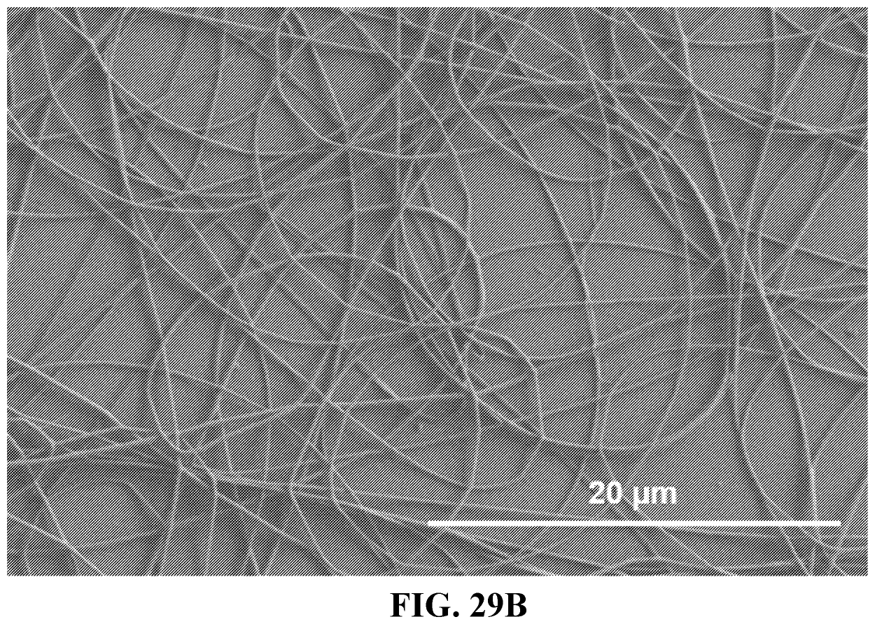

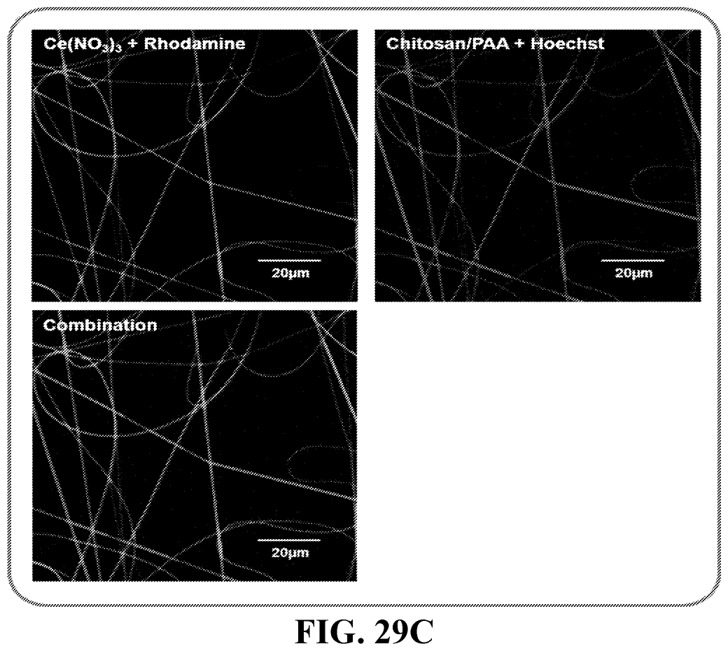

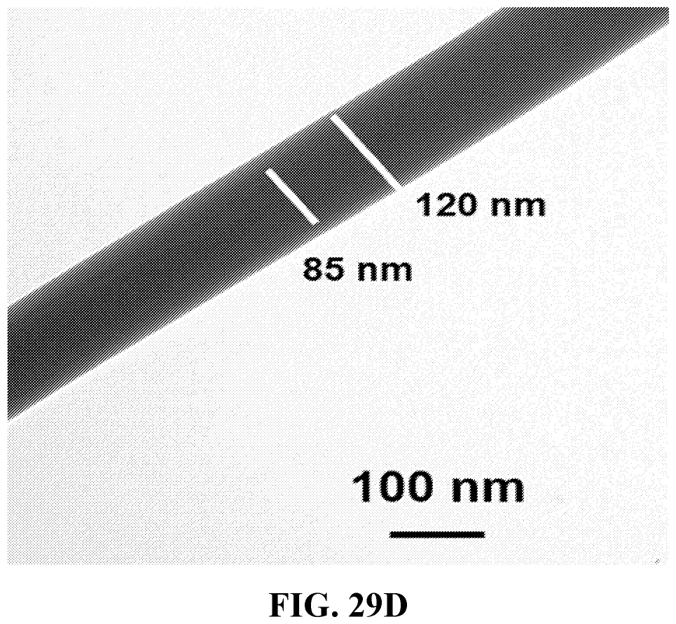

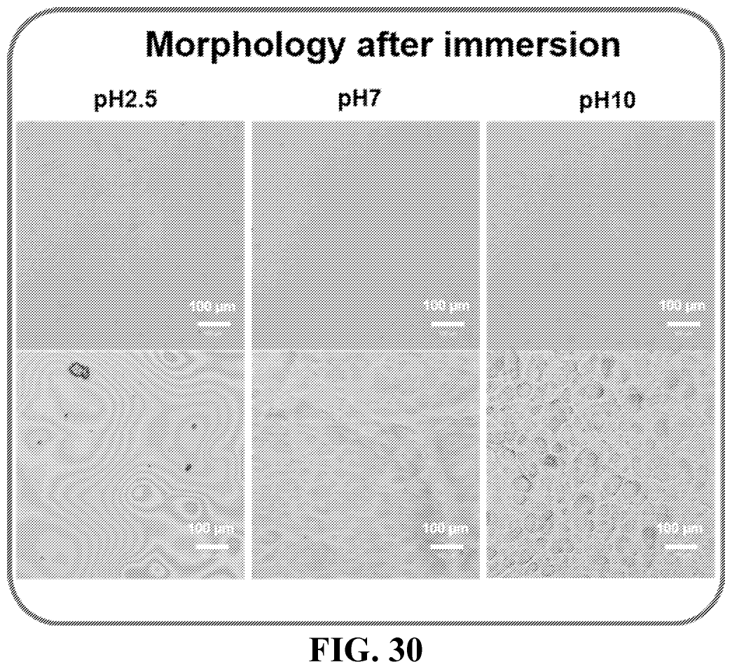

An organic dye loaded coating, i.e., (BB)₃/(chitosan/PAA)₅ was fabricated and the release of the entrapped BB at different pH conditions was studied to assess the dual pH-sensitivity of the coacervate. BB was impregnated into the polyelectrolyte coacervate coating because the released BB can be easily detected by the color change of the release medium without need of further characterization techniques. As shown in FIG. 29A, the media after 24 h of release appears to be yellow in color at both pH 2.5 and 10, whereas a less significant change is observed at pH 7. This proves the chitosan/PAA coacervate is dual-pH responsive and can release BB at both low and high pH conditions at a faster rate than that at neutral pH. Another set of coating samples without BB was used to detect the alteration of surface morphology caused by immersion for 24 h. From optical microscopy images FIG. 30, most of the coating dissolved at pH 2.5, and several large pores were created at pH 10. At pH 7, the surface morphology became rougher relative to that before immersion, but this change is less obvious compared to that at pH 2.5 and 10. This finding again verifies that the chitosan/PAA coacervate is sensitive to both acidic and basic pH conditions. The mechanism behind this pH-responsive behavior is associated with the strength of electrostatic interactions between the two oppositely charged polyelectrolytes. As is well-documented the pKₐ values of chitosan are 6.22, 6.11, and 6.09, whereas PAA has a pKₐ of 6.5. Although these pKₐ values may shift when the polyelectrolyte is incorporated within the coacervate, it is safe to conclude that chitosan and PAA have moderate interactions between their functional groups at pH 7 as both polyelectrolytes are partially charged. However, such interactions can be compromised by altering the pH to 2.5 or 10, owing to the deionization of PAA or chitosan, respectively. As a result, the presence of hydrogen bonds between water and uncharged functional groups within polyelectrolytes (i.e. carboxylic acid groups in PAA and amine groups in chitosan) enables water to penetrate through the polymer networks, a process accompanied by the swelling/dissolution of the polyelectrolyte coacervate.²⁸ Moreover, in both acidic and alkaline environments, one of the polyelectrolytes is prone to be fully charged and the stronger repulsive force within the polyelectrolytes can also cause the polyelectrolyte coacervate to swell or dissolve in the solution. Consequently, the impregnated organic dye can rapidly release from the unstable polyelectrolyte coacervate at pH 2.5 and 10.

Characterization of Ce(NO₃)₃-Loaded Nanofibers

Ce(NO₃)₃-loaded nanofibers were fabricated by the electrospinning technique. A coaxial nozzle was utilized to prevent the undesired mixing between the polyelectrolyte coacervate solution and the inhibitor solution prior to the formation of nanofibers. During the electrospinning process, chitosan may have limited electrospinnablity due to the intermolecular interactions, but the presence of PAA in the polyelectrolyte coacervate can hinder the undesired interactions between chitosan chains allowing electrospinning to be successful. The SEM in FIG. 29B shows that the resulting nanofibers are free of defects and beads. The diameter of the electrospun nanofibers is less than 200 nm.

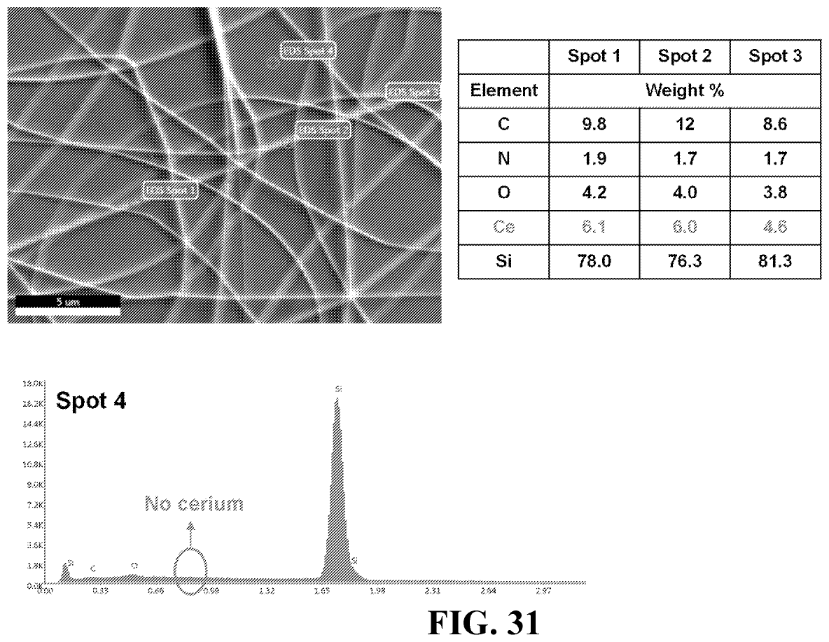

To verify the core-shell structure of the nanofibers, confocal spectroscopy was employed at first. Hoechst 33258 pentahydrate was added into the shell solution while rhodamine B was mixed with the core solution, Due to the excitation by the laser in the confocal microscope, these two fluorescence dyes made the shell and the core blue and red in color, respectively. However, due to the limited resolution of confocal microscopy, the shell of the nanofibers appears to be solid instead of hollow FIG. 29C. The image of the core stained by rhodamine B base is continuous, indicating Ce(NO₃)₃ is filled within the nanofibers. Upon combining the images of the shell and the core, the red and blue colors overlap, and no red color is observed outside the nanofibers, suggesting the successful incorporation of Ce(NO₃)₃ FIG. 29C. To further confirm Ce(NO₃)₃ was incorporated within the nanofibers, EDS was carried out by analyzing the Ce spectral Ma line located at 0.88 keV. Three locations along one nanofiber were randomly selected and examined. The content of Ce was independent of location (FIG. 31(a)), indicating the uniform dispersion of Ce(NO₃)₃ in the nanofibers. Additionally, the possible existence of Ce in an area without nanofibers was probed, but the characteristic peak of Ce did not appear in the EDS spectrum (FIG. 31(a)). This validates the successful encapsulation of Ce(NO₃)₃, consistent with the confocal spectroscopy result FIG. 29C. Since the confocal spectroscopy was not able to reveal the core-shell structure of the nanofibers, TEM analysis was conducted. The detailed morphology of the nanofibers is presented in FIG. 29D. A sharp boundary between relatively dark and bright regions is identified, corresponding to the core and shell of the nanofibers, respectively. The overall diameter of the nanofiber is about 120 nm, while the diameter of the core region is around 85 nm. Moreover, the core is concentrically located in the nanofibers, suggesting a stable electrospinning process.

Release of Ce(III) from Ce(NO₃)₃-Loaded Nanofibers

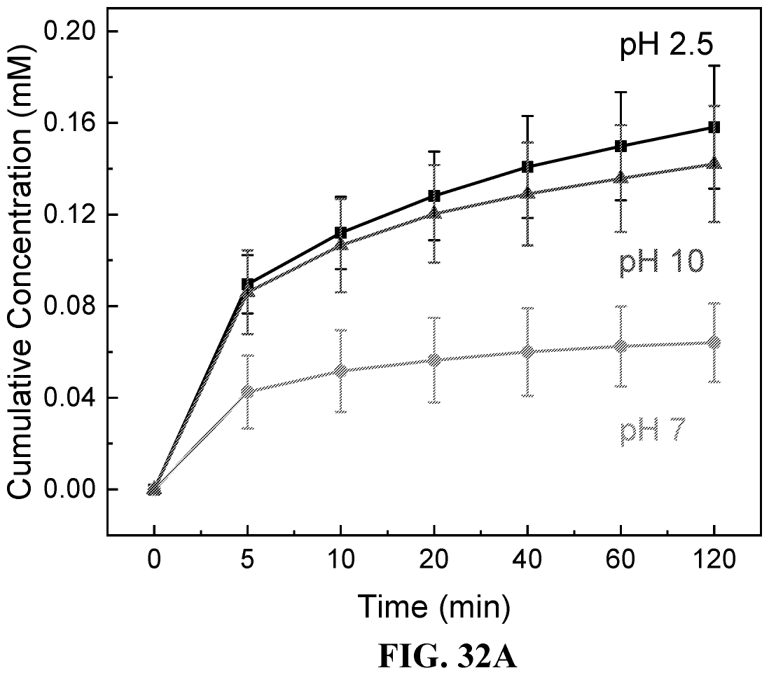

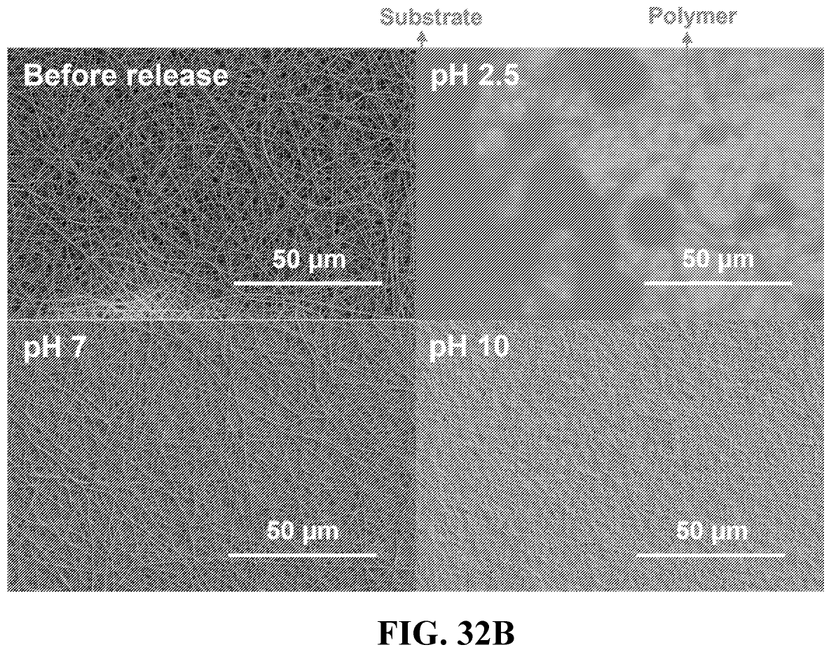

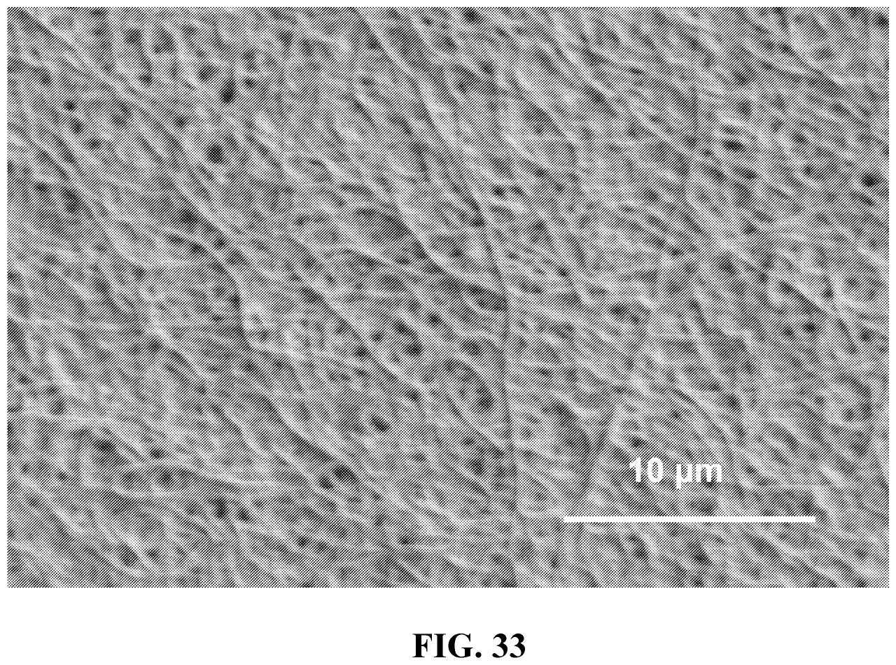

The dual pH-responsive behavior of the chitosan/PAA polyelectrolyte coacervate was corroborated by the fast release of an organic dye upon a pH change (FIG. 29A and FIG. 30). However, it is essential to investigate whether this behavior can be affected by the electrospinning process. Moreover, the presence of Ce(NO₃)₃ in the core of the nanofibers may also result in different release kinetics due to the undesired electrostatic attraction between the negatively charged PAA and positively charged cerium ions. Therefore, the release of Ce(III) from the nanofibers was studied by immersing the nanofiber-coated samples in DI water with pH 2.5, 7, or 10. The exposed area was 7.5 cm². The released amounts of Ce(III) were measured using UV-vis spectroscopy, and the cumulative release profile of Ce(III) is shown in (FIG. 32A). There are two stages in the release curves including a rapid release of Ce(III) at the beginning and a sustained release thereafter. The initial burst release of Ce(III) may be associated with unleashing the inhibitors close to the shell, which is commonly reported in the literature. As time proceeds, the corrosion inhibitors in the inner core are released, contributing to the sustained release at a slower rate in the second stage. Notably, the release rate in the first stage was higher at pH 2.5 and 10, as indicated by the steeper slope of the release curve, compared to that at pH 7. This can be elaborated by the pH-triggering release process at both low and high pH conditions. After 2 h of exposure, the final values of the cumulative concentration of Ce(III) were 0.16 mM at pH 2.5 and 0.14 mM at pH 10, which were more than twice that at pH 7. Higher released amounts of Ce(III) at acidic and alkaline pH than that at the neutral pH verifies that the Ce(NO₃)₃-loaded nanofibers are dual-pH sensitive, and neither the electrospinning process nor the enclosed Ce(NO₃)₃ substantially interfere with the pH-sensitive release behavior of the nanofibers. The surface morphology of the nanofibers after the release study was also examined by SEM. As shown in (FIG. 32B), the nanofibers strongly dissolve after being exposed to an acidic condition for 2 h. In an alkaline environment, a large number of nanofibers swell, and numerous pores are generated inside the nanofiber networks (FIG. 32B) and FIG. 33). In contrast, the change in the surface morphology of the nanofibers at pH 7 is negligible (FIG. 32B). The nanofibers seem to exhibit a higher degree of swelling under acidic condition compared to that of the alkaline condition, which may explain the higher amount of Ce(III) released at pH 2.5 than pH 10 (FIG. 32A). The distinct morphologies of the nanofibers shown in (FIG. 32B) suggest that the shell material can be in an either open or close state depending on the environmental pH. Under acidic and alkaline conditions, the shell of the nanofibers can open to release the encapsulated corrosion inhibitors, whereas remains closed at neutral pH to retard the leakage of the inhibitors from the core of the nanofibers.

Influence of Ce(NO₃)₃-Loaded Nanofibers on the Barrier Property of the Coating Matrix

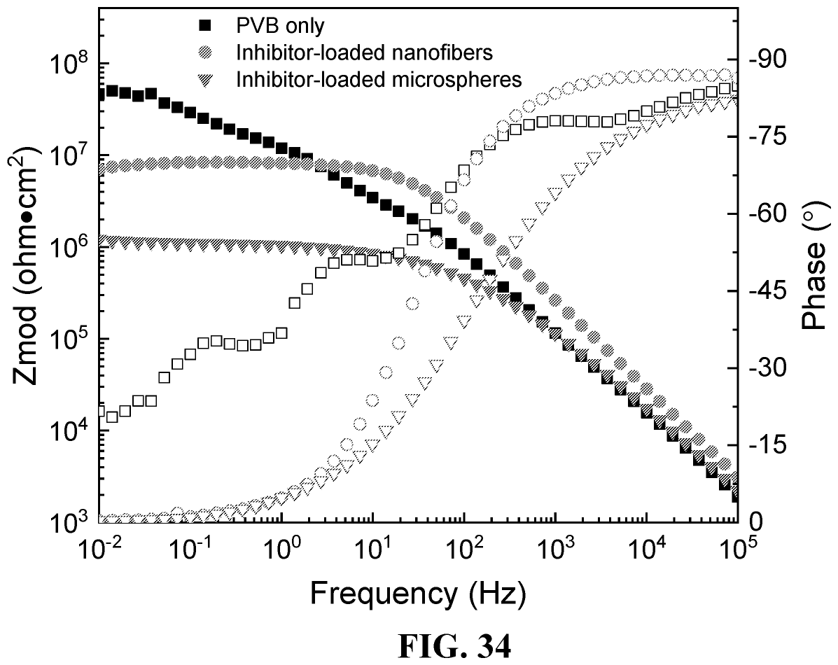

It is known that the addition of Ce(NO₃)₃-loaded microspheres into a polymeric coating matrix might create localized defects/voids, compromising the integrity of the coating system. To investigate whether the same problem occurs with embedding Ce(NO₃)₃-loaded nanofibers in the coating, EIS measurements were carried out on PVB coated samples incorporated with the Ce(NO₃)₃-loaded nanofibers. For comparison, untreated PVB and PVB containing Ce(NO₃)₃-loaded microspheres were also subjected to EIS tests. It should be pointed out that all coating samples had a thickness between 15 to 30 μm. The inclusion of the microspheres or nanofibers might have increased the coating thickness, but the effect was not determined, because the bar-coating method used in this work had a limited control in the thickness of coating samples. After being immersed in 100 mM NaCl for 1 h, EIS spectra of coated samples were acquired. The result is given in FIG. 34. PVB with Ce(NO₃)₃-loaded microspheres had the lowest impedance value at low frequencies, which was about 50× lower than that of PVB. This suggests a large negative effect of the microspheres on the barrier property of the coating system. On the other hand, the low-frequency impedance the coating with nanofibers was intermediate, indicating a less negative impact of the nanofibers than the microspheres on the integrity of the coating system. Furthermore, the coating with nanofibers exhibits a wider range of capacitive behavior at high frequencies, further validating its better barrier property than the coating loaded with microspheres. Nanofibers had a smaller size and thus a higher specific surface area than the microspheres, leading to nanometer-scale interactions between the nanofibers and the coating matrix, thus enhancing the barrier property of the coating. Another possibility is that there were more closed pores/voids for the microspheres embedded coatings. In comparison, the defects within the fibrous network may be interconnected, so it is more accessible for PVB solution during bar-coating. However, there are always some closed defects that are not accessible by the PVB solution, so these defects become susceptible sites for corrosion. Consequently, the impedance of the coating with the nanofibers was still lower than that of PVB, indicating an inferior protective property compared to the untreated PVB coating sample. This problem might also originate from the coating preparation by a manual bar-coating method. PVB probably did not fully infiltrate into the nanofiber network, resulting in unfilled pores/voids that preexist between the nanofibers.

### Surface Morphology of Coated AA2024-T3 Samples

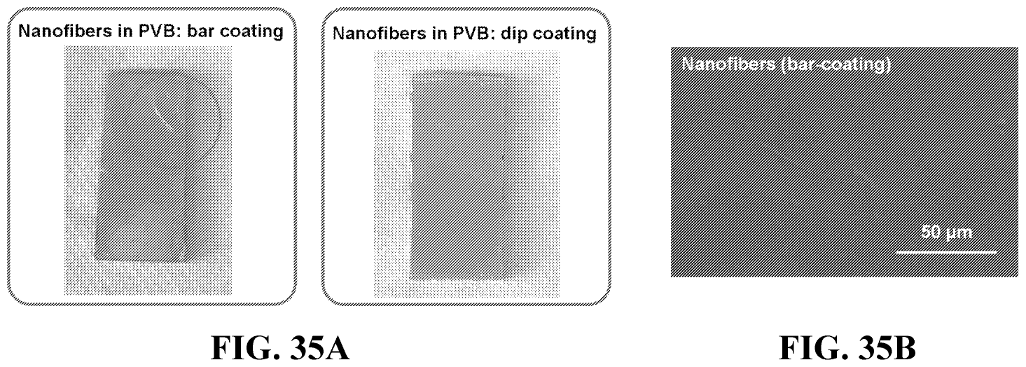

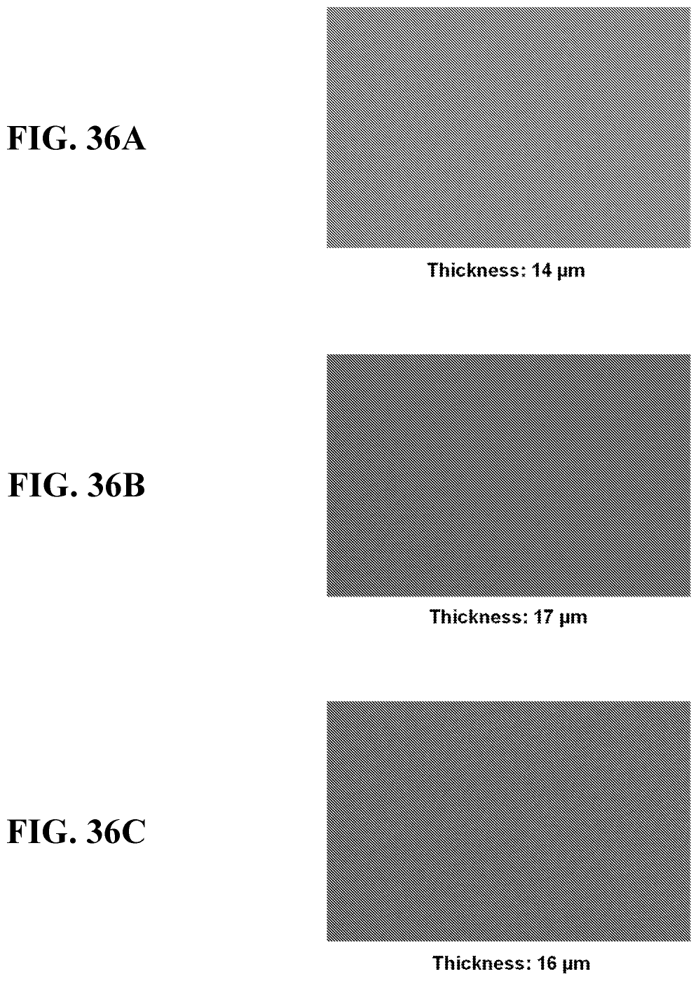

Two coated AA2024-T3 samples, i.e. Fiber-PVB and Ce-Fiber-PVB were prepared using the dip-coating method. As mentioned above, the coating made by the bar-coating technique might have unfilled interfibrous pores/voids inside the coating, which can serve as pathways for the aggressive solution to reach the AA2024-T3 substrate to trigger corrosion. Additionally, the electrospun nanofibers formed a mat that was thick enough to be readily peeled off from the substrate during the bar-coating process, even though PVB was precoated on AA2024-T3 to enhance the adhesion between the nanofiber mat and the metal substrate. As a result, visible defects were inevitably created in the resulting coated samples FIG. 35A. As the nanofiber mat was found to not dissolve in ethanol, a dip-coating method was used as an alternative to prepare coated AA2024-T3 samples. The surface morphology of dip-coated samples was explored by SEM. Compared to PVB FIG. 36A, the inclusion of nanofibers with/without Ce(NO₃)₃ did not significantly alter the surface morphology, and the nanofibers seemed to be fully covered by PVB FIGS. 36(a) and 36(b). Moreover, the thickness of Fiber-PVB and Ce-Fiber-PVB was 17 and 16 μm, respectively, which did not evidently increase compared to that of PVB. This is possibly because PVB intercalated into the nanofiber mat and reached the underlying metal substrate. Hence, by dip-coating, PVB can seal the interfibrous pores and act as a binder for the nanofiber mat to attach to the metal substrate. During the coating preparation, the nanofiber mat formed on the substrate was white in color but gradually became transparent with the deposition of PVB layers, indicating the infiltration of PVB to replace the air in the interfibrous pores, in line with studies reported elsewhere. Unlike the bar-coated samples, the dip-coated samples had a smooth and uniform surface without noticeable defects FIG. 35A. The advantage of the dip-coating method over the bar-coating technique was further demonstrated by the surface morphology of coated samples observed by SEM. As shown in FIG. 35B, nanofibers partially protrude from the bar-coated samples, which is not the case for the dip-coated samples (FIGS. 36A-36C). These uncovered parts of nanofibers may jeopardize the integrity of the coating and be vulnerable sites for corrosion attack. Therefore, the dip-coating method was utilized to fabricate coated AA2024-T3 samples for the following electrochemical tests.

### EIS Tests at Various pH Conditions

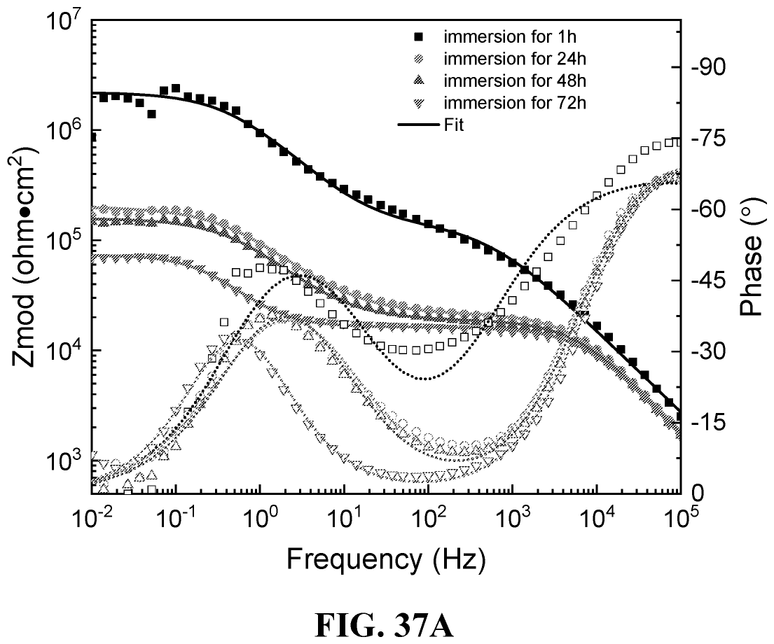

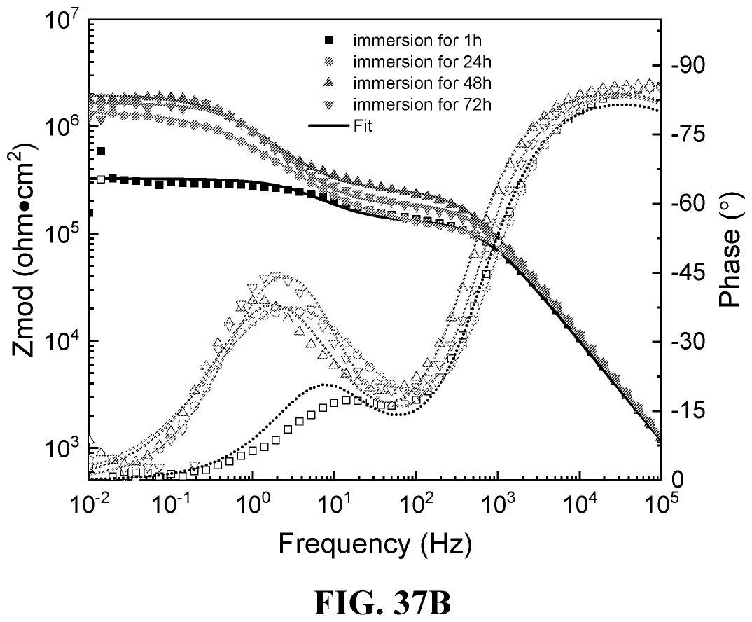

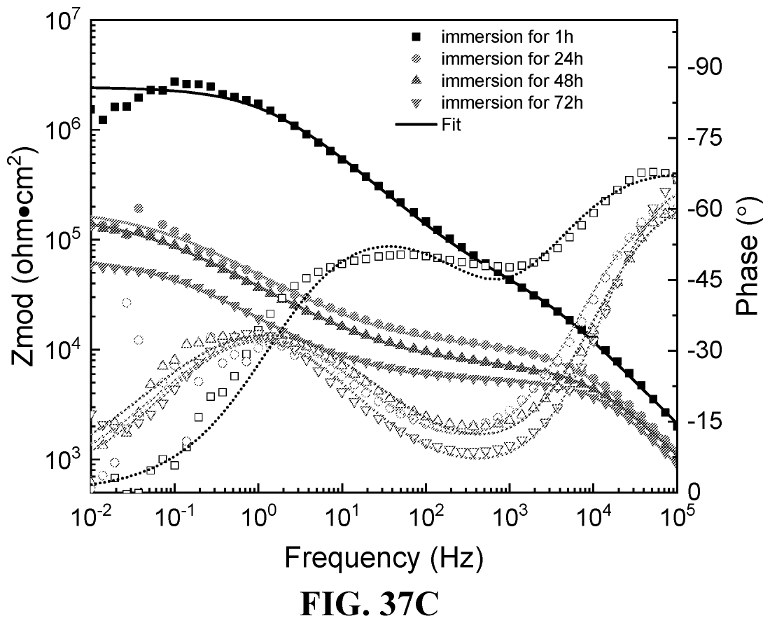

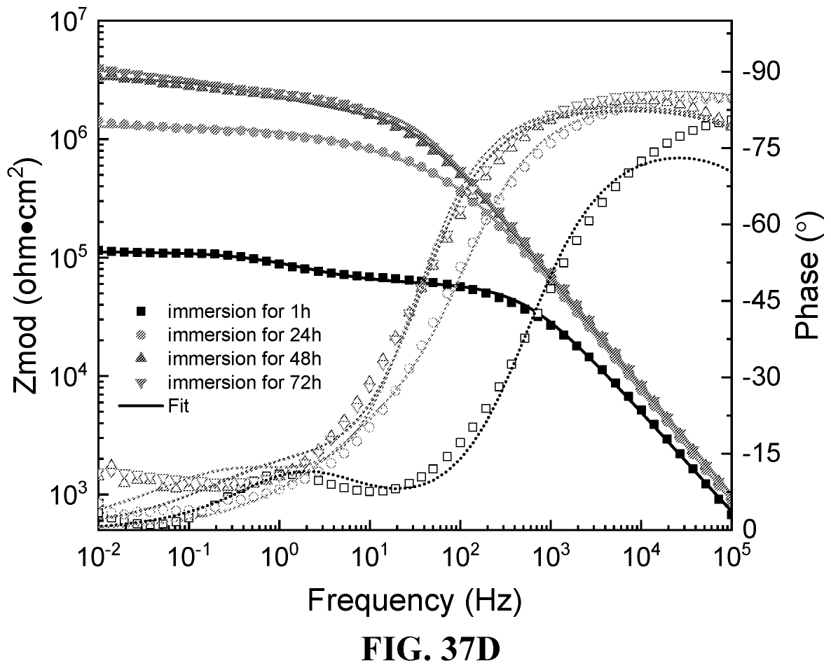

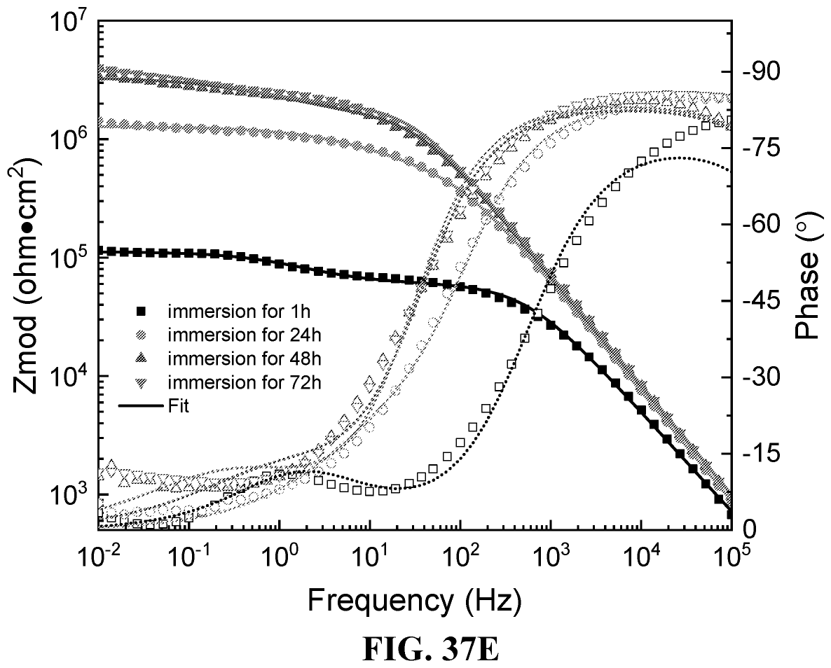

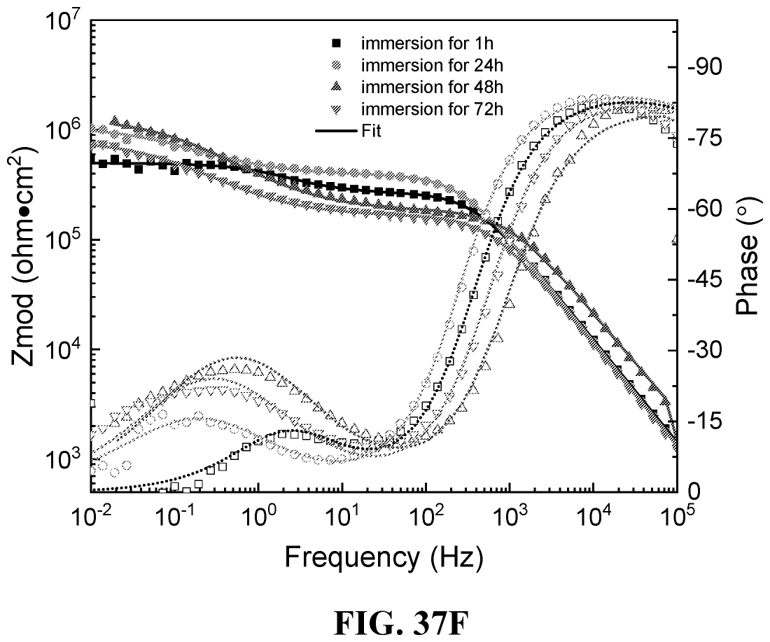

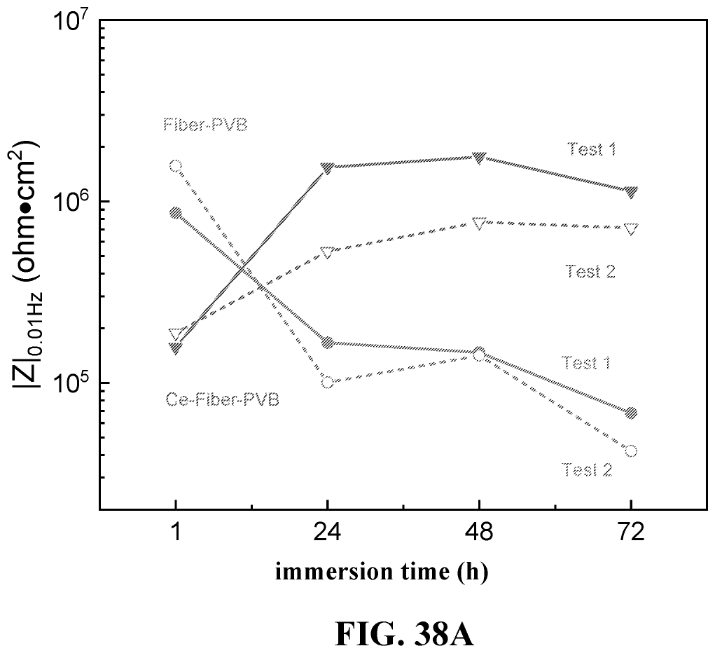

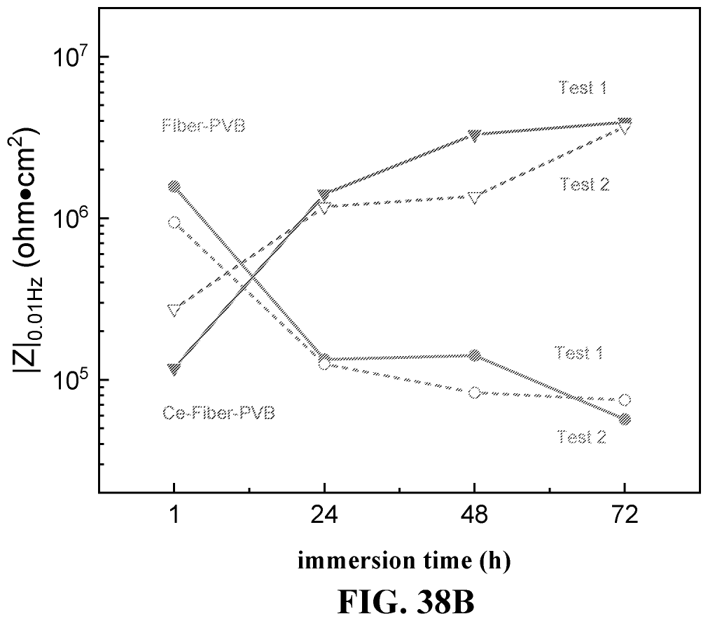

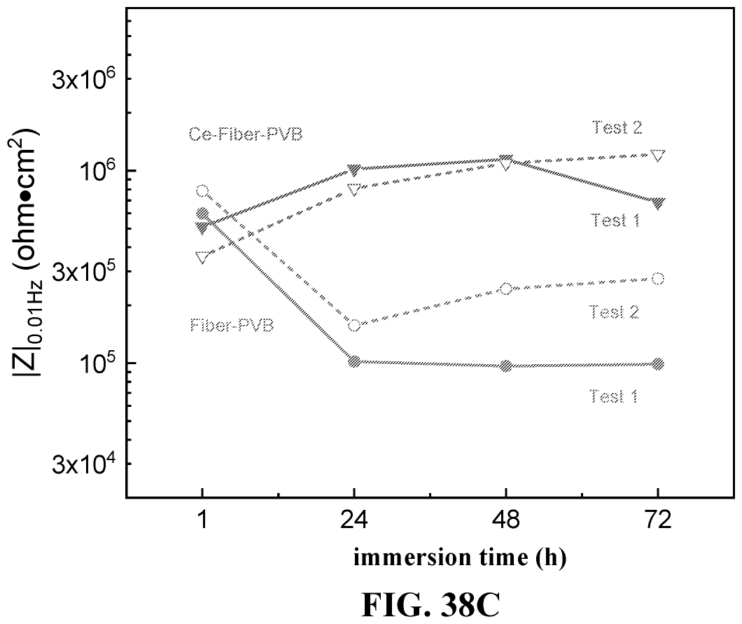

EIS measurements were carried out at both pH 2.5 and pH 10 to examine the corresponding corrosion resistance of two coated samples, i.e. Fiber-PVB and Ce-Fiber-PVB, both on AA2024-T3, as a function of immersion time. The solution pH was adjusted to be acidic and basic to mimic the situation that occurred in anodic and cathodic sites in the metal substrate during corrosion, because the local pH conditions may decrease or increase due to the hydrolysis of metal ions and the oxygen reduction reaction (ORR), respectively. As a comparison, EIS tests at pH 7 were also conducted. For reproducibility, the EIS tests were repeated twice. The representative EIS spectra are shown in FIGS. 37A-37F, and the impedance values at 0.01 Hz (Z|_{0.01 Hz}) for different immersion times is recorded in FIGS. 38A-38C to better illustrate the corrosion protection performance of coated samples, as a higher value of low-frequency impedance generally indicates better corrosion resistance.

For Fiber-PVB immersed at pH 2.5 (FIGS. 37A and 38A), the impedance values at both low and middle frequency abruptly decreased by over one order of magnitude after the coating was soaked in the solution for 24 h. This indicates that the coating began to degrade, and water was absorbed by the coating at a rapid rate. Then, a slight decrease in the impedance values was observed as the immersion time increased from 24 h to 48 h, which is possibly associated with the water saturation in the coating. With a prolonged soaking time, the impedance value at low frequency further showed a downward trend, perhaps because the corrosive electrolyte arrived at the metal substrate to initiate corrosion. Meanwhile, the nanofibers inside the coating were destroyed, which accelerated the rupture of the coating. In the Bode phase plots, two time constants are clearly present with one at high frequency and the other at low frequency, related to the coating property and the charge transfer process at the metal/coating interface, respectively. The maximum phase angle at the high frequency was low and the magnitude decreased over time. No plateau in the high frequency range in the Bode phase plot is observed. These results suggest that the barrier property of the coating sample was severely affected by exposure to an aggressive environment. In contrast, at pH 2.5 the impedance values for Ce-Fiber-PVB with Ce(NO₃)₃ encapsulated within the nanofibers displayed a constant increase at low frequencies along with a moderate increased in the mid frequency range (FIGS. 37B and 38B). Additionally, the phase angle at high frequencies is nearly −90° and seems to be constant at all immersion times. Besides, the plateau region in the high frequency range tends to broaden towards the lower frequency, indicating the barrier property of the coating is promoted rather than being undermined. All these observations suggest Ce-Fiber-PVB has better corrosion resistance than Fiber-PVB, possibly originated from the corrosion inhibition effect of Ce(NO₃)₃. Ce(NO₃)₃ is highly efficient in retarding corrosion of AA2024-T3 through the preferential deposition at cathodic sites to form insoluble cerium oxide/hydroxide films. Moreover, the charge transfer process between the anodes and cathodes can also be impeded due to the lower conductivity of precipitated cerium compounds, thus reducing the corrosion rate of AA2024-T3. It has been suggested that Ce(IV) species can be generated by the oxidation of Ce(III) during the corrosion of AA2024-T3, and these species can also form insoluble Ce(IV) oxides/hydroxides to slow down the corrosion process. Therefore, for Ce-Fiber-PVB, Ce(NO₃)₃ was released from the nanofibers and retarded corrosion, leading to the improved corrosion protection performance. However, the formation of an insoluble cerium film can be delayed by the limited local pH raise under an acidic bulk environment, and a stable film is more difficult to be maintained at low pH conditions, leading to a modest drop in |Z|_{0.01 Hz} after 72 h immersion (FIG. 38A).

The behavior at pH 10 was similar. For Fiber-PVB (FIGS. 37C and 38C), after 1 h of immersion, the impedance modulus declined with decreasing frequency due to the drastic alteration of the metal surface caused by corrosion. The addition of the empty nanofibers did not provide corrosion protection to the metal substrate, evidenced by a continuous drop in |Z|_{0.01 Hz} FIG. 38B. The impedance at the middle frequency decreased with increasing immersion time, and the plateau at the middle frequency was more distinctly shown in the extended immersion periods, indicating the degradation of the coating and the ingress of corrosive electrolyte FIG. 37C. On the other hand, |Z|_{0.01 Hz} of Ce-Fiber-PVB increased over time and was nearly two orders of magnitude higher than that of Fiber-PVB by the end of immersion, suggesting superior corrosion resistance (FIG. 38B). It should be noted that in the Bode phase plot (FIG. 37D), the time constant at high frequency is dominant. Although a small bump appears at low frequency after 1 h of immersion, it diminishes with immersion time. This implies the released Ce(NO₃)₃ slowly suppresses corrosion of AA2024-T3. This inhibition effect is better than that at pH 2.5, as indicated by no decrease in |Z|_{0.01 Hz} of Ce-Fiber-PVB after 72 h of immersion. This is likely account of the easier formation of insoluble cerium oxides/hydroxides in the alkaline environment.

At pH 7 the behavior was different. For Fiber-PVB FIG. 37E, the impedance values at both low frequency and middle frequency declined by an approximately full decade. However, they did not keep decreasing after 24 h, and |Z|_{0.01 Hz} even recovered to some extent in the repeated EIS experiment (FIG. 38C), which is not the case at pH 2.5 and pH 10. It is well-known that both PAA and chitosan are hydrophilic and chitosan has multiple sites on the polymer chains for water adsorption, such as hydroxyl groups and amine groups. The introduction of the nanofibers into the coating may render the coating system to be hydrophilic, which can speed up the water infiltration. As a result, a decrease in the impedance values was shown even though the coating was not severely deteriorated. Since the environment is less aggressive at pH 7, the corrosion rate of AA2024-T3 is low, which can explain why the impedance remained unchanged with extended immersion time. For Ce-Fiber-PVB (FIGS. 37F and 38C), the released Ce(NO₃)₃ may have precipitated to form an insoluble film to retard water penetration, so the impedance values of Ce-Fiber-PVB did not decrease. Nevertheless, since the chitosan/PAA coacervate is stable at pH 7, a limited amount of entrapped Ce(NO₃)₃ can be released out from the nanofibers. Thus, unlike at pH 2.5 and 10, the impedance did not significantly increase with increasing immersion time at pH 7.

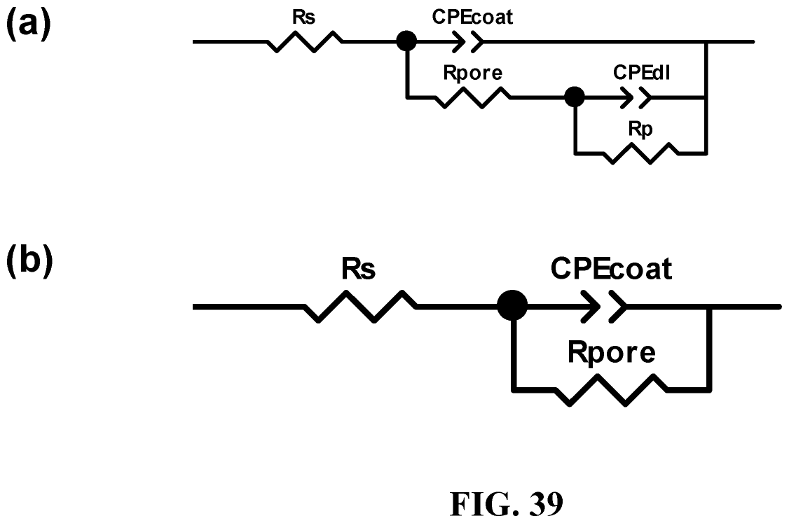

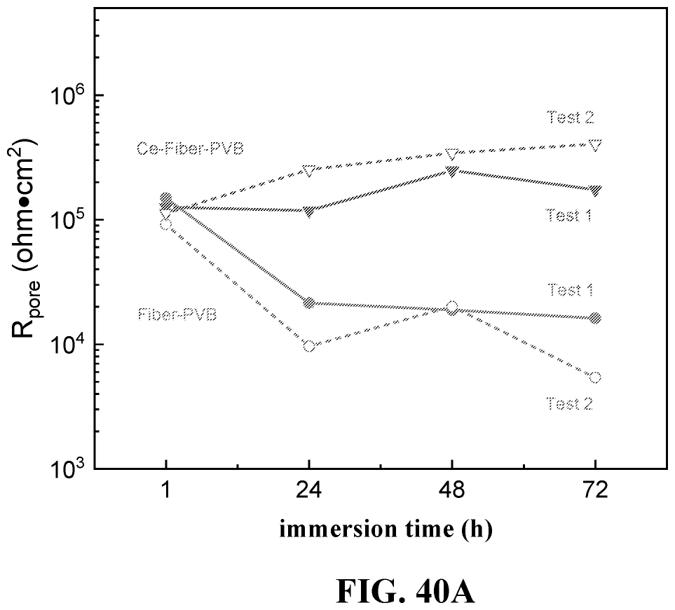

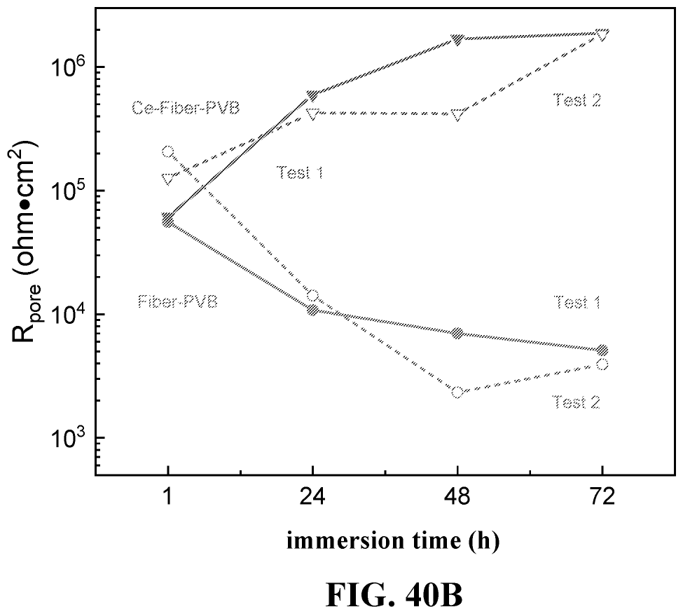

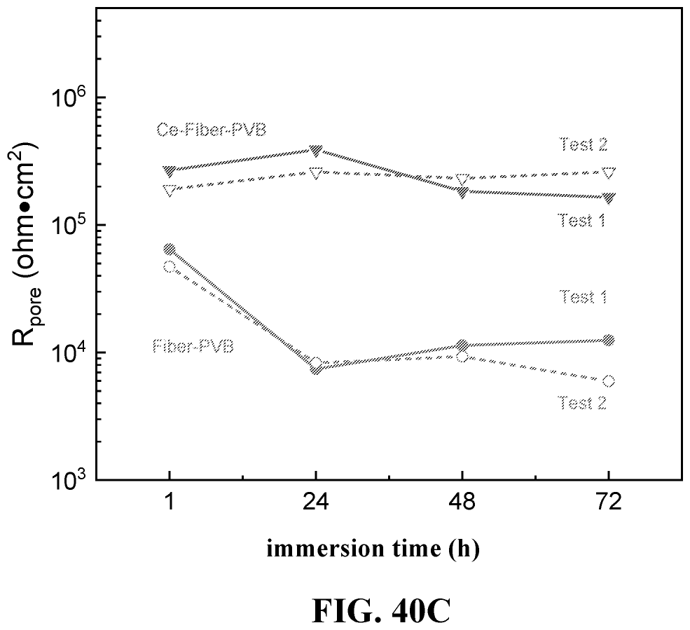

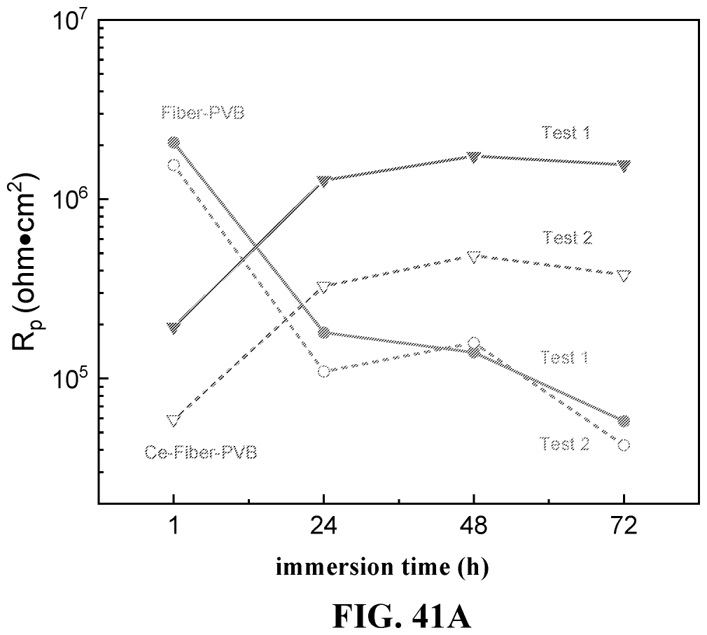

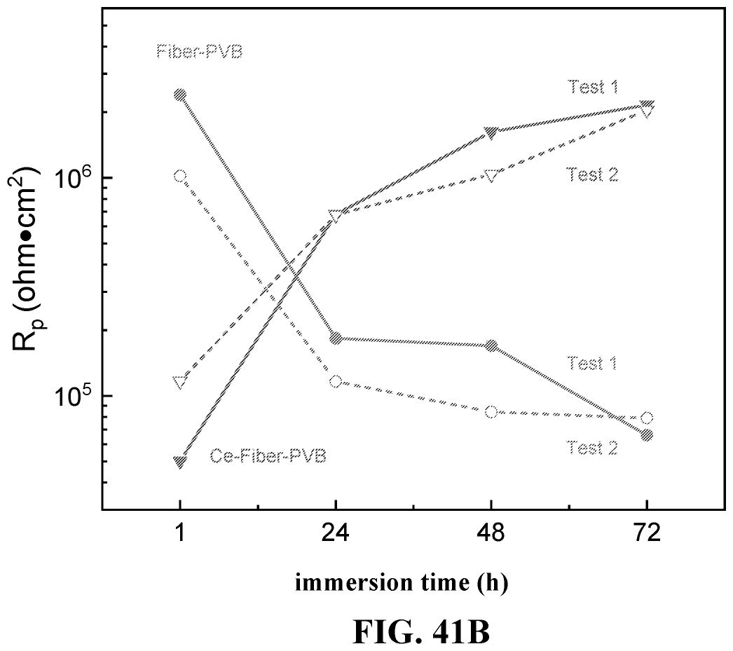

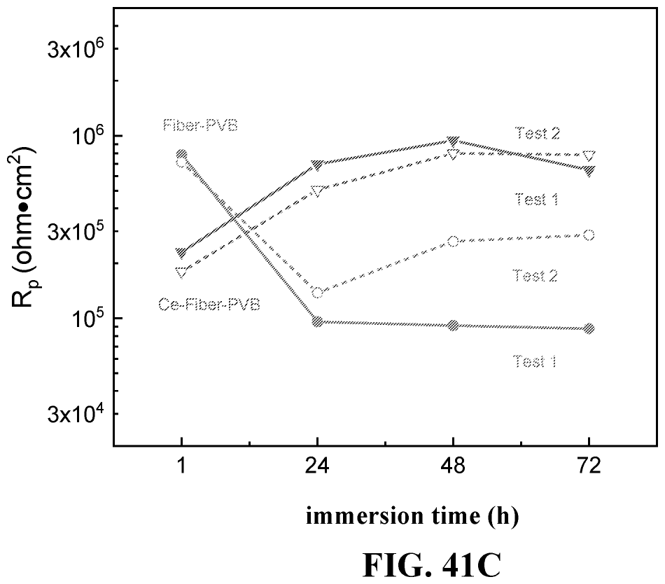

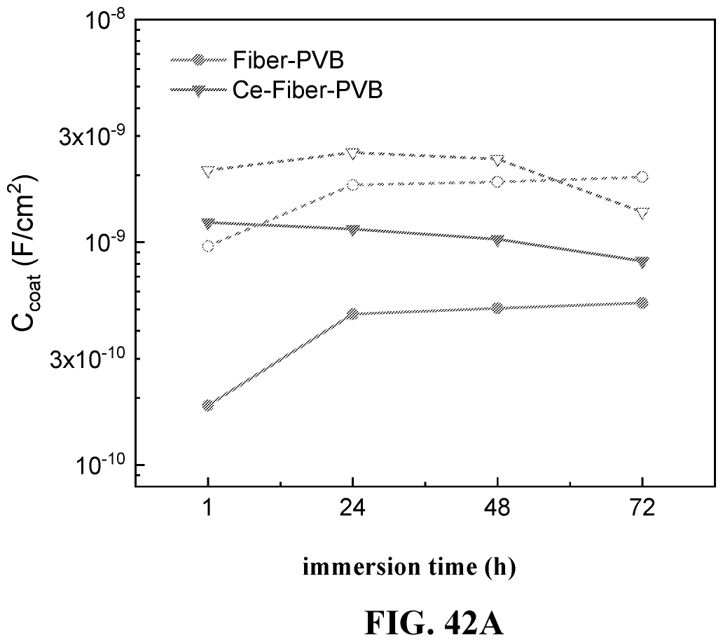

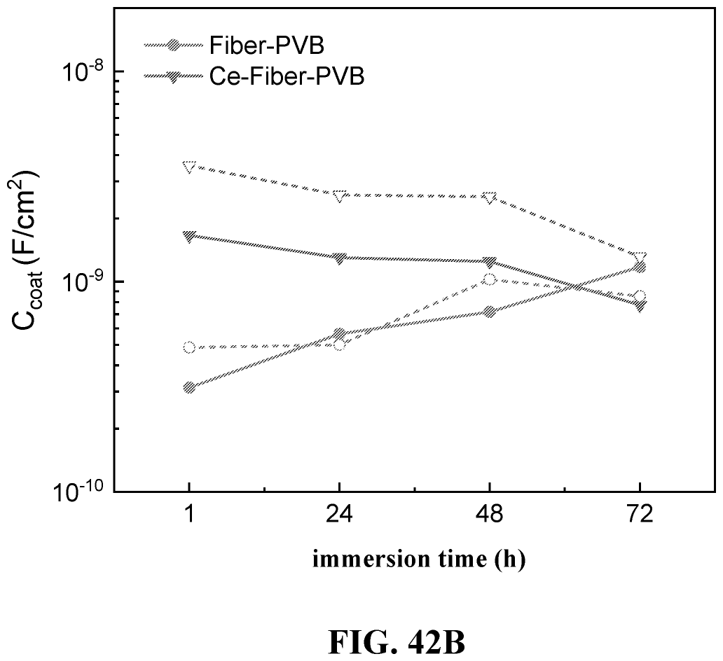

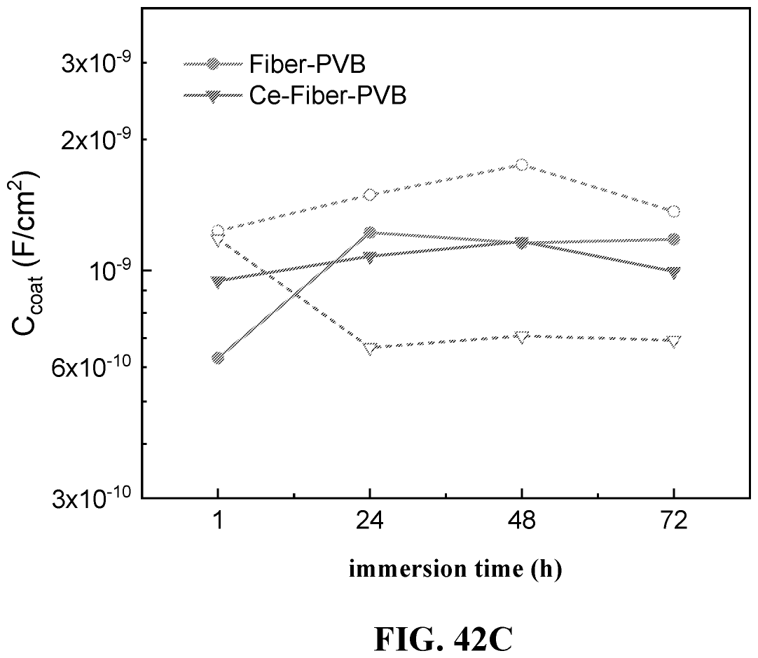

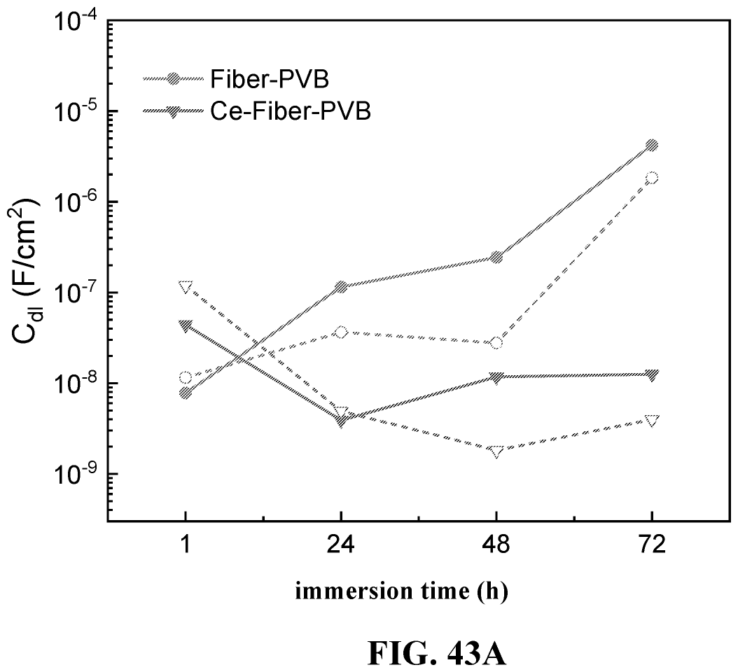

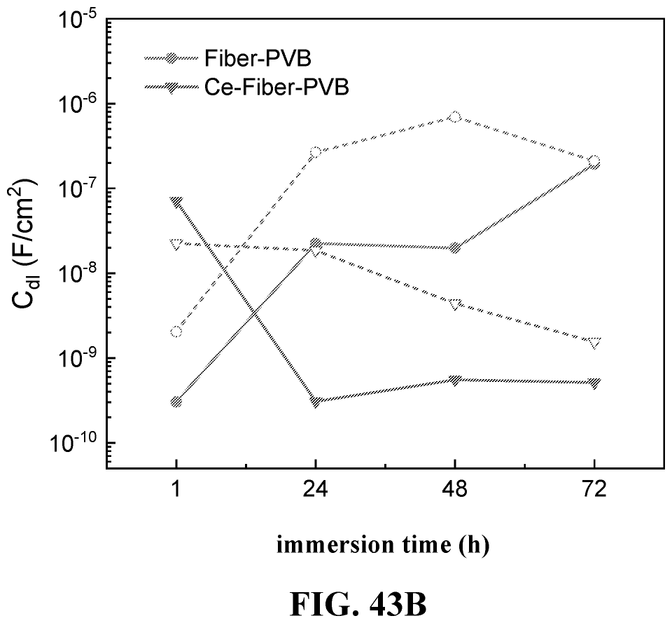

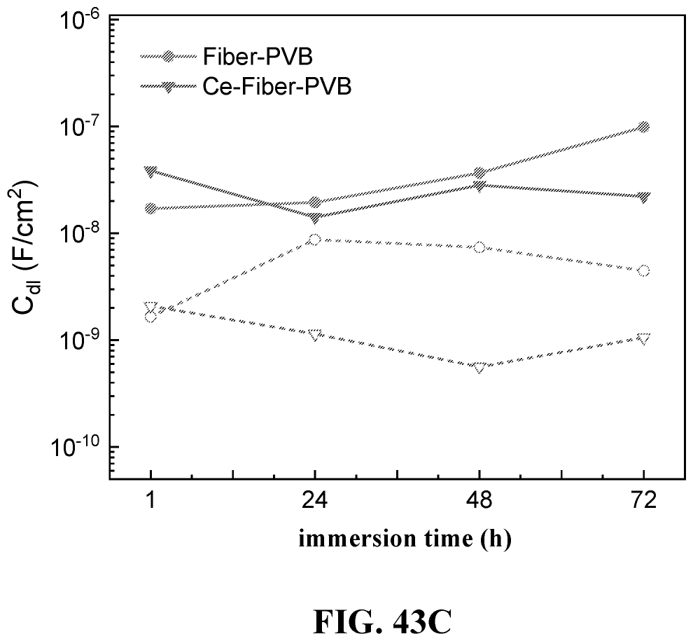

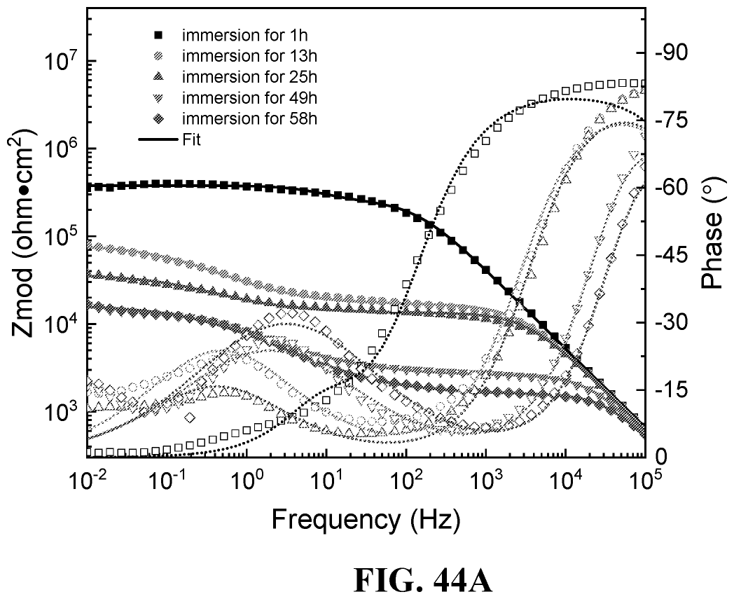

To quantitatively estimate the protectiveness of the coating in Na₂SO₄ solutions with various pH, EIS experimental data were fitted using a classical equivalent circuit model with two time constants, presented in FIG. 39(a), and the fitted lines are exhibited along with the experimental data in FIGS. 37A-37F. The selection of this model considers the following characteristics: Rₛ is the solution resistance. Rₚₒᵣₑ and CPE_{coat} correspond to the pore resistance and the coating capacitance indicated by a constant phase element, respectively. Rₚ refers to the polarization resistance whereas CPE_{dl} represents the double layer capacitance, arising from the faradic process at the coating/metal interface. Due to the heterogeneity and roughness of the coating surface,²⁵ the maximum phase angle deviated from −90° (FIGS. 37A-37F). As a result, constant phase elements (CPEs) were applied instead of perfect capacitors for a more accurate fit, which can take into account the non-ideal capacitive behavior of coated samples. To demonstrate differences in the corrosion resistance of Fiber-PVB and Ce-Fiber-PVB, the evolution of Rₚₒᵣₑ and Rₚ versus immersion time are compared and shown in FIGS. 40A-40C and FIGS. 41A-41C, while the actual coating capacitance (C_{coat}) and double layer capacitance (C_{dl}) were extracted from the fitting results using a well-established method, and provided in FIGS. 42A-42C and 43A-43C.

Generally speaking, Rₚₒᵣₑ represents the barrier property of a coating system, and a larger Rₚₒᵣₑ reflects stronger protective capability of the coating. As displayed in FIG. 40A, Rₚₒᵣₑ decreased by nearly a full decade within 24 h of immersion when Fiber-PVB was placed in Na₂SO₄ solution with pH 2.5 because of rapid water saturation in the coating. This is also consistent with a sudden increase in C_{coat} at the initial stage of immersion (FIG. 42A). Afterwards, Rₚₒᵣₑ continued diminishing from 2.0×10⁴ ohm·cm² to 1.6×10⁴ ohm·cm², possibly due to the destabilization of the embedded nanofibers. As mentioned above, under acidic pH conditions, the electrostatic interactions between chitosan and PAA are more likely to be disrupted, inducing the swelling/dissolution of the nanofibers. Therefore, more defects can form in the coating to adversely affect the protection properties of the coating system. Due to the same reason, a similar declining tendency in Rₚₒᵣₑ of Fiber-PVB with immersion time was observed at pH 10 (FIG. 40B). Concerning pH 7 (FIG. 40C), the average Rₚₒᵣₑ value of Fiber-PVB also declined from 5.5×10⁴ ohm·cm² to 7.9×10⁴ ohm·cm² during the early immersion period, but then slightly recovered to around 1.0×10⁴ ohm·cm² for the remaining exposure time. At the end of the EIS measurement, the decrease in Rₚₒᵣₑ was less significant compared to that displayed at pH 2.5 and 10. This is because the coating has a slower degradation rate and nanofibers are primarily intact under a less corrosive environment. It should be noted that despite the mild environment (i.e. pH 7), an abrupt decrease in Rₚₒᵣₑ during the first 24 h immersion was again observed. This is possibly due to the fast water infusion into the coating with an intrinsic hydrophilic property, which can be a factor of concern and needs to be addressed in future work. For Ce-Fiber-PVB in pH 2.5, Rₚₒᵣₑ either barely changed or had a modest rise in the replicated EIS tests (FIG. 40A). This is significantly different from what was observed for Fiber-PVB at the same pH condition. The higher corrosion resistance of Ce-Fiber-PVB may be attributed to the additional protection from the released cerium species and the subsequent formation of insoluble cerium films. Nevertheless, these insoluble films are prone to be redissolved upon contacting with the acidic electrolyte, resulting in a limited improvement in the barrier property of the coating. However, at alkaline pH condition redissolution of the oxide/hydroxide does not occur. At pH 10, Rₚₒᵣₑ exhibited a value of 2.0×10⁶ ohm·cm² at the end of the EIS measurement, which was over one order of magnitude higher than the initial value (FIG. 40B). Meanwhile, C_{coat} decreased over time (FIG. 42B). These results suggest a greatly enhanced protective ability of the coating due to the favorable pH condition for the formation of a robust cerium hydroxide/oxide film. At pH 7 (FIG. 40C), Rₚₒᵣₑ stayed unchanged throughout the exposure, which is similar to what was observed at pH 2.5, but the mechanism is different. At neutral pH, a fast release of loaded Ce(NO₃)₃ is hampered by the undamaged shell of the nanofibers, so the protective ability of the coating cannot be dramatically boosted due to the inadequate released corrosion inhibitors. Nevertheless, a small amount of corrosion inhibitors can still be released by diffusion and provide protection to some degree. As a result, no decrease in Rₚₒᵣₑ was shown.

It is noteworthy that for the two coating samples, the variation of Rₚₒᵣₑ versus immersion time was not obvious, possibly because water quickly saturated inside the coating. Therefore, the evolution of Rₚ over time was also assessed to characterize corrosion protection performance of the coated samples, as Rₚ is inversely correlated with the rate of corrosion and can describe the corrosion resistance of the coated samples in an aggressive environment. For Fiber-PVB corroded at pH 2.5, Rₚ decreased over time while Ca increased (FIGS. 41A and 43A). For instance, Rₚ diminished from 2.1×10⁶ ohm·cm² to 1.8×10⁵ ohm·cm² when the coating was immersed in the solution for 24 h, then continuously decreased at a slower rate for the remaining immersion period. In the meantime, Ca notably increased from 1.0×10⁻⁸ F/cm² to 3.0×10⁻⁶ F/cm² throughout the immersion. These results indicate coating degradation and the fast ingress of the aggressive electrolyte towards the metal surface to trigger corrosion. A similar trend was also found for Rₚ and C_{dl} of Fiber-PVB at pH 10 (FIGS. 41B and 43B). Like pH 2.5, the coating sample experienced a severe deterioration due to the swelling of the nanofibers. As a result, more pathways were generated for the aggressive electrolyte to arrive at the AA2024-T3 substrate, causing a sudden change in Rₚ and Ca within a short immersion period. Due to the amphoteric nature of Al, AA2024-T3 is also highly vulnerable to corrosion at alkaline conditions, leading to the decrease and increase of Rₚ and C_{dl}, respectively. However, at pH 7, despite a drop in Rₚ during the first 24 h immersion, Fiber-PVB seemed to have constant Rₚ values up to 72 h (FIG. 41C), which is associated with the higher stability of the passive film on the substrate at neutral pH. Even though water diffuses to the metal/coating interface and leads to the reduction of Rₚ at the beginning of immersion, intense corrosion of AA2024-T3 was impeded by the passive film, resulting in the unchanged Rₚ of Fiber-PVB between 24 to 72 h. For Ce-Fiber-PVB corroded at pH 2.5, Rₚ increased and reached a plateau above 1.0×10⁶ ohm·cm² until the exposure time extended to 48 h, then slightly reduced between 48 to 72 h (FIG. 41A). Nevertheless, compared to that of Fiber-PVB, the final Rₚ of Ce-Fiber-PVB was more than one order of magnitude higher, suggesting a lower corrosion activity when AA2024-T3 was coated with Ce-Fiber-PVB. The detailed mechanism has been discussed above. To recap, the encapsulated Ce(NO₃)₃ was stored within the nanofibers, and released when the nanofibers were open at pH 2.5, followed by precipitating insoluble cerium oxides/hydroxides to passivate the metal surface. Since this insoluble film has a lower dielectric constant, Cat of Ce-Fiber-PVB decreased and became lower than that of Fiber-PVB (FIG. 43A). It should be noted that under the acidic pH condition, the local pH raise is buffered by the bulk acidic solution, so the formation of the cerium oxide/hydroxide film is restrained. This may lead to partial coverage of the film on the metal surface, limiting the corrosion inhibition effect of released Ce(NO₃)₃. Similarly, at pH 10, the addition of Ce(NO₃)₃-loaded nanofibers empowered the coating sample with greater corrosion protection. Rₚ climbed from 5.0×10⁴ ohm·cm² to 2.1×10⁶ ohm·cm², whereas C_{dl} markedly decreased over time (FIGS. 41B and 43B). The alkaline pH condition facilitates the generation of a more robust cerium film on the AA2024-T3 surface, so Rₚ did not suffer a decrease with longer immersion. Considering pH 7, the nanofiber was in a closed state owing to the moderate electrostatic interactions between chitosan and PAA, so a low amount of Ce(NO₃)₃ could be released, resulting in less visible changes in Rₚ and C_{dl} (FIGS. 41C and 43C). In general, incorporating Ce(NO₃)₃-loaded nanofibers into the PVB coating matrix can improve the corrosion inhibition efficacy, while enclosing empty polyelectrolyte coacervate nanofibers does not significantly increase the corrosion resistance of AA2024-T3.

### EIS Measurements in NaCl Solutions

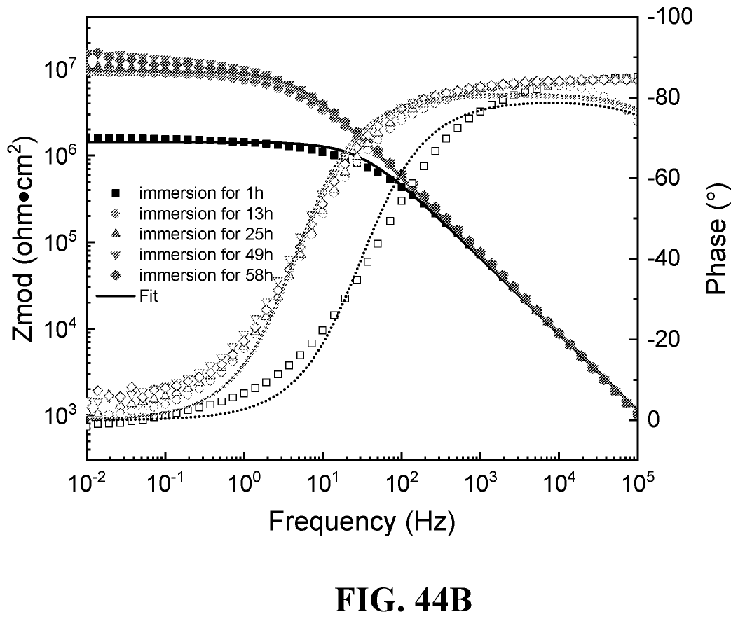

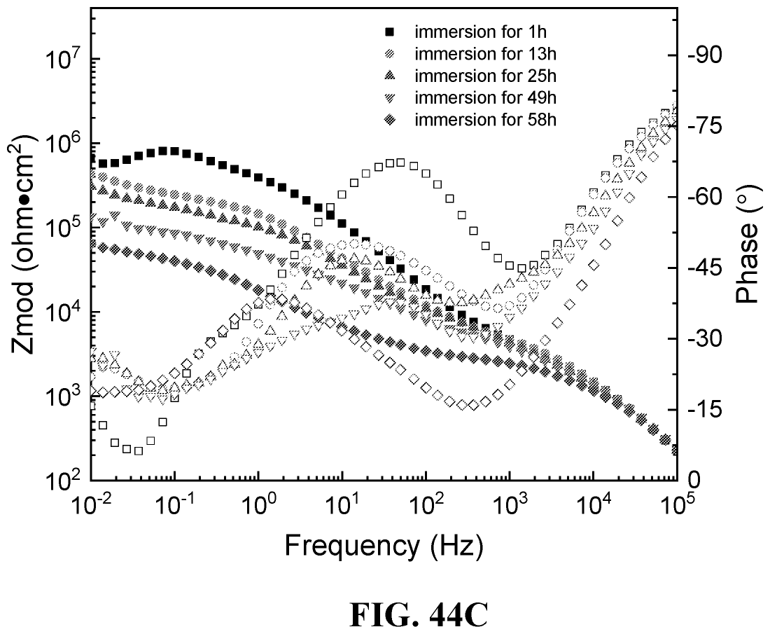

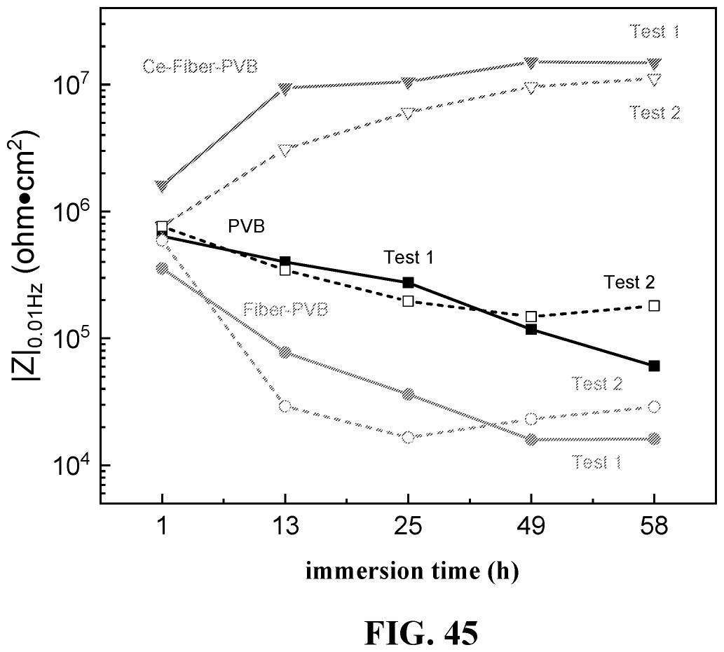

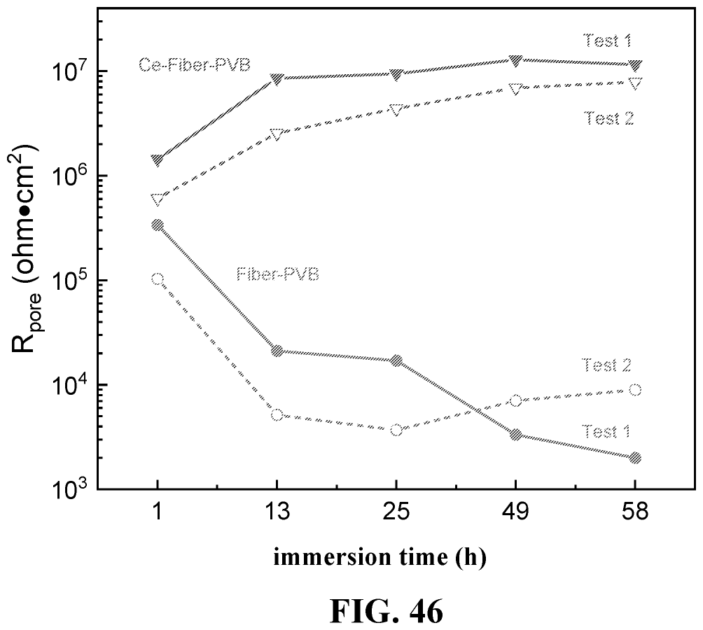

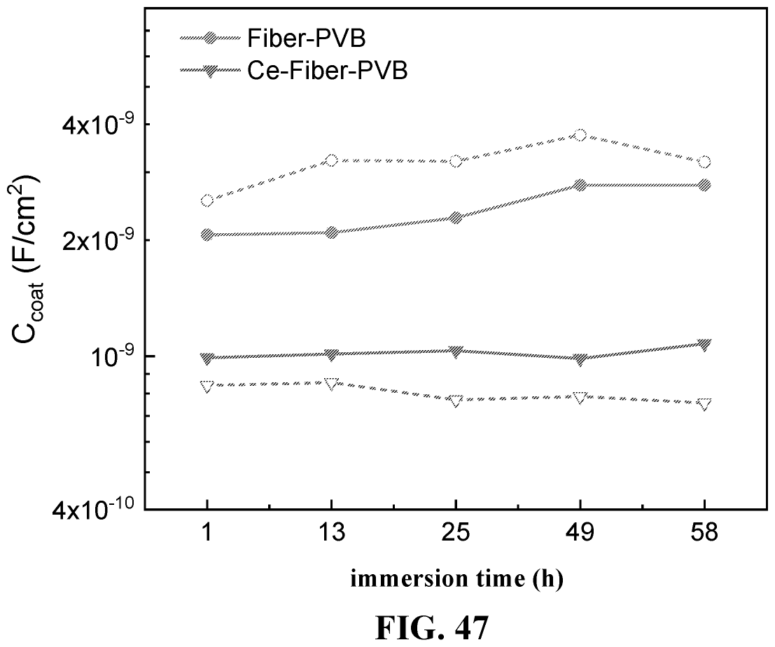

To further evaluate the resistance of Fiber-PVB and Ce-Fiber-PVB against corrosion, EIS spectra were also recorded in 100 mM NaCl at different immersion times, and the results are displayed in FIG. 44A-44C. As a reference, PVB samples were also prepared by sequentially dip-coating four individual layers of PVB on the AA2024-T3 substrate. The resulting coatings were tested by EIS under the same condition. As shown in FIG. 44A, the introduction of nanofibers into the coating matrix did not negatively affect the barrier property, which is evident by the fact that the low frequency impedance was similar to that of PVB at the beginning of EIS measurements (FIG. 44C). This is not the case when the coated samples were prepared by a bar-coating method (FIG. 34). During the dip-coating process, a dilute PVB solution was used, which is more likely to diffuse into the nanofiber mat and seal the interfibrous pores. Moreover, the dilute PVB solution can lower the risk of generating artifacts that are often found by using the sticky and concentrated PVB solution during the bar-coating process. Accordingly, the resulting coated sample had fewer defects, and the embedded nanofibers did not substantially affect the barrier property of the coating matrix. However, the deterioration of the coating seems to be accelerated by the embedded nanofibers, which is supported by the larger decrease in |Z|_{0.01 Hz} of Fiber-PVB over time compared to that of the PVB sample (FIG. 45). This is due to the destruction of the nanofibers with the presence of aggressive salt ions and local pH alteration during the immersion. Also, the nanofibers undesirably enhance the hydrophilicity of the coating, so the water ingress is speeded up. Since the electrolyte is easier to breach the coating, corrosion occurs more readily on the metal substrate. Unlike Fiber-PVB, Ce-Fiber-PVB showed promising corrosion resistance. In the Bode phase plot, only one time constant is observed, which is related to the coating property. The capacitive region extends towards the lower frequency over time, indicating high corrosion resistance of Ce-Fiber-PVB sample throughout the immersion (FIG. 44A). The EIS spectra acquired from Fiber-PVB and Ce-Fiber-PVB were also fitted by using the equivalent circuits with two time constants and one time constant, respectively (FIG. 39(b)). Only Rₚₒᵣₑ and C_{coat} of these two coating samples were investigated as Ce-Fiber-PVB had just one time constant characterizing the coating property, and the results are illuminated in FIG. 46 and FIG. 47. For Fiber-PVB, Rₚₒᵣₑ steadily reduced from 3.4×10⁵ ohm·cm² to 2.0×10³ ohm·cm², on account of the solution absorption and the rupture of nanofibers. In the replicate EIS test, Rₚₒᵣₑ slightly increased when the immersion time was longer than 25 h (FIG. 46), which was possibly related to the poor protection from corrosion products. Nonetheless, it is safe to conclude that Fiber-PVB coating did not provide a sufficient degree of protection toward the AA2024-T3 substrate. On the other hand, an increase in Rₚₒᵣₑ of Ce-Fiber-PVB was shown because of additional corrosion protection of Ce(NO₃)₃ stored in the nanofibers. Additionally, C_{coat} of Ce-Fiber-PVB remained at around 1×10⁻⁹ F/cm² and was always lower than that of Fiber-PVB during the immersion period (FIG. 47). This again proves that the addition of Ce(NO₃)₃-loaded nanofibers can accomplish satisfying corrosion protection performance.

Scribe Protection by Ce(NO₃)₃-Loaded Nanofibers

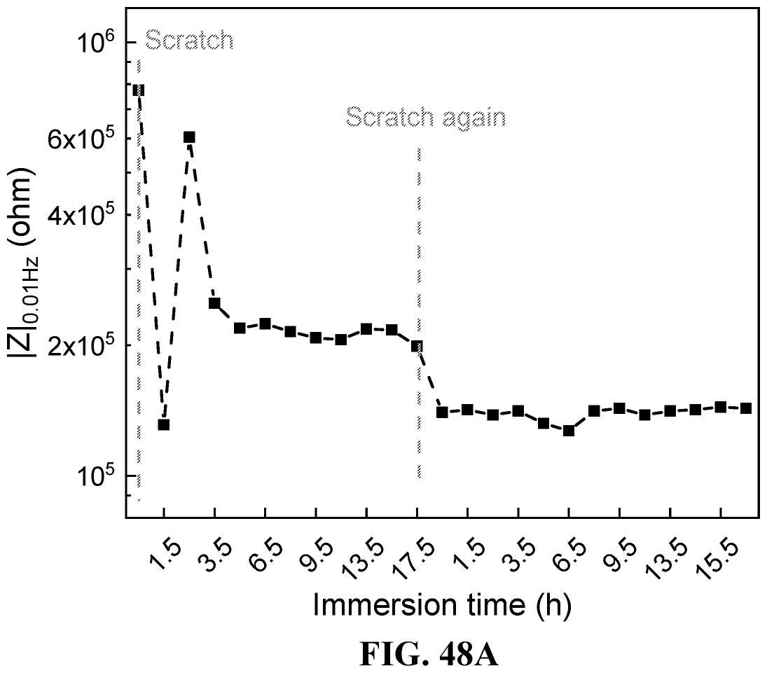

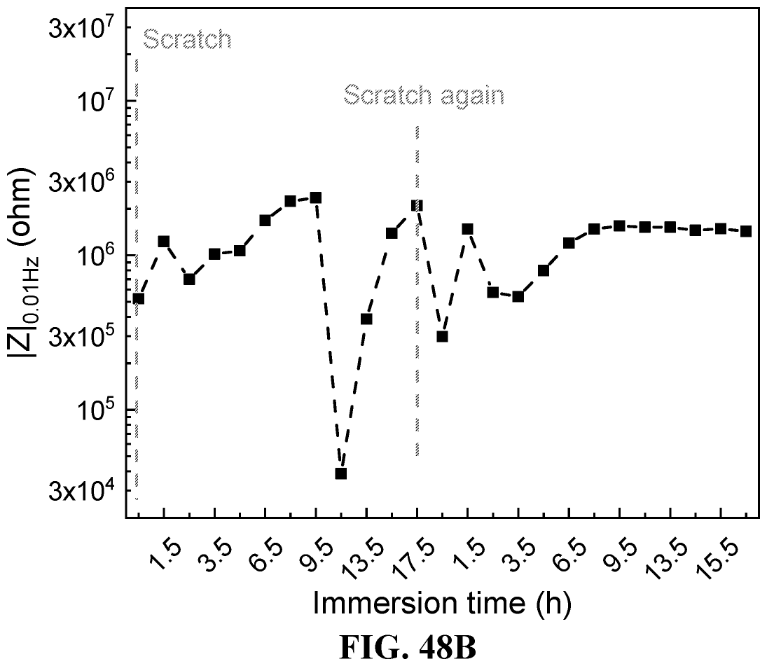

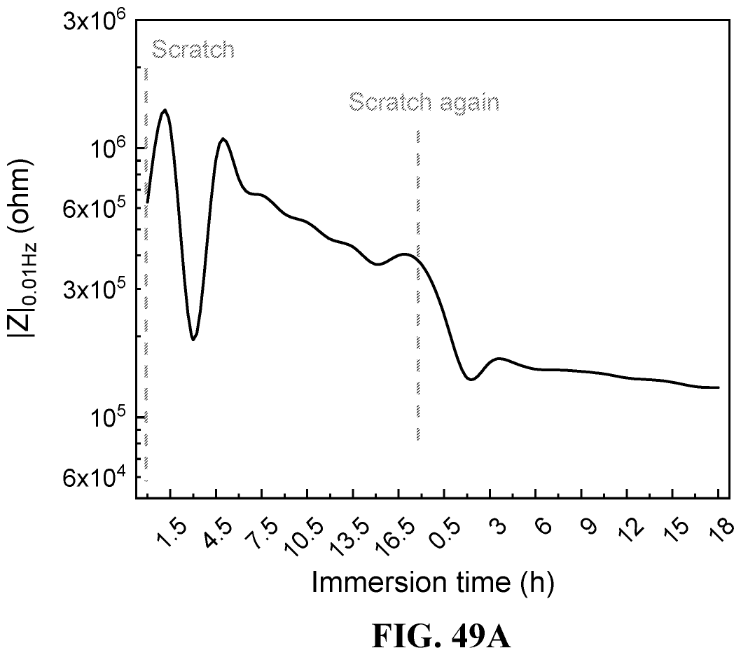

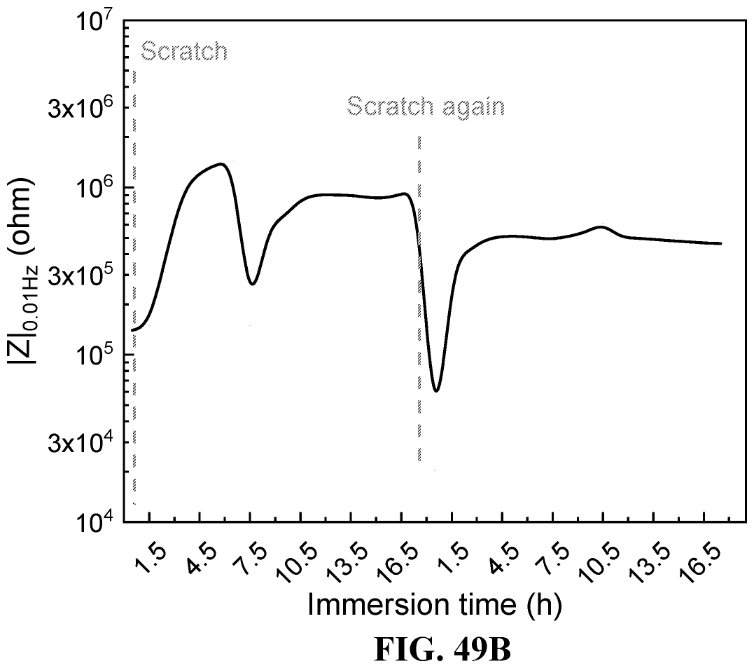

EIS measurements were conducted and the variation of |Z|_{0.01 Hz} with time was documented to inspect the scribe protection of the sample with Ce(NO₃)₃-loaded nanofibers. In comparison, the coating system containing Ce(NO₃)₃-loaded microspheres was also fabricated and tested under the same condition. To assure that a similar amount of corrosion inhibitors was encapsulated within the microspheres or the nanofibers, the time for the electrospray or electrospinning process was the same. The nanofibers or microspheres were then introduced into an epoxy coating rather than a PVB coating because the epoxy coating has a superior physical barrier property and long durability. Therefore, it is assumed that the resulting coating will prevent the penetration of electrolyte and fully isolate the underlying metal substrate from the corrosive environment during 2 days of immersion if no damage is made in the coating on purpose. When an artificial scratch was made in the coating to expose the shiny metal substrate underneath, corrosion is presumed to happen in that damaged area with no corrosion in areas where the coating is not scratched. As shown in FIG. 48A, a relatively high |Z|_{0.01 Hz} value of approximately 8.0×10⁵ ohm was measured on the freshly scribed sample with Ce(NO₃)₃-loaded microspheres, probably due to the accumulation of coating debris or corrosion products on the metal surface. The |Z|_{0.01 Hz} value remarkably declined to 1.3×10⁵ ohm after 1.5 h, indicating corrosion of AA2024-T3. Then, the bare metal substrate was protected by the released Ce(NO₃)₃ from the microspheres located in this defect area, so |Z|_{0.01 Hz} recovered to 6.0×10⁵ ohm. However, Ce(NO₃)₃ in this area was not abundant to offer the substrate protection against the continuous corrosion attack, thus the |Z|_{0.01 Hz} decreased after 3.5 h. Subsequently, a fresh scratch was made again at the same defective region to expose the underlying metal substrate after 18 h of immersion. After the second scribe was made, the corrosion resistance of the coated sample reduced and never covered again. This is likely because Ce(NO₃)₃ is quickly consumed during the first corrosion process, and corrosion inhibitors preserved in other locations of the coating cannot migrate fast enough to heal the defective zone when corrosion recurs. The same issue has been reported by numerous studies, which is generally described as limited chemical throwing power of corrosion inhibitors.^{66,67} A similar result was seen in the replicate test FIG. 49A, where the corrosion protection could only last for a few hours. On the other hand, |Z|_{0.01 Hz} progressively increased from 5.0×10⁵ ohm to 2.4×10⁶ ohm during the first 18 h immersion for the coating sample with Ce(NO₃)₃-loaded nanofibers. Although |Z|_{0.01 Hz} exhibited a sudden drop to 4.0×10⁴ ohm at around 12 h immersion due to the re-occurrence of corrosion, it went back to a value above 2.1×10⁶ ohm after this stage. When the coating was scratched again to uncover the metal substrate, |Z|_{0.01 Hz} continued to increase and reach a value of 1.6×10⁶ ohm FIG. 48B. This repeatedly healing phenomenon is also observed in the replicated EIS test FIG. 49B. All these results suggest that the substrate could be continuously healed by the released corrosion inhibitors from the nanofibers. Unlike the inhibitor-loaded microspheres, the nanofibers can serve as a pathway for the inhibitors to be transported from other locations to the corrosion-active region, therefore, adequate corrosion inhibitors can form a stable film to prevent the re-occurrence of corrosion. This difference shown in FIGS. 48A and 48B clearly demonstrates the effectiveness and benefit of using a fibrous delivery system to attain a repeated healing ability for long-term corrosion protection of AA2024-T3.

### Example 4

Ce(NO₃)₃-loaded microspheres were fabricated and the corresponding pH-dependent release behavior was monitored by UV-vis spectroscopy. After dispersing the inhibitor loaded microspheres into a polyvinyl butyral (PVB) coating matrix, a pH-sensitive smart coating was generated. The improved corrosion protection performance was validated through electrochemical measurements including cyclic polarization and electrochemical impedance spectroscopy (EIS). Scanning electron microscopy (SEM) with energy dispersive spectroscopy (EDS) and confocal spectroscopy were also applied to characterize the physiochemical properties of the Ce(NO₃)₃-loaded microspheres and the pH-sensitive coatings.

### Materials

Branched PEI (M_{w}=25,000 g/mol), PAA (Mᵥ=450,000 g/mol), rhodamine B base, and dichloromethane (DCM) were purchased from Sigma-Aldrich. Sulfuric acid, sodium hydroxide, hoechst 33258 pentahydrate, sodium chloride, cerium(III) nitrate hexahydrate, and sodium sulfate anhydrous were from Fisher Scientific. PVB was obtained from Pfaltz & Bauer, and acetic acid glacial was from Mallinkrodt AR. All aqueous solutions were prepared using deionized (DI) water with a resistivity of 18.2 MΩ·cm from a Milli-Q filtration system. All materials were used as received without further purification. Aluminum alloy 2024-T3 substrates were ground through 1200 grit SiC papers with ethanol as lubricant to minimize corrosion.

Fabrication of Ce(NO₃)₃-Loaded Microspheres

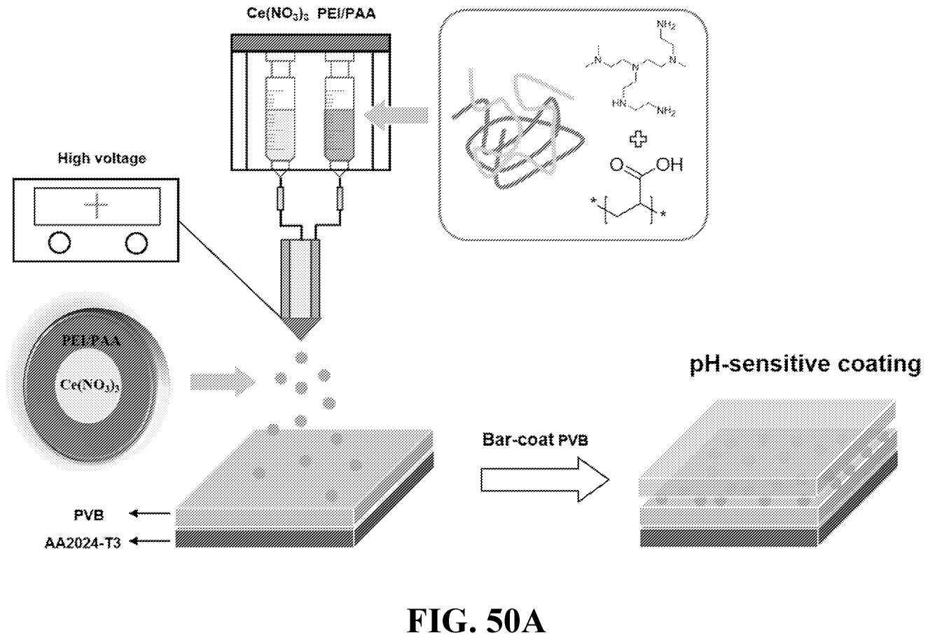

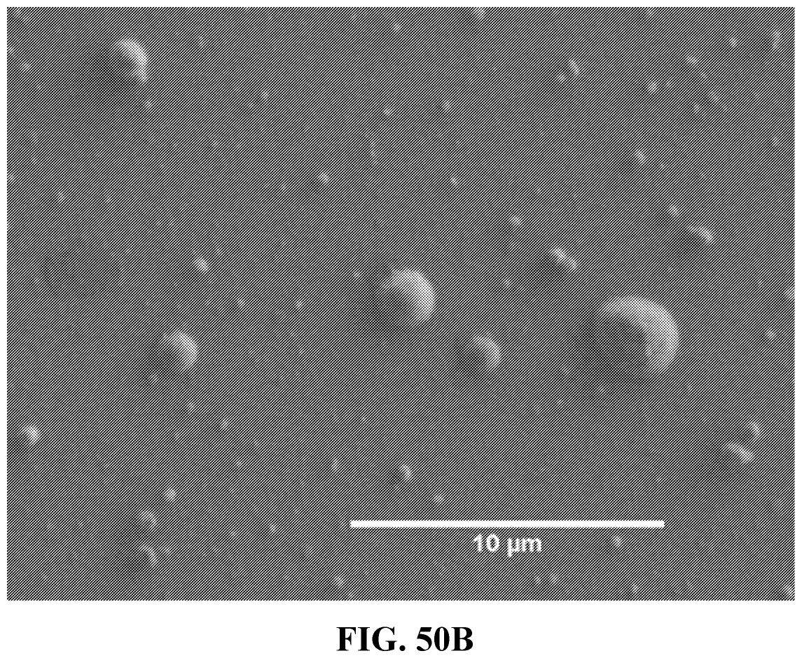

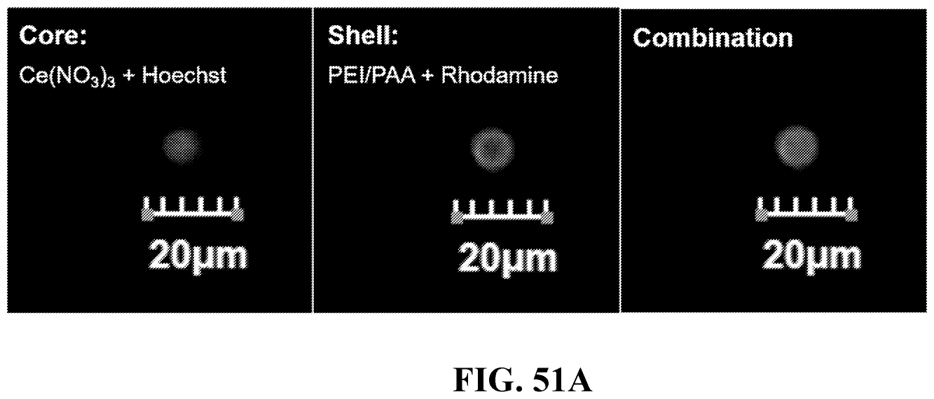

The Ce(NO₃)₃-loaded microspheres were generated using a coaxial electrospray technique. Ce(NO₃)₃ was dissolved in acetone at a concentration of 0.5 M, which was used as the core liquid. PEI/PAA polyelectrolyte coacervates as the shell liquid were prepared. Briefly, PEI and PAA were dissolved in a mixture of ethanol, DCM, and acetic acid with a volume ratio of 3:3:4 and 5:3:2, respectively. The as-prepared PEI and PAA solutions had a concentration of 75 mM with respect to the amine groups and carboxylic acid groups, respectively. The PEI/PAA coacervate was obtained by adding PAA solution into PEI solution dropwise under stirring until achieving a PEI:PAA molar ratio of 1:2. As shown in (FIGS. 50A-50B), the Ce(NO₃)₃ solution and PEI/PAA coacervate, fed by two syringes independently, flowed through a coaxial nozzle consisting of two concentric needles. The Ce(NO₃)₃ solution was injected through the inner needle at a feed rate of 0.2 mL/h while PEI/PAA coacervates were fed through the outer needle at a rate of 1.5 mL/h. The diameters of exterior and interior needles were 1.02 and 0.64 mm, respectively. A static potential of 15 kV was applied to the tip of the coaxial nozzle. The Ce(NO₃)₃-loaded microspheres were harvested on a ground collector that was placed 20 cm below the coaxial nozzle.

The as-fabricated Ce(NO₃)₃-loaded microspheres were able to release corrosion inhibitors at both acidic and basic pH conditions at a faster rate than that at neutral pH.

Morphological characterization of AA2024-T3 after cyclic polarization showed that the Ce(NO₃)₃ released from the microspheres precipitated on the intermetallic particles and formed an insoluble film. These cerium compounds seemed to reduce the cathodic reaction kinetics during corrosion, rendering a cathodic inhibition effect at pH 7 and pH 10. However, the inhibition effect was not significant at pH 2.5, probably because the aggressive environment made it difficult to quickly form a stable insoluble film to passivate the metal surface.

Ce(NO₃)₃-loaded microspheres were embedded into a PVB coating matrix to generate a dual-pH responsive coating, i.e. Ce-PEI/PAA-PVB. Three more coatings including PVB, PEI/PAA-PVB, and Ce-PVB were prepared for comparison. EIS analysis was performed on all coated samples, which revealed that Ce-PEI/PAA-PVB sample had the highest corrosion resistance within the testing period.

Characterization of Ce(NO₃)₃-Loaded Microspheres

The morphology of the Ce(NO₃)₃-loaded microspheres was examined by SEM. Confocal spectroscopy (Olympus FV1000 Filter Confocal System) was used to confirm the core-shell structure of representative large microspheres. To observe the core-shell structure of the as-fabricated microspheres, rhodamine B base, a fluorescence dye, was added into the PEI/PAA coacervate whereas Hoechst 33258 pentahydrate was mixed with the Ce(NO₃)₃ solution prior to the electrospray process. The Ce(NO₃)₃-loaded microspheres were collected on a glass slide and subjected to characterization by confocal spectroscopy with a laser excitation wavelength of 544 nm for rhodamine B base and 355 nm for Hoechst 33258 pentahydrate, respectively. Focused ion beam (FIB, FEI 200 FIB workstation) was also used to prepare the cross-section of representative small microspheres for the identification of the core-shell structure, which was not visible under confocal microscopy due to limited optical resolution. To validate the successful encapsulation of cerium nitrate in microspheres, the as-fabricated microspheres were collected on a silicon wafer and the composition of individual microspheres was recorded by SEM coupled with EDS. An FEI Quanta 200 SEM with an EDS detector was used. The acceleration voltage was 5 kV.

Release Study of Ce(III) from Ce(NO₃)₃-Loaded Microspheres

To examine the release kinetics of Ce(III), approximately 2 mg of Ce(NO₃)₃-loaded microspheres were electrosprayed and collected on laboratory glass slides (40×25 mm), followed by immersion in 9 mL of DI water with varied pH (i.e. pH 2.5, 7 and 10). The solution pH was adjusted with 0.1 M H₂SO₄ or NaOH solutions. At definite time intervals, a 5 mL aliquot was extracted and replaced with fresh DI water with the same pH and volume. The light absorption of Ce(II) in the extracted solution was measured by UV-vis at λₘₐₓ=250 nm. A calibration curve was established for all pH conditions due to the pH-independent absorption behavior of Ce(III), and the concentration of released Ce(II) was obtained by extrapolating from the calibration curve. The cumulative concentration of released Ce(III), C_{cum}, was calculated using the equation:

$${C}_{cum} = {C}_{t} + \frac{v}{V} {\sum }_{0}^{t - 1} {C}_{t} \qquad ( 1 )$$

Where Cₜ, v and V are the concentration of released Ce(III) at time t, the extracted volume at time t and total volume of the released medium, respectively.

### Cyclic Polarization

Cyclic polarization was conducted to evaluate the corrosion inhibition property of released Ce(NO₃)₃. Typically, Ce(NO₃)₃-loaded microspheres were immersed in 10 mM NaCl with pH of 2.5, 7 or 10 for 2 h to induce Ce(NO₃)₃ release. The pH of the solution was not buffered during the release. The open circuit potential (OCP) of a bare AA2024-T3 panel immersed in the release medium was measured by a Gamry™ Reference 600 potentiostat for 1 h prior to the cyclic polarization. A three-electrode cell was used, where a bare AA2024-T3 panel served as the working electrode. The reference and counter electrodes were a saturated calomel electrode (SCE) and a platinum mesh, respectively. Cyclic polarization was performed at a scan rate of 0.5 mV/s from −0.2 V with respect to the OCP toward the more noble direction. When the current density reached 1 mA/cm², the scanning direction was reversed.

Characterization of Ce(NO₃)₃ Adsorption

SEM coupled with EDS was applied to examine the presence of Ce(NO₃)₃ on the bare AA2024-T3 panels after cyclic polarization, to shed light on the inhibition mechanism of Ce(NO₃)₃. The acceleration voltage of the electron beam was 20 kV.

Preparation of Coatings with Inhibitor-Loaded Microspheres on AA2024-T3 Substrates

To embed Ce(NO₃)₃-loaded microspheres into PVB coatings, a single layer of 15 w/v % PVB in ethanol was bar-coated on AA2024-T3 substrates, followed by the deposition of inhibitor-loaded microspheres via electrospray for 1 h. After drying overnight, another layer of PVB was bar-coated to fully cover the microspheres. The obtained coating was denoted as Ce-PEI/PAA-PVB. For comparison, three other types of coating formulations, i.e. PVB, PVB with electrosprayed Ce(NO₃)₃ (no PEI/PAA), and PVB with electrosprayed PEI/PAA coacervate microspheres (no Ce(NO₃)₃), were prepared following the same procedures and denoted as PVB, Ce-PVB, PEI/PAA-PVB, respectively. It should be noted that acetone and the PEI/PAA coacervate solution were used as the core and shell liquids, respectively, during the electrospray process to fabricate PEI/PAA coacervate microspheres without Ce(NO₃)₃. All coatings had a thickness in the range of 10-20 μm measured by a micrometer caliper. The surface morphology of all coatings was examined by SEM prior to any corrosion experiments.

### Electrochemical Impedance Spectroscopy

To assess the corrosion resistance of PVB, PEI/PAA-PVB, Ce-PVB and Ce-PEI/PAA-PVB, EIS measurements were carried out on these coated samples, which were immersed in two sets of electrolyte solutions: neutral 100 mM NaCl or 5 mM Na₂SO₄ with pH 2.5, pH 7 or pH 10 adjusted by 0.1 M H₂SO₄/NaOH. 5 mM Na₂SO₄ solutions with varied pH conditions were chosen to mimic the local environments during corrosion of AA2024-T3, thus inspecting the corresponding corrosion resistance of coated samples. On the other hand, 100 mM NaCl is considered to be aggressive to AA2024-T3, so it was used to assess the protective ability of all coating samples in a corrosive environment. A three-electrode cell was used, which consisted of a platinum mesh counter electrode, a saturated calomel reference electrode (SCE), and the coated aluminum samples as working electrodes with an exposed area of 1 cm². After stabilizing the OCP for 1 h, impedance spectra were acquired by applying sinusoidal signals at a frequency range of 10⁵ Hz to 0.01 Hz with a 10 mV perturbation around the OCP. To avoid the interference of external electromagnetic fields, EIS tests were performed in a Faraday cage. To ensure reproducibility, all EIS measurements were conducted at least twice.

### Results

Characterization of Ce(NO₃)₃-Loaded Microspheres

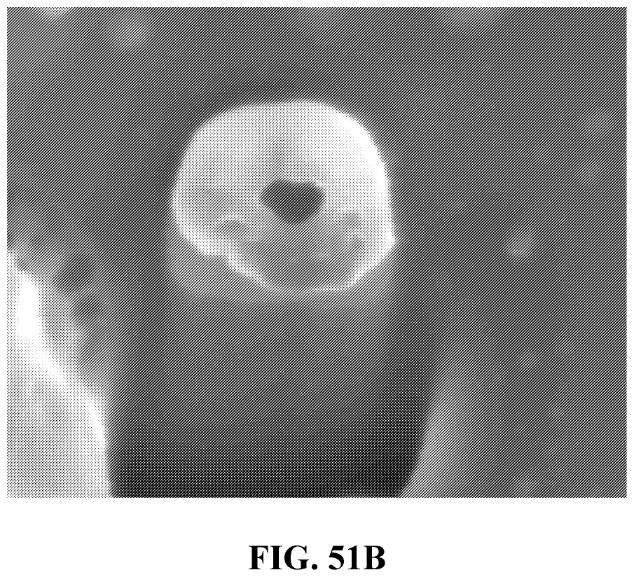

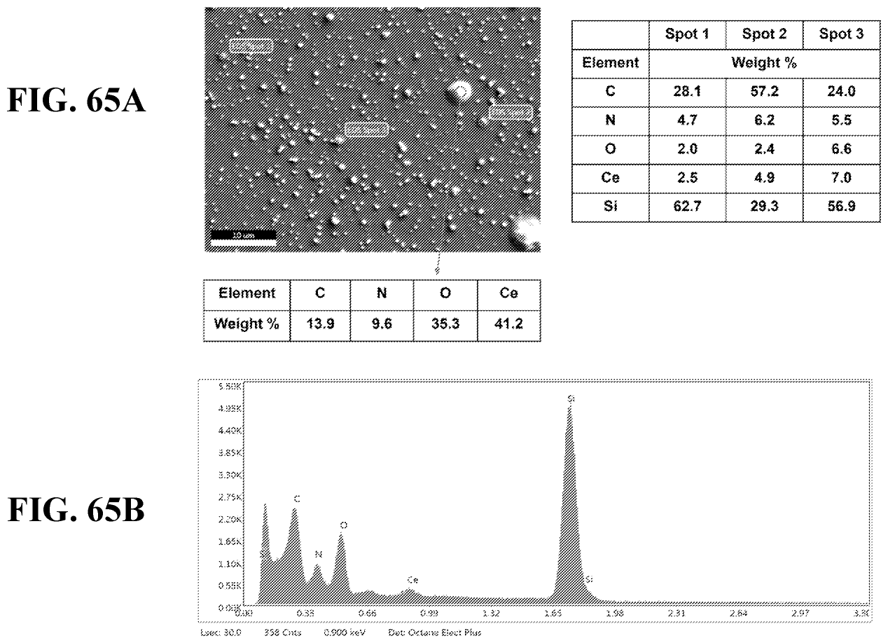

The Ce(NO₃)₃-loaded microspheres were fabricated by electrospray using a coaxial nozzle (FIG. 50A). All microspheres have a spherical shape with a diameter on the micron/submicron scale (FIG. 50B). A broad distribution in the particle size is observed, which may indicate the intermittent cone-jet mode occurring during the electrospray process. To examine the core-shell structure of the microspheres, rhodamine B base and Hoechst 33258 pentahydrate were added to the shell and core material, respectively. By using confocal laser microscopy, rhodamine B base was excited to emit a red light, whereas Hoechst 33258 pentahydrate gave a blue light. As a result, the shell and core of the microspheres imaged by confocal microscopy were red and blue in color, respectively. The core-shell structure of large microspheres is clearly observed, suggesting the successful fabrication of Ce(NO₃)₃-loaded microspheres (FIG. 51A). Particles with submicron sizes were also generated during the electrospray process. Due to the limited optical resolution of confocal microscopy, the core-shell structure of these smaller particles was studied with SEM after the cross-sections of the particles were prepared by FIB, which can provide high-resolution investigation on the nanometer scale. The cross-section of one representative small particle prepared by FIB also displays a similar core-shell structure (FIG. 51B), indicating that the as-fabricated microspheres possess a core-shell structure regardless of the particle size. Furthermore, EDS was performed to assure the incorporation of Ce(NO₃)₃ in the microspheres (FIG. 65A). Three small and one large microspheres were randomly chosen and examined with EDS. The composition of each microsphere is listed in the table included in (FIG. 65A). The spectral Mα line located at 0.88 keV was used to examine the existence of Ce (FIG. 65B). No other spectral lines of Ce at higher energy levels were analyzed to avoid the overwhelming background signals from the metal substrate. Although the cerium content was dependent on the size of the selected microspheres, as expected, the presence of cerium confirmed by EDS suggests the successful loading of Ce(NO₃)₃ into the microspheres.

Release Study of Ce(III) from Ce(NO₃)₃-Loaded Microspheres

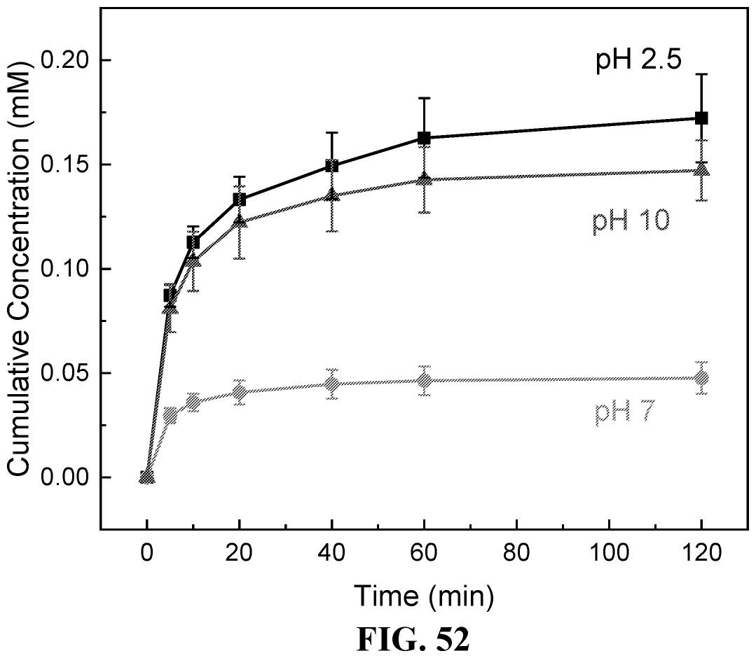

The pH-responsive behavior of Ce(NO₃)₃-loaded microspheres was explored by a release study. The microspheres were deposited on a glass slide by electrospray and an area of 7.5 cm² was immersed in 9 ml DI water with pH 2.5, 7, or 10. The concentration of the released Ce(III) was recorded by UV-vis spectroscopy (FIG. 52). The cumulative concentration of the released Ce(III) quickly increased and reached a steady-state plateau after 2 h. The final cumulative concentration of Ce(III) was 0.17 mM at pH 2.5 and 0.15 mM at pH 10, but only 0.05 mM at pH 7. Ce(III) has a lower solubility in alkaline conditions because it may interact with OH⁻ ions to form insoluble species, so the release rate was slowed down. Therefore, a slightly lower amount of released Ce(III) at pH 10 than pH 2.5 is expected. Nevertheless, compared to pH 7, more Ce(III) is released in both acidic and alkaline environments, which proves that the Ce(NO₃)₃-loaded microspheres are indeed dual pH-sensitive. The pH-dependent release behavior can be attributed to the unique property of the dual-pH-responsive polyelectrolyte coacervate shell of the microspheres. The polyelectrolyte coacervate was made from two weak polyelectrolytes, i.e. PEI and PAA, which could be destabilized at both low and high pH conditions due to the weaken interactions between the polyelectrolytes. Hence, microspheres based on this polyelectrolyte coacervate could rupture to release corrosion inhibitors upon a pH change. On the other hand, at pH 7, moderate interactions between the functional groups of PEI and PAA are maintained in the form of ionic crosslinks, so the integrity of the polyelectrolyte coacervate is protected. Consequently, the microspheres are well-preserved under neutral condition, which prevents undesired leakage of the corrosion inhibitors from the core of the microspheres.

Corrosion Inhibition by Released Ce(NO₃)₃

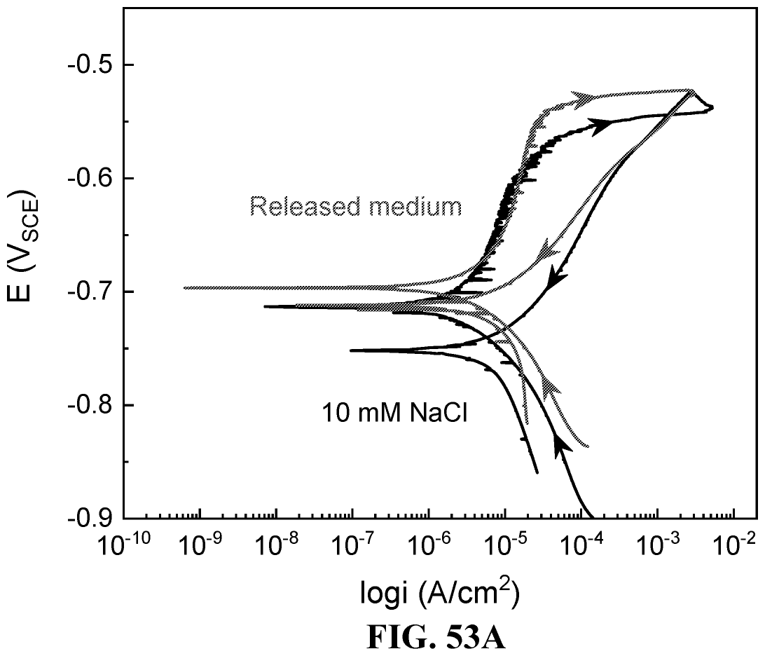

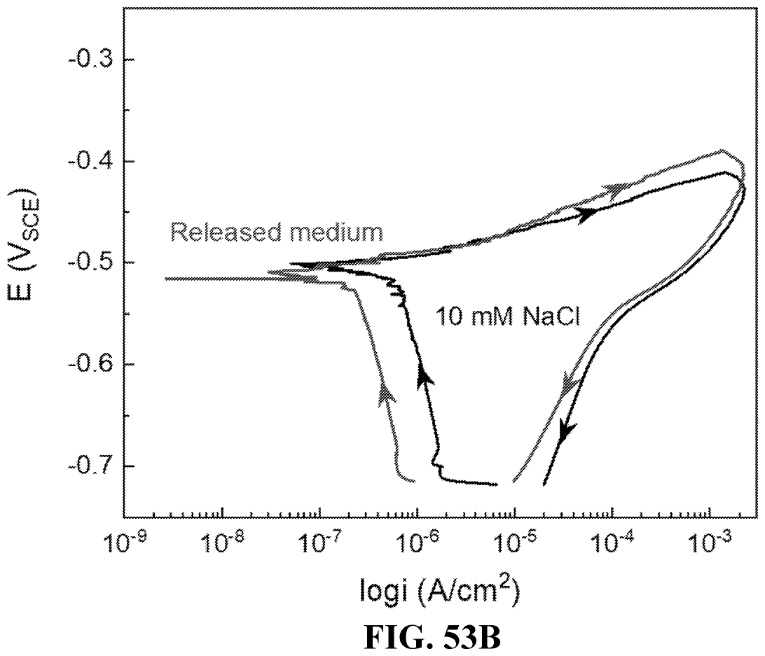

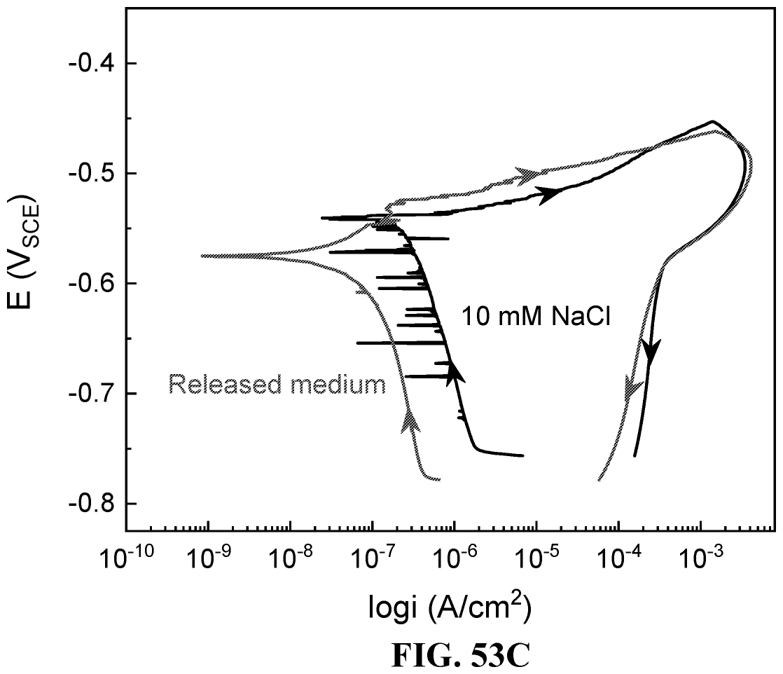

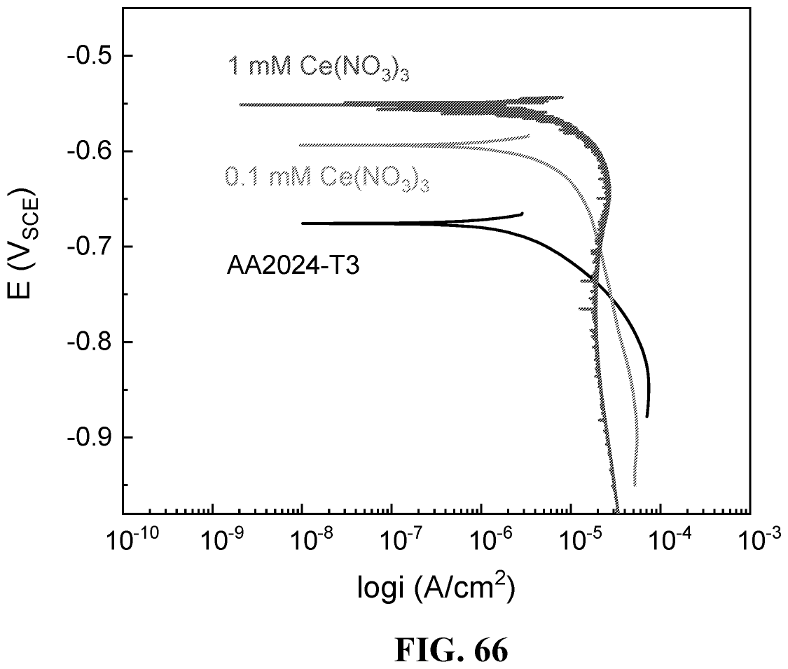

To inspect the inhibition efficacy of released Ce(NO₃)₃, cyclic polarization was performed on AA2024-T3 immersed in 10 mM NaCl containing released Ce(NO₃)₃ at varied pH conditions. UV-vis spectroscopy shows that the amount of released Ce(NO₃)₃ was 0.17 mM, 0.16 mM, and 0.07 mM at pH 2.5, 10, and 7, respectively, consistent with the release study. As a control, AA2024-T3 was also polarized in 10 mM NaCl solution without any corrosion inhibitors under the same pH conditions. The rendered polarization curves of AA2024-T3 are shown in (FIGS. 53A-53C) and the corresponding corrosion current densities (icorr) extracted from the polarization curves are provided in Table 7. At pH 2.5, there is no significant change in the polarization curve of the AA2024-T3 substrate polarized in the release medium compared to that in 10 mM NaCl solution (FIG. 53A). The polarization curve obtained in the released medium exhibits a slightly lower corrosion current density, and slightly higher pitting and repassivation potentials compared to that measured in 10 mM NaCl solution. These observations might suggest a certain degree of inhibition for the released media, but the overall effect is limited, which is likely associated with the highly corrosive condition at pH 2.5. On the other hand, at pH 7, the polarization curve measured in the release medium displays consistently lower current densities in the cathodic region compared to the control group as a result of the presence of Ce(NO₃)₃ (FIG. 53B). At pH 10, the corrosion potential (E_{corr}) shifts toward the more active direction and the cathodic current density is depressed by almost one order of magnitude due to the presence of the released Ce(NO₃)₃ in 10 mM NaCl (FIG. 53C), indicating a cathodic inhibition mechanism. icorr is also significantly reduced (Table 1). Furthermore, in contrast to the AA2024-T3 substrate corroded in 10 mM NaCl at pH 10, which does not exhibit any passivity, a passive region clearly appears in the anodic branch from −0.58 to −0.52 V_{SCE} when released corrosion inhibitors are present. In conclusion, the existence of Ce(NO₃)₃ has a clear effect on enhancing the corrosion resistance of the AA2024-T3 substrates at both pH 7 and pH 10 but the effect is marginal at pH 2.5. It is well known that Ce(NO₃)₃ is an effective inhibitor for AA2024-T3. When aluminum alloys corrode under OCP, oxygen reduction reaction (ORR) generally serves as the primary cathodic reaction and generates OH⁻ ions. The resulting alkaline environment can further interact with cerium ions to give rise to an insoluble film consisting of Ce(III) oxides/hydroxides in the proximity of cathodic sites. Meanwhile, this insoluble film is less conductive than the metal substrate underneath, so it can reduce the rate of ORR by retarding the charge transfer process. Due to the suppressed cathodic reaction of AA2024-T3, OCP can be lowered to below the pitting potential of AA2024-T3, therefore an apparent passivation region can be exhibited in the presence of the released Ce(NO₃)₃ at pH 10 (FIG. 53C). Besides, Ce(III) can be oxidized to Ce(IV) by the hydrogen peroxide produced during the oxygen reduction and the resulting Ce (IV) can be further converted to Ce(OH)₄ and CeO₂ and precipitated on the cathodic sites to reduce the corrosion rate. In the case of pH 7 and pH 10, the released Ce(NO₃)₃ provides a cathodic inhibition effect and the corrosion rate is considerably reduced, suggesting that the local concentration of released corrosion inhibitors exceeds the threshold to suppress the corrosion of AA2024-T3. However, under acidic conditions, the local pH increase at the cathodic sites might have been buffered by the bulk acidic environment, thereby retarding the formation of cerium oxides and hydroxides. This may lead to a partial coverage of the insoluble film on the metal surface so the released Ce(NO₃)₃ barely inhibits the corrosion of AA2024-T3 under acidic condition. Although (FIG. 53A) suggests an anodic inhibition effect of Ce(NO₃)₃ at pH 2.5, the influence on the cathodic branch is not conclusive. To further investigate whether the lack of a cathodic inhibition effect at pH 2.5 (FIG. 53A) was due to the limited concentration of released Ce(NO₃)₃, cathodic polarization measurements were performed on AA2024-T3 immersed in 10 mM NaCl solution with the direct addition of 0.1 mM and 1 mM Ce(NO₃)₃ (FIG. 66). Compared to that in 10 mM NaCl solution, the oxygen diffusion-limited current density shows a reduction of one-sixth and over half in 0.1 mM and 1 mM Ce(NO₃)₃, respectively, suggesting that cathodic inhibition can be enhanced by adding a higher amount of corrosion inhibitors. Although the corrosion potential and cathodic current density near the corrosion potential increase possibly due to the reduction of nitrate ions, it is reasonable to conclude the insufficient amount of released Ce(NO₃)₃ may be the reason for the unsatisfied corrosion protection performance at acidic pH condition, shown in (FIG. 53A).

TABLE 7
Corrosion current densities (i_{corr})

| | i_{corr} (μA/cm²) | | |
|---|---|---|---|
| | pH 2.5 | pH 7 | pH 10 |
| 10 mM NaCl | 2.2 | 0.57 | 0.21 |
| Released medium | 1.6 | 0.21 | 0.03 |

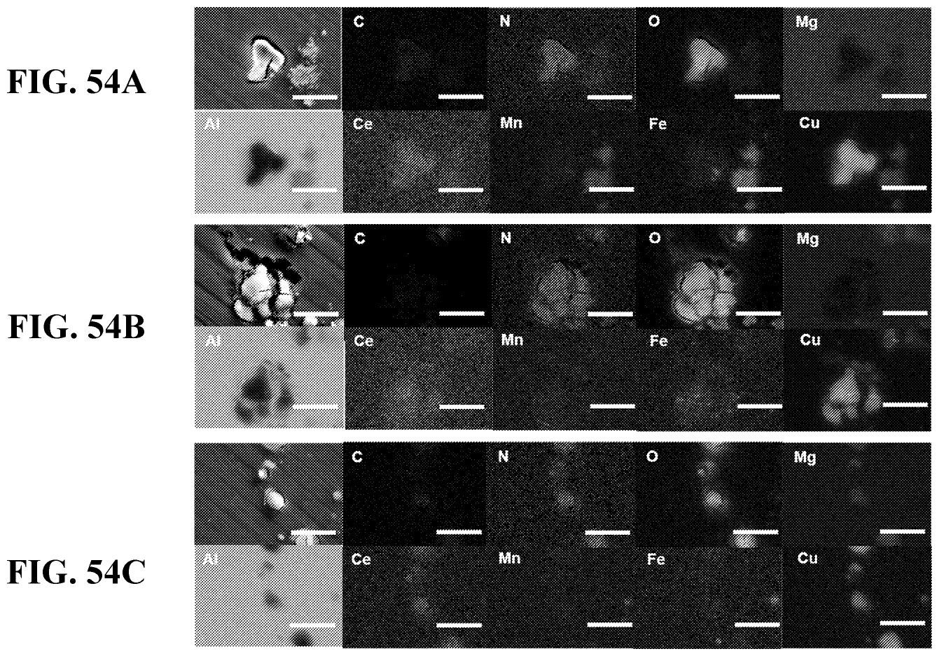

After the cyclic polarization scans, EDS analysis was carried out on the polarized samples. The result shows that cerium primarily existed on intermetallic particles including S-phase and Fe, Mn-rich particles under all three pH conditions (FIGS. 54A-54D), consistent with previous studies where preferential deposition of Ce at cathodic sites was reported. Many of these intermetallic particles are inherently more noble than the aluminum matrix, while some active ones, such as S-phase, also become more noble as a result of de-alloying. Therefore, these intermetallic particles often serve as cathodic sites, leading to the local pH increase and the subsequent precipitation of cerium oxides/hydroxides. These precipitates may interfere with the adsorption of oxygen at these locations and hinder the transfer of electrons from the nearby anodic areas. As a result, the cathodic kinetics are slowed down. However, the rate of precipitation might be slower than the anodic dissolution, or the coverage of such precipitates on the intermetallic particles may not be complete, so Ce(NO₃)₃ fails to completely prevent the formation of pits and trenches around the particles (FIGS. 54A-54D). It is noteworthy that a trace amount of magnesium is observed at pH 10. This indicates the dealloying process of S-phase particles is retarded, possibly due to the favorable pH condition for the cerium precipitation. At pH 2.5, the existence of cerium on both S-phase and Fe, Mn-rich particles was also analyzed, which reveals the presence of more cerium on S-phase particles. One possible explanation is that S-phase particles are depleted in Mg upon dealloying, resulting in the formation of remanent Al—Cu particles with a more noble corrosion potential than Fe, Mn-rich particles. Hence, cerium oxide/hydroxide is more likely to deposit on these Mg-depleted particles where cathodic reactions occur more readily. It should be noted that despite the precipitation of Ce(NO₃)₃ on the intermetallic particles, no significant inhibition effect is found in the polarization test at pH 2.5 (FIG. 53A), further indicating that the fast anodic dissolution at this pH condition may account for the negligible corrosion inhibition of Ce(NO₃)₃ on AA2024-T3.

### Characterization of Coatings on AA2024-T3 Substrates

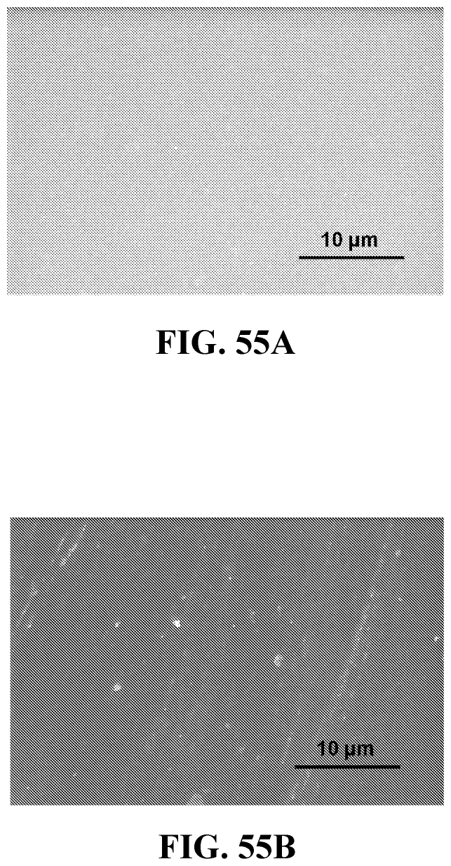

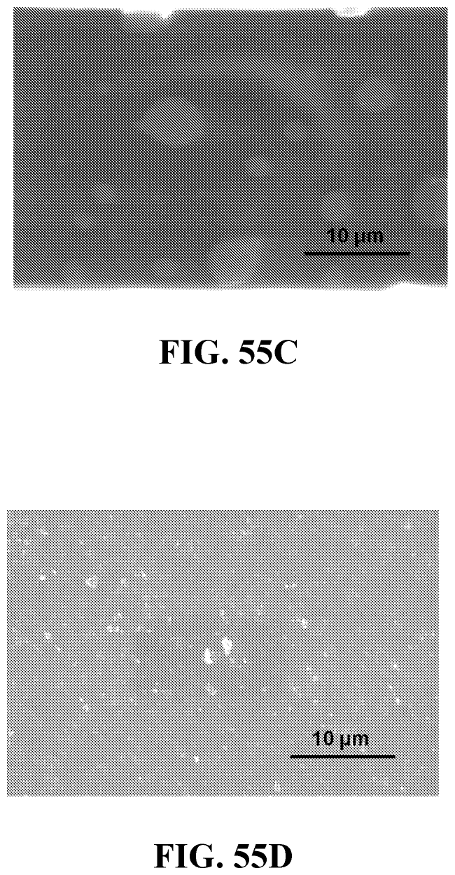

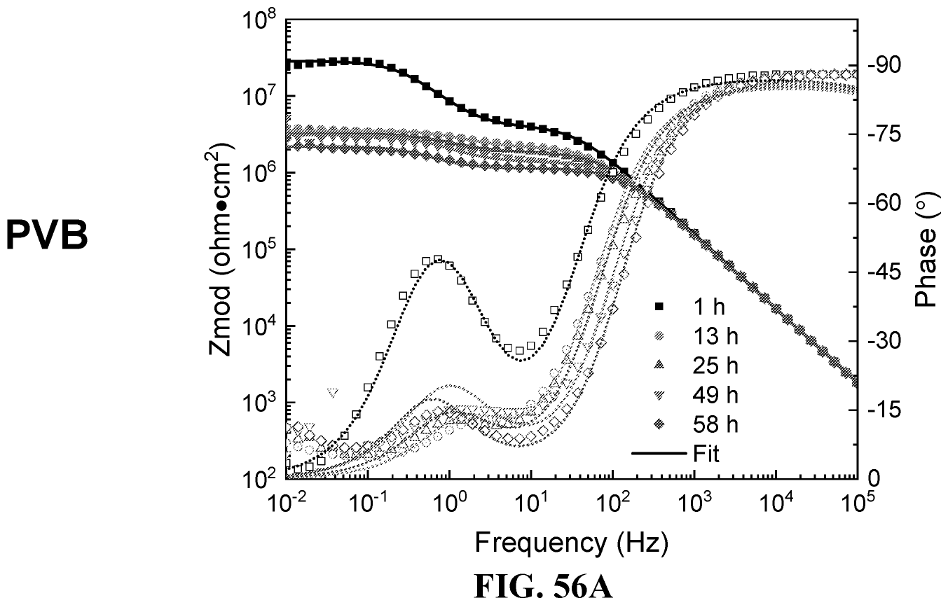

To develop a pH-sensitive coating for protecting AA2024-T3 substrate, Ce(NO₃)₃-loaded microspheres were electrosprayed on the PVB-precoated AA2024-T3, followed by depositing another layer of PVB on top of the microspheres. Hence, the Ce-PEI/PAA-PVB coating with a sandwich structure was prepared. Ce-PVB and PEI/PAA-PVB coatings were also prepared with the same method but only cerium nitrate or polyelectrolyte coacervates were electrosprayed. As a reference, a PVB coated sample was fabricated by sequentially bar-coating two individual layers of PVB on AA2024-T3. It should be noted that all coatings had a thickness within the range of 10-20 μm. It was hard to accurately determine the change of thickness by the incorporation of microspheres or inhibitor salts due to the difficulty in controlling the coating thickness as the specimens were manually bar-coated. After the coating process, all samples were dried in air at room temperature overnight and subjected to morphological characterization by SEM. The obtained PVB coating exhibited a smooth surface morphology (FIG. 55A). After introducing polyelectrolyte coacervates or Ce(NO₃)₃-loaded microspheres into the PVB coating (FIGS. 55B and 55D), these additives were homogeneously distributed inside the coating and no large pores or defects were observed. In contrast, apparent aggregation of Ce(NO₃)₃ was observed when only Ce(NO₃)₃ is impregnated within the coating (FIG. 55C), indicating low compatibility between the inorganic salts and organic polymer matrix. Another possible reason for the aggregation of Ce(NO₃)₃ is that during the electrospray, cerium nitrate particles in the nanometer size are more likely to be generated and they are prone to agglomerate due to the high surface area, as reported in other works.

### EIS Tests at Varied pH Conditions

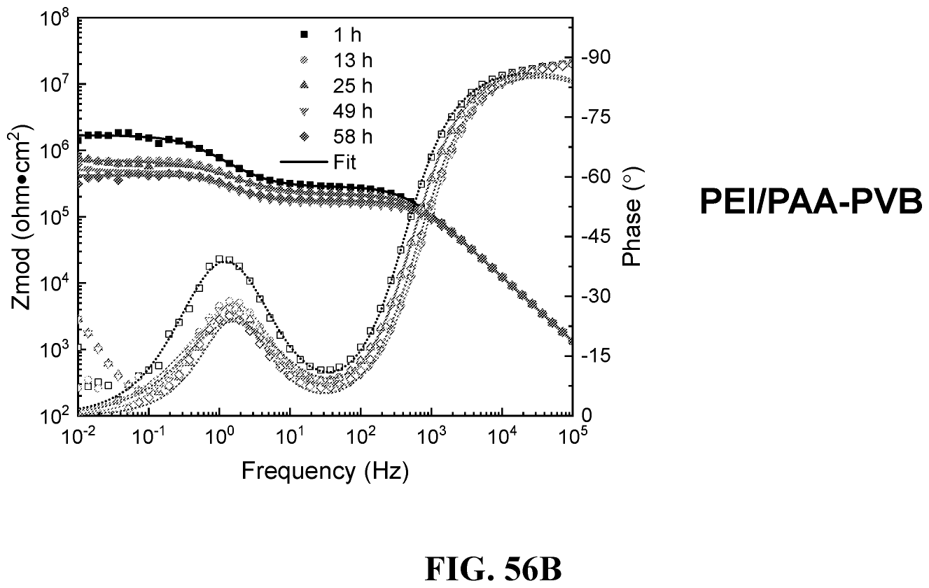

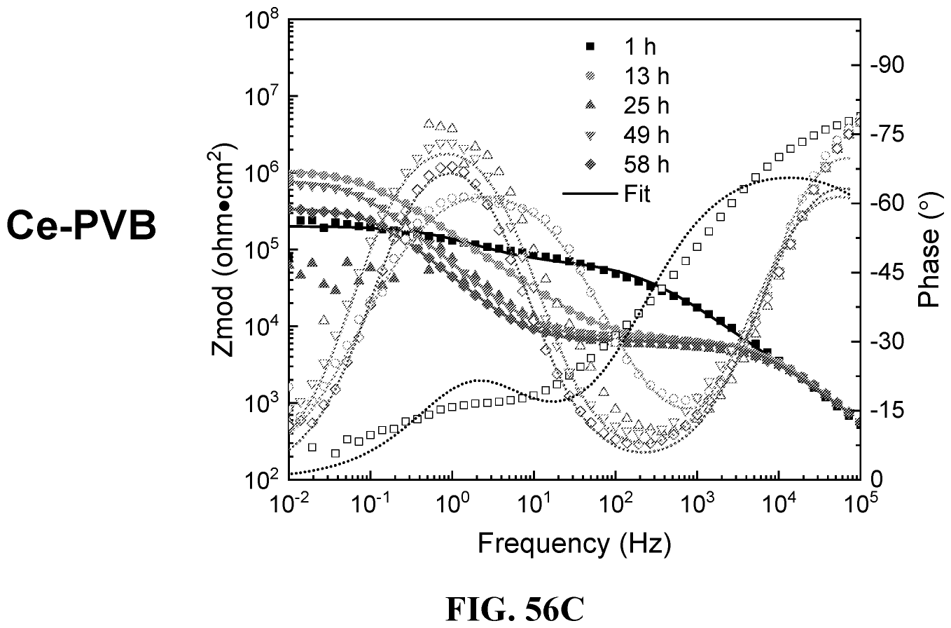

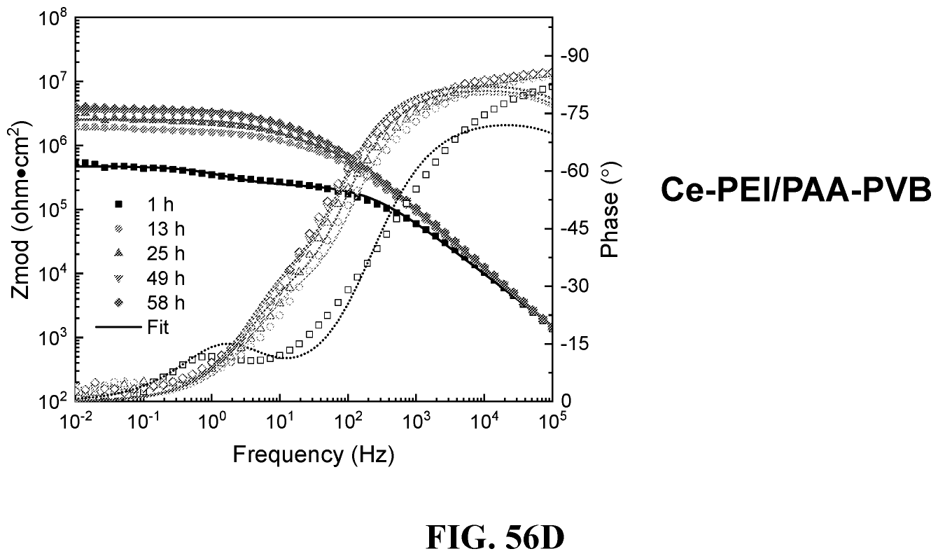

EIS measurement was conducted in 5 mM Na₂SO₄ at both pH 2.5 and pH 10 to mimic corrosion that may occur at anodic and cathodic sites, respectively. In this work, 5 mM Na₂SO₄ was added to provide conductivity of the electrolyte. It was assumed that such a small amount of Na₂SO₄ is unlikely to have a detrimental effect on the stability of the polyelectrolyte coacervates or the corrosion of AA2024-T3. Hence, the pH of the solution is expected to be the main factor to be investigated. All four coating samples, i.e. PVB, PEI/PAA-PVB, Ce-PVB, and Ce-PEI/PAA-PVB, were evaluated at pH 2.5, 10 and at pH 7 for comparison. To ensure reproducibility, all EIS experiments were replicated at least twice. FIGS. 56-58 exhibit a set of representative EIS results obtained after 58 h of immersion of the coated samples in 5 mM Na₂SO₄ solutions with different pH conditions.

At pH 2.5 (FIGS. 56A-56B), the low-frequency impedance values of both PVB and PEI/PAA-PVB samples decreased steadily with immersion time, whereas no clear trend was identified for the Ce-PVB sample. In contrast, the low-frequency impedance value of Ce-PEI/PAA-PVB sample continuously increased and the amplitude was the highest amongst all coated samples by the end of immersion. Also, unlike other coatings, the impedance values of Ce-PEI/PAA-PVB sample in the middle frequency did not drop after 13 h of immersion. These results indicate Ce-PEI/PAA-PVB has the best corrosion resistance. It should be pointed out that the impedance values at low-frequency region were different for various coatings at the initial immersion time. For example, the PVB sample had the highest initial impedance value which is almost one order of magnitude higher the others, while the Ce-PVB sample exhibited the lowest impedance value of only around 10⁵ ohm·cm². This suggests that the inclusion of various additives to the PVB coating matrix may adversely affect the barrier property of the polymer matrix to some extent. From the Bode phase plots, two time constants are visible for all coatings. The one at high frequency is related to the coating property and the other at low frequency is associated with the charge transfer process at the interface between the coating and the substrate. For Ce-PEI/PAA-PVB, the time constant at high frequency is dominant whereas the one at low frequency presents a small bump in the Bode phase plot. Also, the plateau region at the high frequency extends to the lower frequency and the bump at the low frequency tends to disappear with increasing immersion time. This pattern implies the corrosion protection performance of the coating was steadily improved and corrosion of the metal substrate was suppressed. The improved corrosion resistance is possibly due to the release of Ce(NO₃)₃ from the microspheres and the formation of local protective films on intermetallic particles. In contrast, the rest of the coating systems exhibited either a narrower plateau at high frequency region or a more evident time constant at low frequency, which is likely associated with the ingress of corrosive electrolyte and the degradation of the coatings.

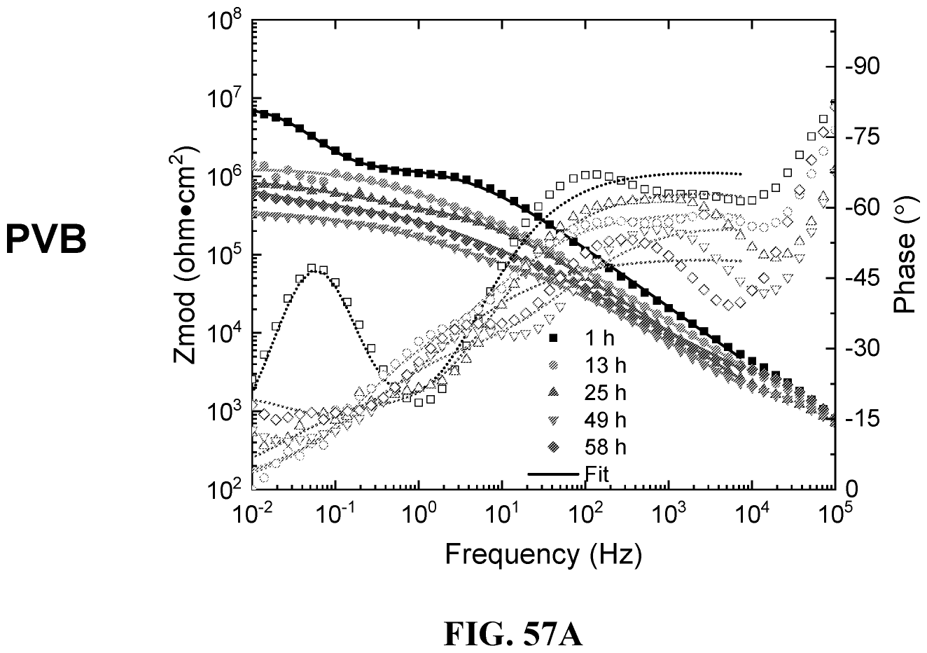

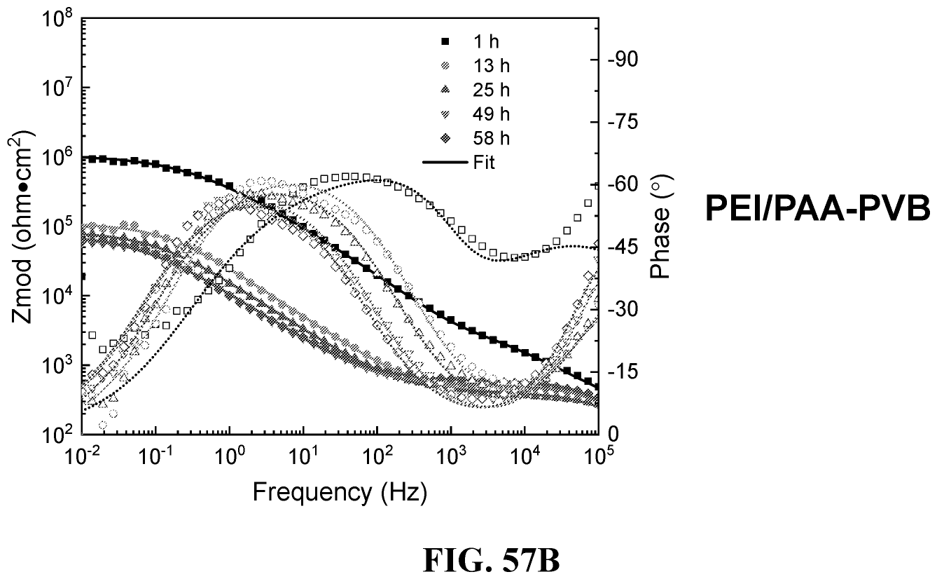

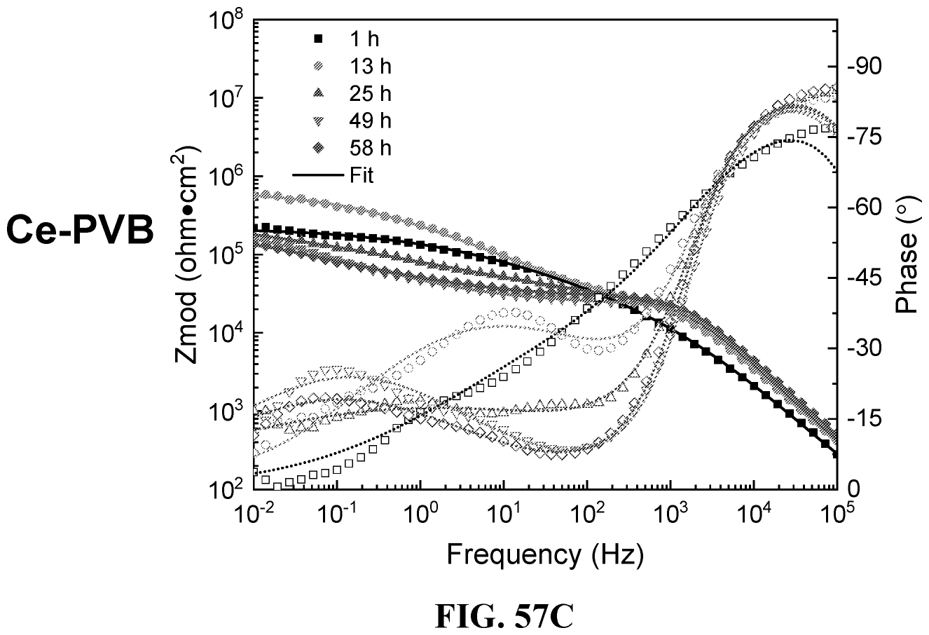

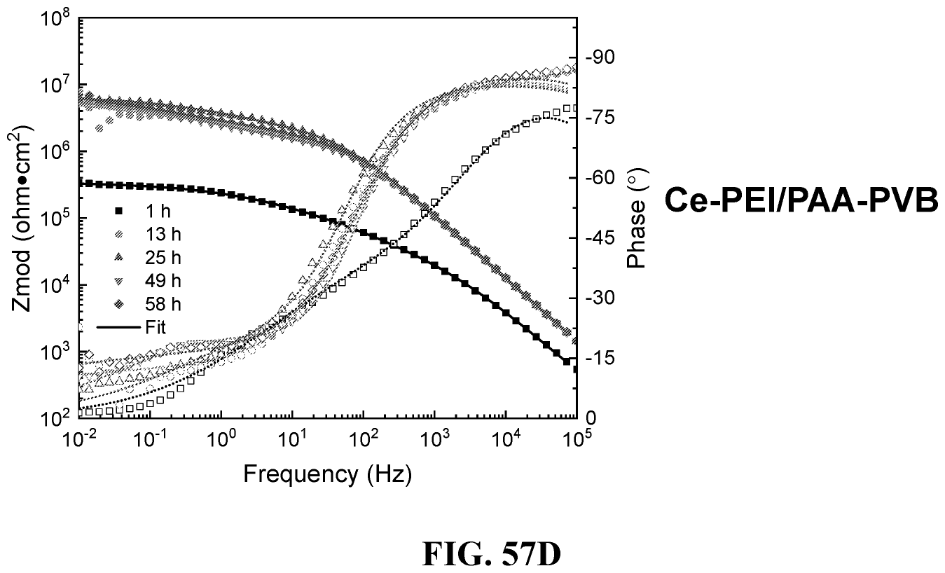

At pH 10 (FIGS. 57A-57D), the overall trend is similar to what is found at pH 2.5. In brief, the addition of Ce(NO₃)₃-loaded microspheres to the PVB coating matrix improves the corrosion resistance. On the other hand, the direct introduction of Ce(NO₃)₃ or the encapsulation of empty polyelectrolyte coacervates microspheres within the PVB coating matrix failed to enhance the corrosion protection performance of the coating system.

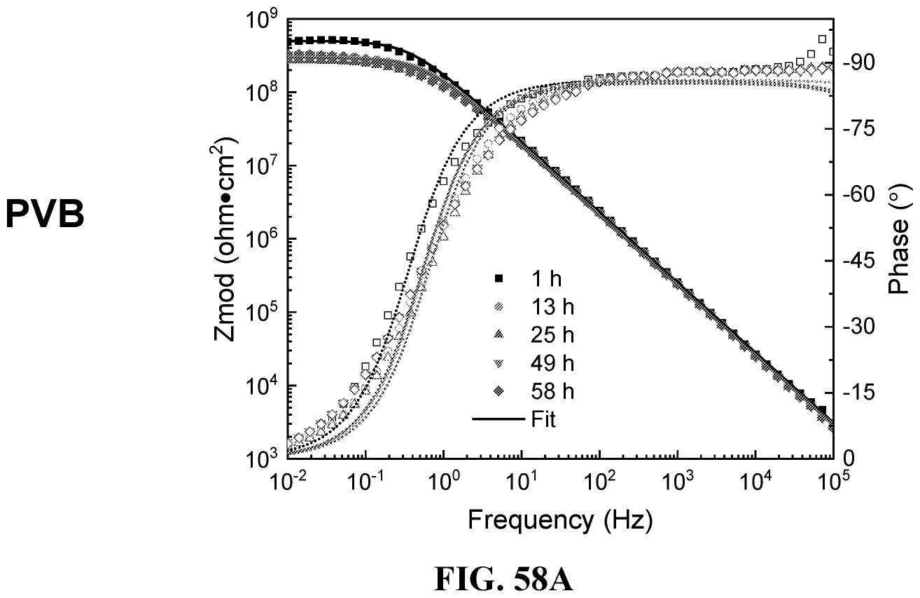

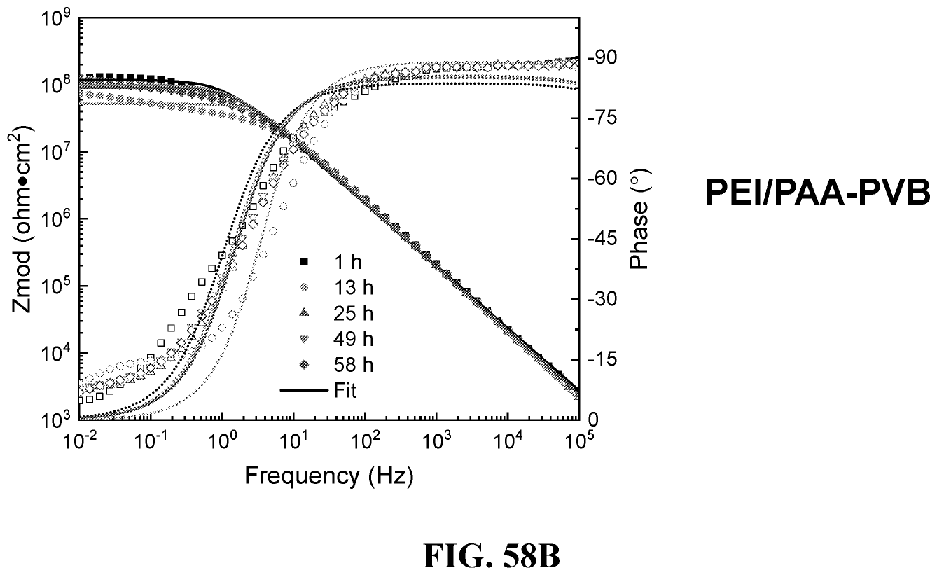

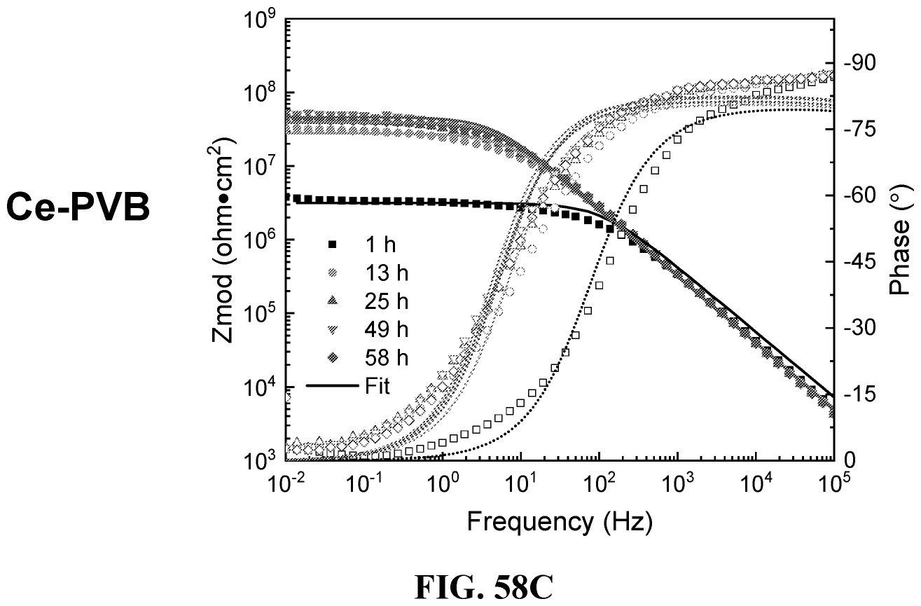

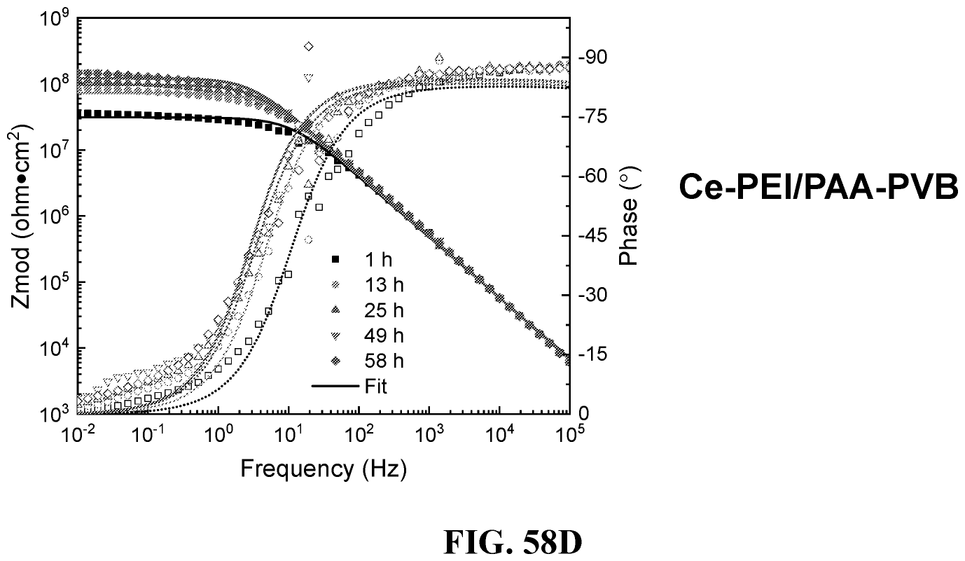

At pH 7 (FIGS. 58A-58D), the coated samples show different behavior. The impedance values of coated samples at low frequency are over one order of magnitude higher than those at acidic and basic pH conditions. The spectra do not change significantly by the end of the immersion period except for the Ce-PVB sample, which is possibly associated with the less aggressive environment under this pH condition. As for the Ce-PVB sample, the leaching of Ce(NO₃)₃ from the coating matrix and the subsequent formation of insoluble cerium oxide/hydroxide films may account for the significant increase in the impedance modulus for up to 58 h of immersion. All of the Bode phase plots exhibit one time constant that is revealed at high frequency attributable to the coating properties and no additional time constant is clearly shown at low frequency for all coatings. Moreover, the unchanged capacitive behavior of the time constant at high frequency throughout the immersion further validates the intact barrier property of all coatings.

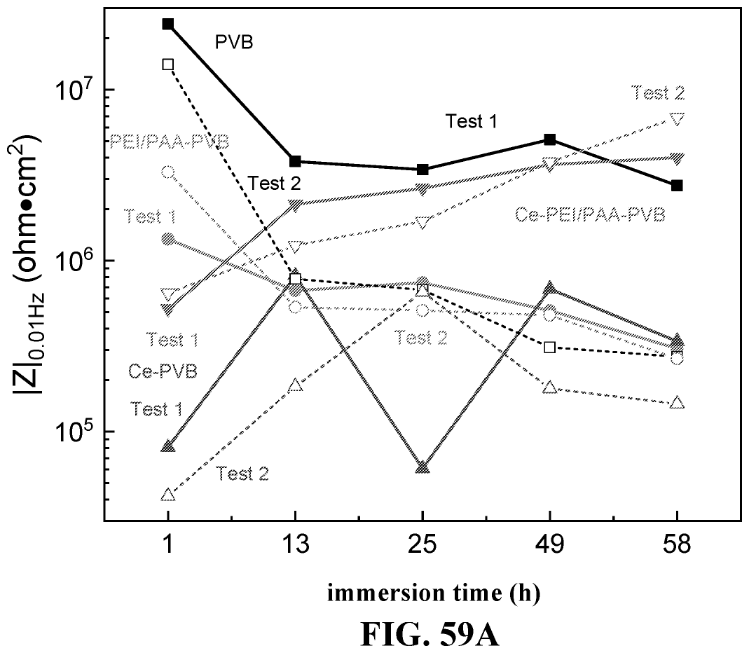

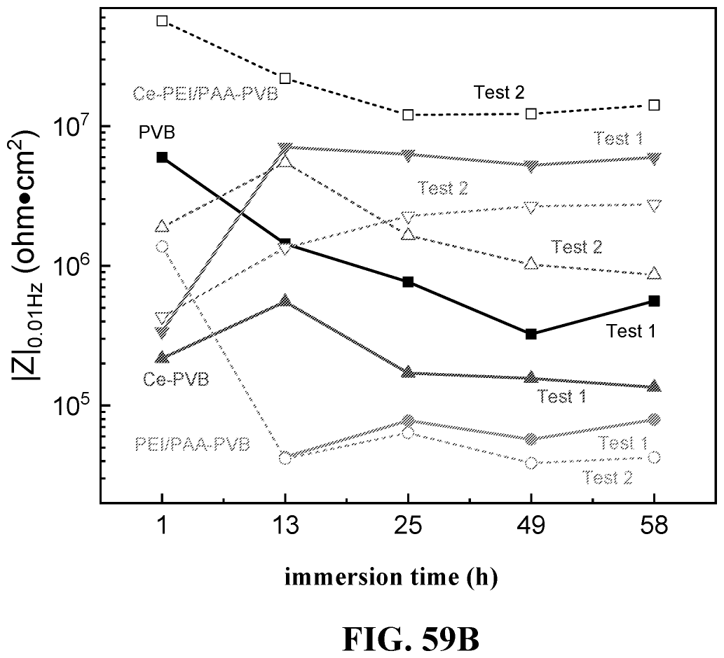

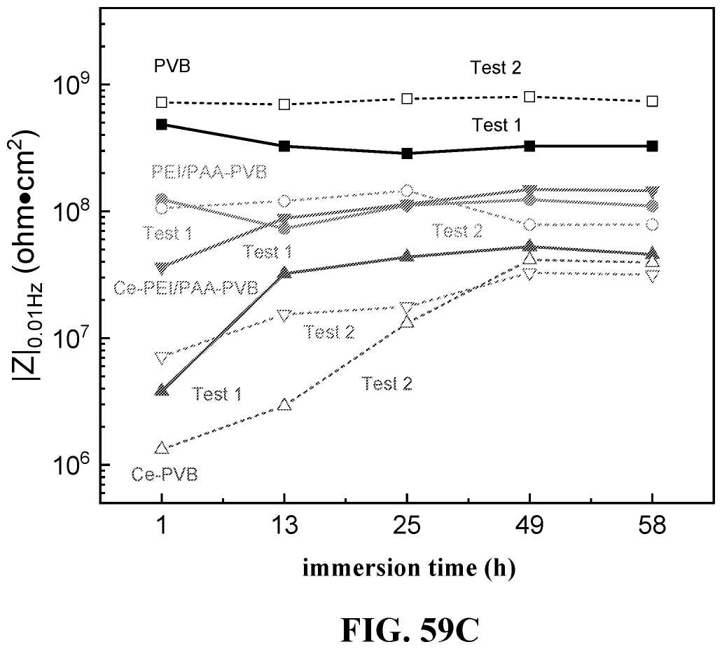

The evolution of the impedance modulus at 0.01 Hz (|Z|_{0.01 Hz}) with immersion time for different coated samples at various pH conditions is provided in (FIGS. 59A-59C). A higher value of low frequency impedance generally indicates better corrosion protection performance of a given coating system. At pH 2.5, the |Z|_{0.01 Hz} value of the PVB sample quickly dropped from 2.4×10⁷ ohm·cm² to 3.7×10⁶ ohm·cm² after 13 h immersion due to the rapid water uptake (FIG. 59A). The |Z|_{0.01 Hz} value continued decreasing to 2.7×10⁶ ohm·cm² over time, which can be attributed to the coating deterioration. A similar trend is seen in the case of PEI/PAA-PVB, indicating the polyelectrolyte coacervate cannot effectively impede the ingress of electrolyte and the coating degradation. In contrast, the |Z|_{0.01 Hz} value of Ce-PEI/PAA-PVB sample gradually increased from 5.2×10⁵ ohm·cm² to 4.0×10⁶ ohm·cm², indicating that embedding Ce(NO₃)₃-loaded microspheres in the PVB coating matrix can empower the rendered coating with superior corrosion protection performance. This may be explained by the fact that, at pH 2.5, the shell of microspheres made by polyelectrolyte coacervates can open by either swelling or dissolution so the entrapped inhibitors can be quickly released from the broken microspheres. Subsequently, local insoluble oxides/hydroxides may form on the metal surface and inhibit the charge transfer process between the cathode and anode. Additionally, the insoluble oxides/hydroxides may block the pores within the coating matrix, thereby slowing down the kinetics of water uptake by reducing the defects of the coating. Once corrosion is retarded, the release of Ce(NO₃)₃ may slow down and the inhibitors can be reserved inside the microspheres for future corrosion inhibition. Therefore, enhanced corrosion resistance for extended periods can be achieved. Notably, the |Z|_{0.01 Hz} value of Ce-PVB oscillated between 8.0×10⁴ ohm·cm² to 3.3×10⁵ ohm·cm² at pH 2.5. As shown in (FIG. 55C), Ce(NO₃)₃ forms agglomerates in the Ce-PVB coating, which may compromise the integrity of the coating matrix. The aggregation of Ce(NO₃)₃ inevitably induces an uneven distribution of inhibitors in the coating so the corrosion resistance may be weaker in locations with a lower concentration of Ce(NO₃)₃. Moreover, without the protection of the shell material serving as a diffusion barrier, Ce(NO₃)₃ can be quickly leached out. Since the corrosion inhibitors are quickly depleted within a short period of time, such coatings will not be able to provide long-term corrosion protection. Therefore, the fluctuation of |Z|_{0.01 Hz} value throughout the exposure seems to be associated with the combined effect of corrosion inhibition by the released Ce(NO₃)₃ and the re-occurrence of corrosion.

At pH 10 (FIG. 59B), the |Z|_{0.01 Hz} values of both PVB and PEI/PAA-PVB decreased over time and the trend is more evident for PEI/PAA-PVB. This is expected because the polyelectrolyte coacervates are hydrophilic, which may accelerate the water uptake of the coating. Specifically, the polyelectrolyte coacervate can swell or dissolve at alkaline pH, so the corresponding locations become susceptible sites inside the coating for the ingress of the electrolyte. Nevertheless, the corrosion protection performance was still improved when Ce(NO₃)₃ was impregnated within the microspheres. This assumption is supported by the increase of |Z|_{0.01 Hz} for Ce-PEI/PAA-PVB (from 3.4×10⁵ ohm·cm² to 6.0×10⁶ ohm·cm²) at the early stage of immersion, after which |Z|_{0.01 Hz} reached a plateau. As for Ce-PVB, |Z|_{0.01 Hz} increased and then decreased during the immersion, which can again be explained by the aggregation and fast leaching of the corrosion inhibitor.

Concerning pH 7 (FIG. 59C), |Z|_{0.01 Hz} of PVB slightly decreased from 4.8×10⁸ ohm·cm² to 3.3×10⁸ ohm·cm² over time, suggesting a slow rate of coating degradation due to the less aggressive environment. A similar degradation rate is observed for PEI/PAA-PVB. This is because at pH 7, although water may penetrate through the coating and get in contact with the embedded polyelectrolyte coacervates during the immersion, the coacervates are primarily intact due to the moderate bonding between PEI and PAA at this pH. Hence, fewer susceptible sites were generated compared to the acidic and basic pH conditions, making it difficult for aggressive species to reach the metal substrate. Due to the same reason, the release of entrapped inhibitors from the undamaged polyelectrolyte coacervates microspheres was substantially limited, resulting in a negligible increase in Z|_{0.01 Hz} of Ce-PEI/PAA-PVB after 58 h of immersion. In contrast, |Z|_{0.01 Hz} of Ce-PVB initially increased by one order of magnitude and then remained constant above 1.0×10 ohm·cm² for the rest period of immersion. This may be attributed to the rapid and uncontrolled release of Ce(NO₃)₃, which forms an insoluble film that protects the metal substrate. Due to the less corrosive environment at pH 7, the film remained stable within the short testing period so no decrease in |Z|_{0.01 Hz} was shown by the end of immersion.

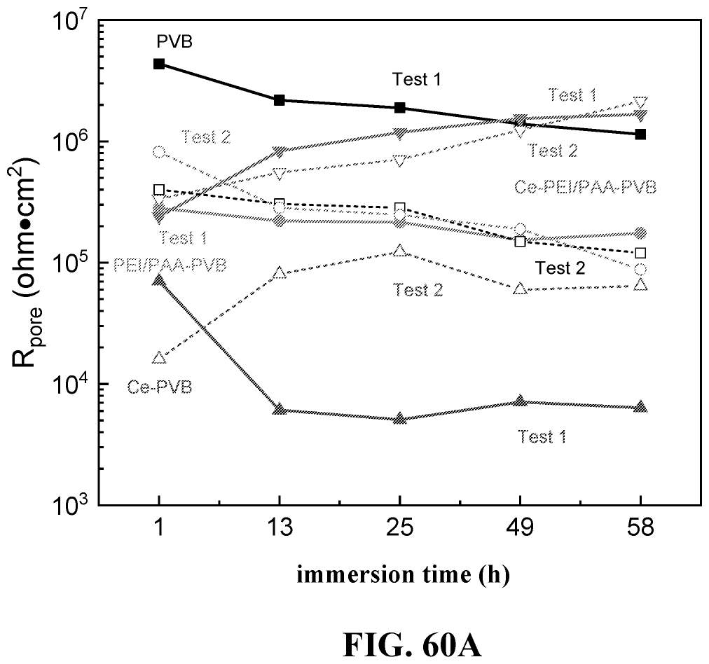

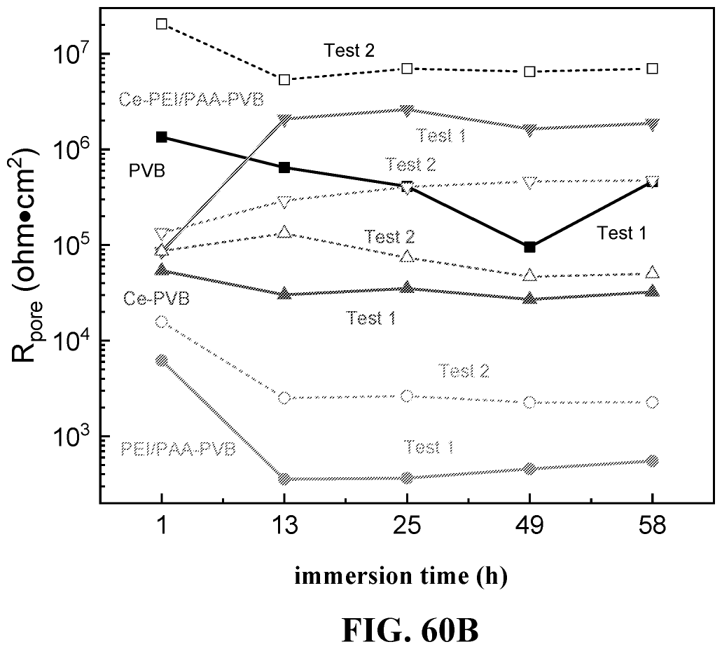

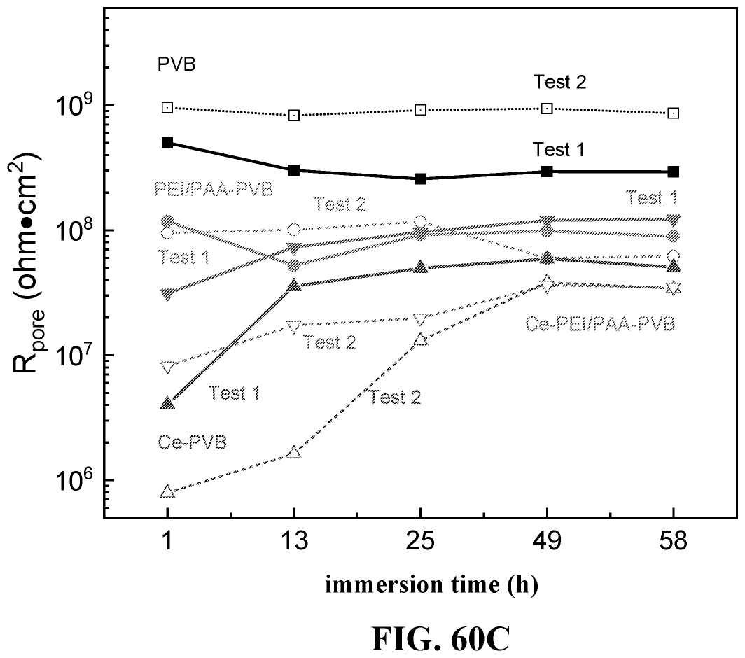

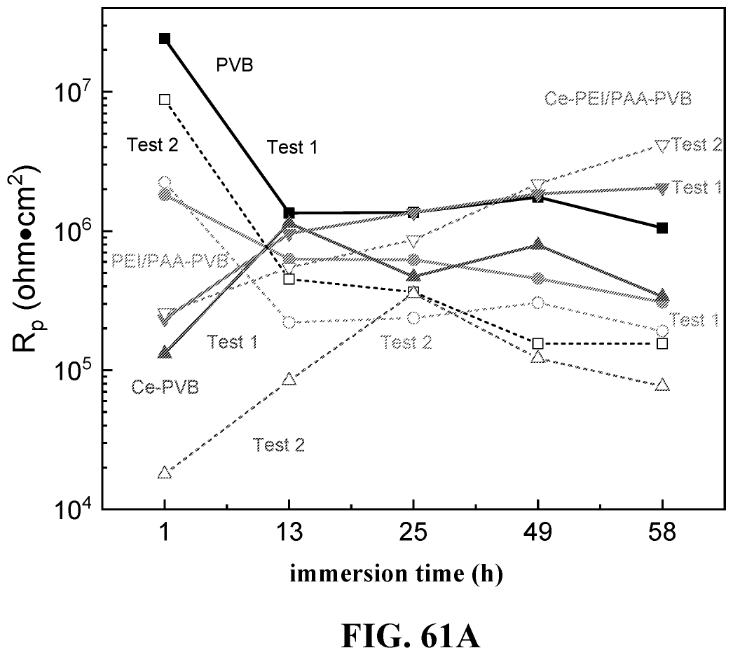

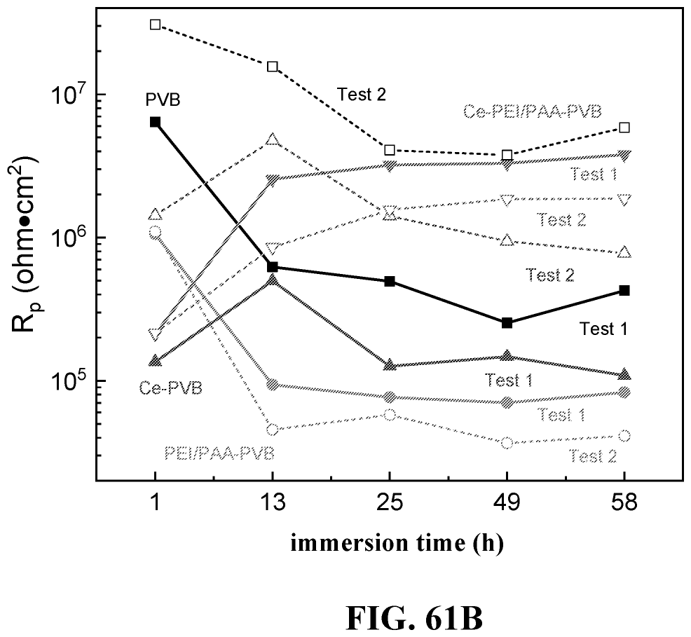

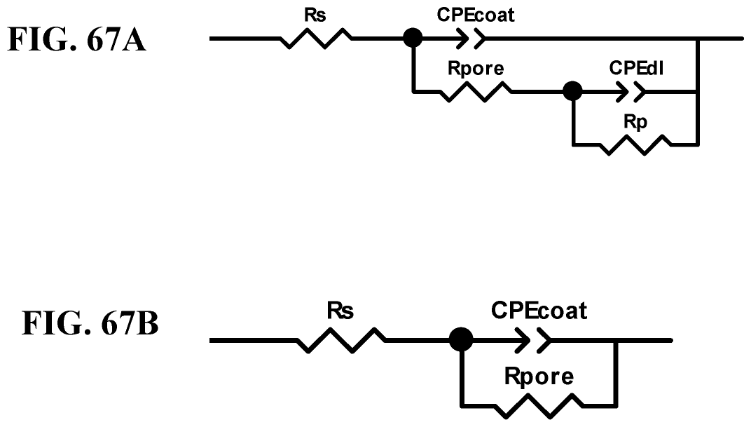

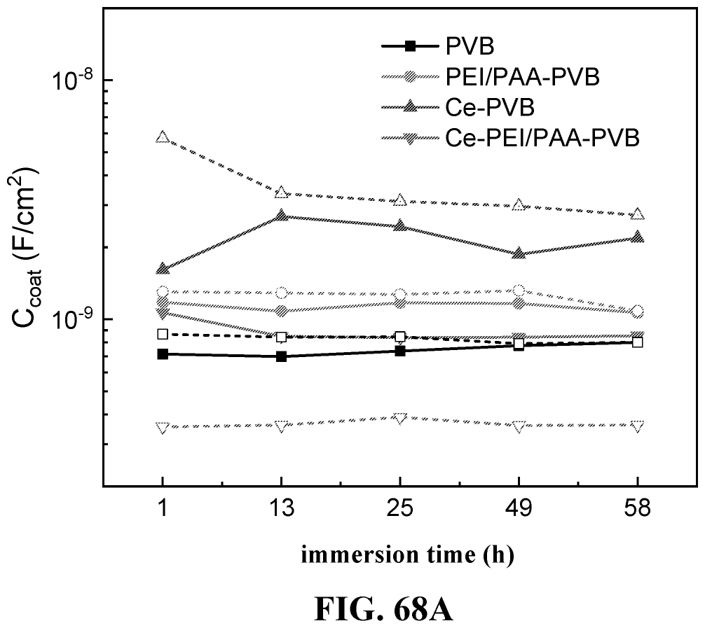

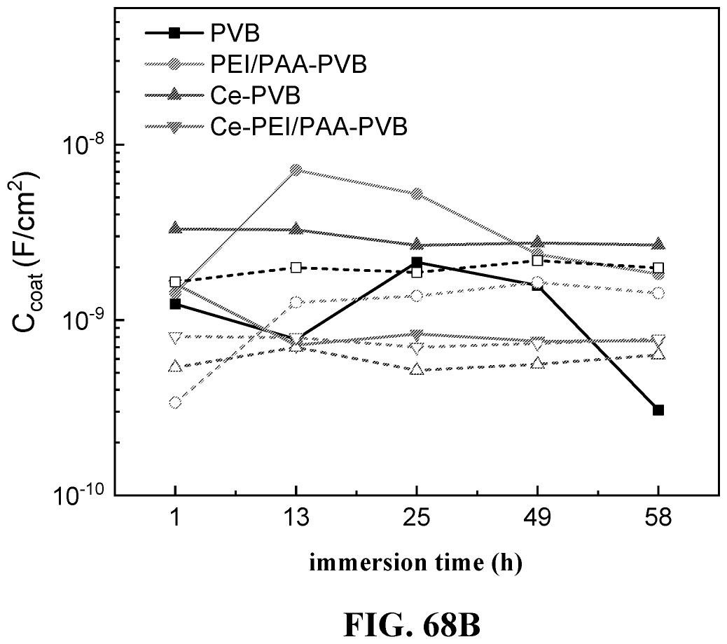

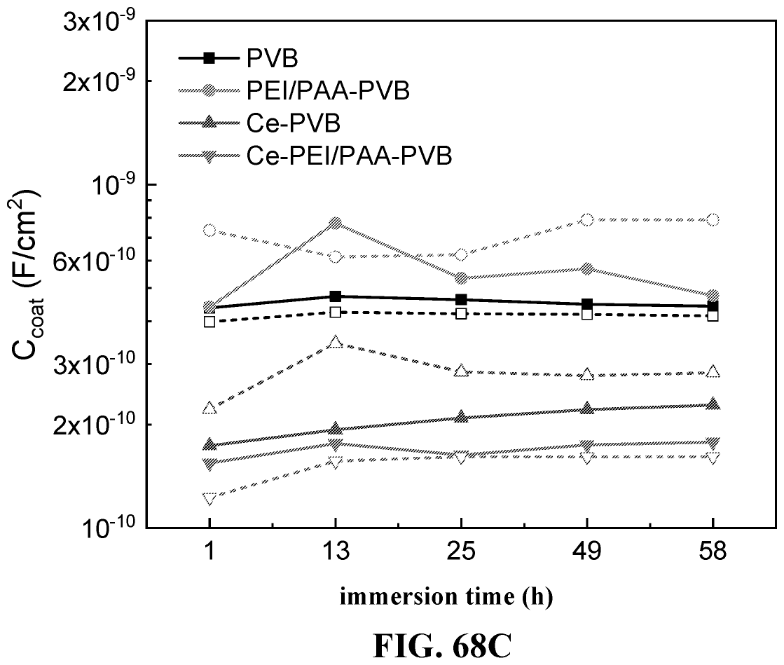

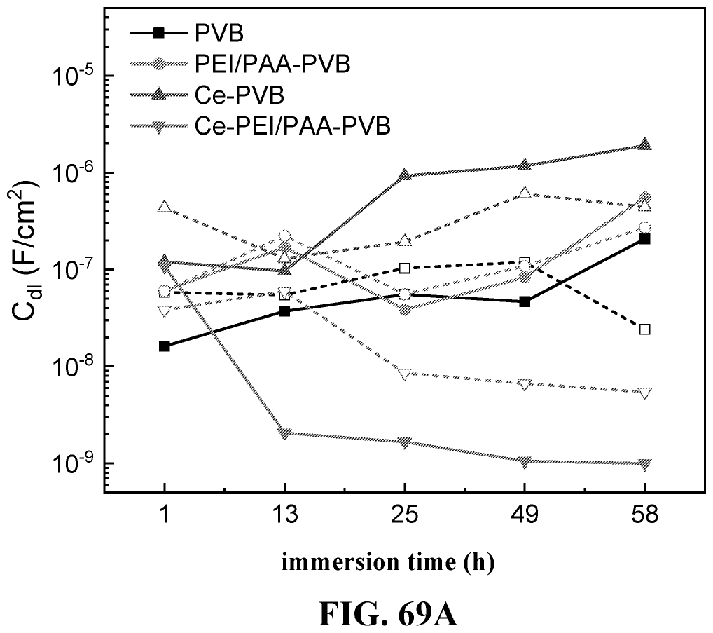

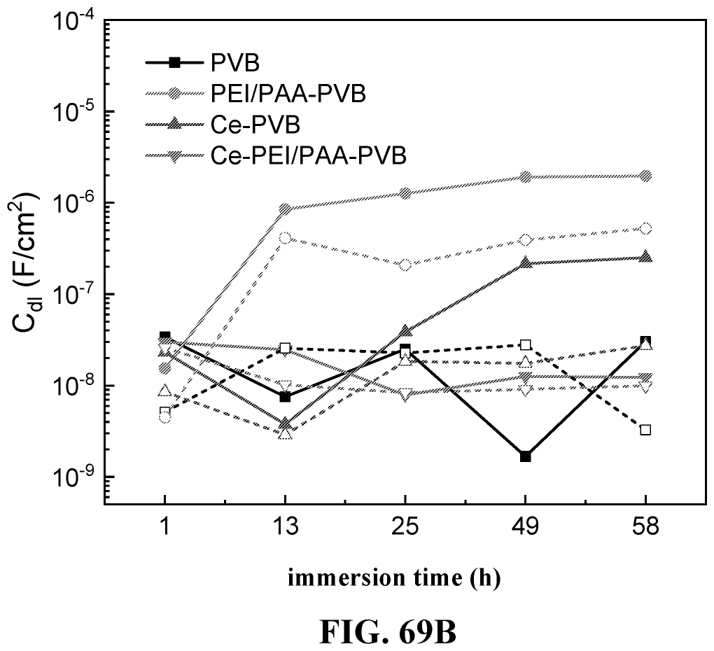

EIS spectra of all coated samples measured at different pH conditions were also analyzed by numerical fitting with equivalent circuits. An equivalent circuit with two time constants was applied to describe the samples corroded at pH 2.5 and pH 10 (FIG. 67A), while a one time-constant equivalent circuit was used to fit EIS spectra obtained at pH 7 (FIG. 67B). It should be noted that the number of time constants for selected EIS spectra may be more than that used to fit the EIS data as corrosion proceeds. For example, at pH 2.5, a third time constant likely related to the diffusion process appeared at the low frequency of the spectra for PEI/PAA-PVB after 25 h of immersion, but it was not seen for the other EIS measurements. Therefore, an equivalent circuit with two time constants was chosen to fit all EIS data at this pH condition. Due to the deviation of the phase angle from −90°, constant phase elements (CPEs) were used instead of pure capacitances to capture the non-ideal capacitive behavior. In the equivalent circuits, Rₛ is the solution resistance. Rₚₒᵣₑ and CPE_{coat} correspond to the pore resistance and the capacitance of the coatings. Rₚ stands for the polarization resistance, and CPE_{dl} describes the double layer capacitance. The actual capacitance, C_{coat} and Cal, were extracted from fitting parameters according to a method described by Hirschorn et al. The evolution of Rₚₒᵣₑ and Rₚ of the coatings at various pH conditions over time is shown in FIGS. 60 and 61 and the changes in C_{coat} and C_{dl} are presented in FIGS. 68A-68C and FIG. 69. EIS tests were repeated twice and the fitting results from the replicated experiments are shown as dashed lines in the figures.

Rₚₒᵣₑ is an important factor that reflects the resistance of defects within a given coating, so detailed information regarding the corrosion protection properties of different coatings can often be achieved by comparing the variation of Rₚₒᵣₑ over time. At pH 2.5 (FIG. 60A), Rₚₒᵣₑ decreased from 4.4×10⁶ ohm·cm² to 1.0×10⁶ ohm·cm² for PVB during the 58 h immersion. Similarly, Rₚₒᵣₑ decreased from 3.0×10⁵ ohm·cm² to 1.7×10⁵ ohm·cm² for PEI/PAA-PVB within the same period of time. This is due to the ingress of electrolyte and degradation of coating. The slow rate of decreasing in Rₚₒᵣₑ may be associated with rapid water saturation in the coating after 1 h immersion. In comparison, Rₚₒᵣₑ of Ce-PEI/PAA-PVB increased from 2.4×10⁵ ohm·cm² to 1.7×10⁶ ohm·cm² and reached the highest value among all coated samples after 58 h of immersion, which is an indication of improved corrosion resistance by the controlled release of Ce(NO₃)₃. As for Ce-PVB, no clear trend is observed in Rₚₒᵣₑ within the two replicated measurements. However, the Rₚₒᵣₑ values for Ce-PVB were always the lowest among all samples throughout the 58 h testing period. As mentioned previously, Ce(NO₃)₃ tends to aggregate in the coating, which reduces the protection properties of PVB coating as a physical barrier against metal corrosion. Furthermore, even if cerium oxides/hydroxides may deposit as a film on local cathode under acidic pH conditions, such film is more likely to be dissolved over time. Under this condition, the corrosion resistance of the coated samples cannot be restored because Ce(NO₃)₃ cannot be replenished after the quick depletion at the initial stage of immersion. It should also be noted that the incorporation of all additives, i.e., polyelectrolyte coacervates, Ce(NO₃)₃, and Ce(NO₃)₃-loaded microspheres, leads to lower Rₚₒᵣₑ values than the PVB coated sample. This suggests that pores or defects are probably generated by the incorporation of additives, and the integrity of the PVB coating matrix is compromised to some degree. This adverse effect is the most evident for Ce-PVB, which possesses the lowest Rₚₒᵣₑ and the highest C_{coat} (FIGS. 68A-68C).

A similar result was observed when various coatings were immersed at pH 10 (FIG. 60B). Like pH 2.5, the corrosive environment at pH 10 induced degradation of all coatings. Under this condition, the polymer shell made from polyelectrolyte coacervates is likely to rupture due to the weakened interactions within the polyelectrolytes, rendering rapid penetration of corrosive electrolytes into the coating through the broken microspheres. This is indicated by a large decrease in Rₚₒᵣₑ of PEI/PAA-PVB. On the other hand, the rupture of the microspheres facilitates the release of corrosion inhibitors, which can speed up the formation of cerium oxides/hydroxides to fill the pores/defects in the coating and boost the corrosion resistance. This hypothesis is supported by a significant increase in Rₚₒᵣₑ of Ce-PEI/PAA-PVB over time. As mentioned above, cerium salts suffer from quick consumption by the leaching process when they are not enclosed within the microspheres. Considering the Ce-PVB sample, the inadequate cerium salts in the coating only has a limited effect on improving its Rₚₒᵣₑ.

At pH 7 (FIG. 60C), Rₚₒᵣₑ of PVB, PEI/PAA-PVB, and Ce-PEI/PAA-PVB almost remained unchanged throughout the 58 h of immersion because of the less aggressive solution environment and the stable polymer microspheres inside the coatings. Nevertheless, Rₚₒᵣₑ of Ce-PVB remarkedly increased from 4.2×10⁶ ohm·cm² to 5.0×10⁷ ohm·cm². This is possibly due to the formation of insoluble cerium oxides/hydroxides that may have blocked pores in the coating since these pores usually serve as pathways for water penetration.

Typically, the rate of metal corrosion can be evaluated by examining the evolution of Rₚ. It is observed that at pH 2.5 (FIG. 61A) Rₚ of PVB was the highest among all coatings at the beginning but declined markedly within 13 h of immersion. After 13 h, Rₚ of PVB continuously decreased over time. The addition of the empty polyelectrolyte coacervate microspheres to the coating matrix resulted in a lower Rₚ, which means a higher corrosion rate. These empty microspheres do not enhance the corrosion resistance of the coating, which is indicated by the steady decrease of Rₚ for PEI/PAA-PVB. Nevertheless, it is shown that Rₚ of Ce-PEI/PAA-PVB gradually increased and reached a plateau of 3.0×10⁶ ohm·cm². The Rₚ value of Ce-PEI/PAA-PVB became the highest among all coating systems by the end of immersion, indicating the lowest corrosion rate. Since Ce(NO₃)₃ is enclosed within the microspheres, undesired interactions between Ce(NO₃)₃ and coating matrix are prevented and the corrosion inhibitors can also be stored for inhibiting the upcoming corrosion process. Once corrosion commences, Ce(NO₃)₃ is released from microspheres. The subsequent deposition of insoluble cerium oxides/hydroxides can passivate the metal surface, thus healing the local corrosion damage and increasing the corrosion resistance of the metal substrate. When Ce(NO₃)₃ is freely dispersed in the coating matrix, uncontrollable leaching of Ce(NO₃)₃ creates defects for the corrosive electrolytes to reach the metal substrate. Meanwhile, it also causes the depletion of corrosion inhibitors inside a coating system, leading to the compromised long-term corrosion protection performance. Therefore, it is observed that for Ce-PVB, Rₚ remained low, and the corrosion rate was relatively high throughout the EIS measurement. Similar to pH 2.5, Ce-PEI/PAA-PVB exhibited a high Rₚ and a low corrosion rate when corroded at pH 10 (FIG. 61B), thanks to the existence of Ce(NO₃)₃-loaded microspheres embedded within the PVB coating matrix. In contrast, the values of Rₚ for the other coating systems either decreased by over one order of magnitude or remained low throughout the EIS measurement, demonstrating failure in sustaining corrosion protection of AA2024-T3. Considering pH 7, only one time constant at high frequency related to the coating property was shown and no signs of corrosion activity were observed on the metal surface due to the less corrosive environment. Therefore, the comparison of Rₚ for various coating systems is not reported at this pH condition.

### EIS Measurements in NaCl Solutions

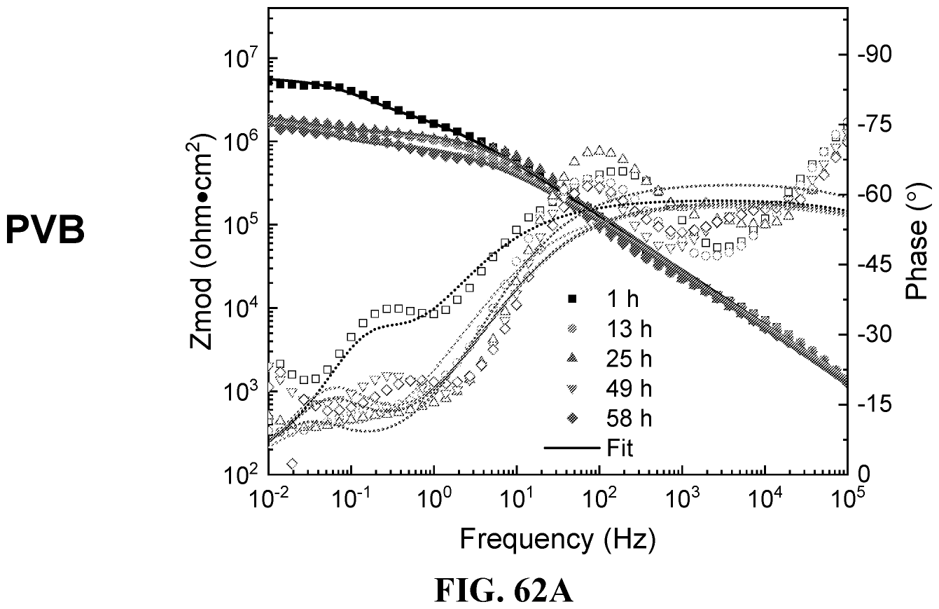

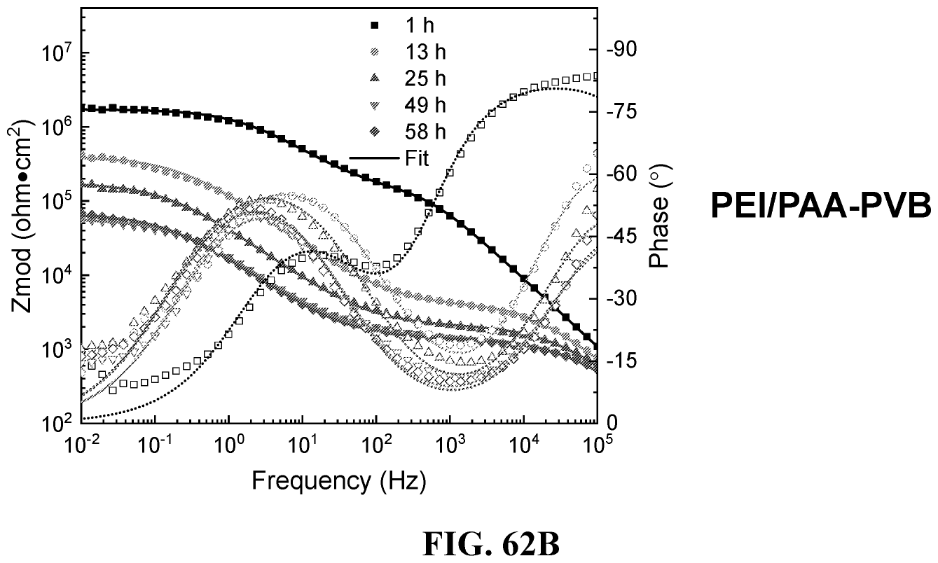

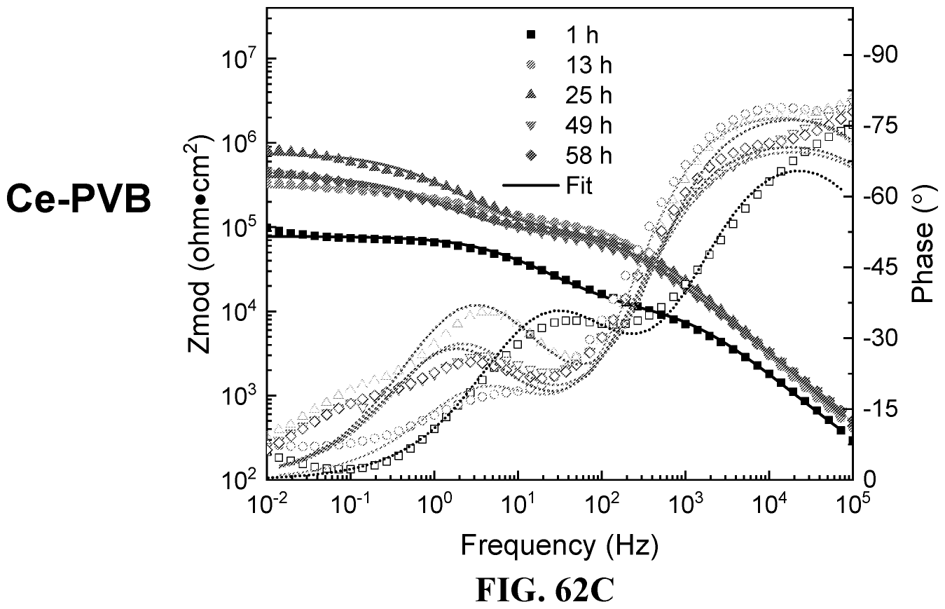

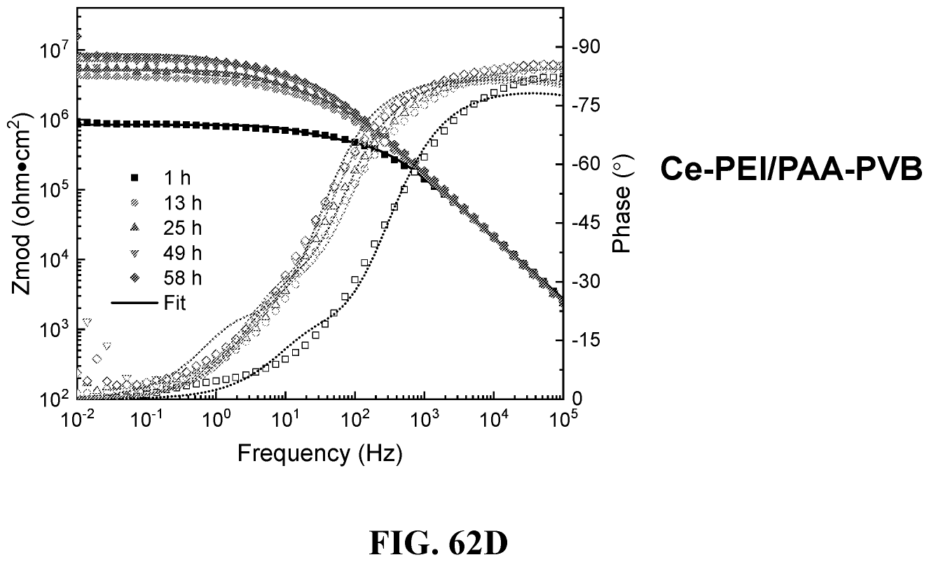

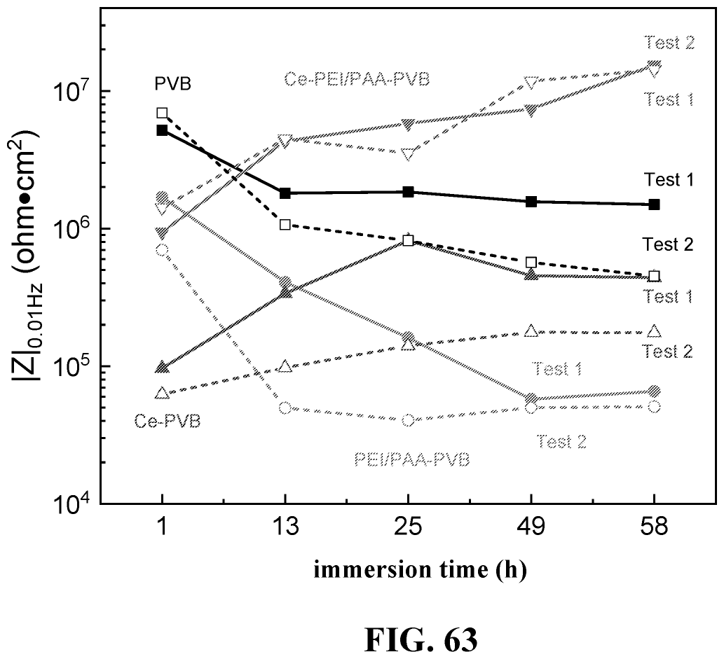

The corrosion resistance of PVB, PEI/PAA-PVB, Ce-PVB, and Ce-PEI/PAA-PVB was further studied by EIS measurements on samples exposed during 58 h in 100 mM NaCl. The Bode plots are shown in (FIG. 62), whereas the |Z|_{0.01 Hz} values at varied immersion time are given in (FIG. 63). |Z|_{0.01 Hz} of PVB decreased from 5.2×10⁶ ohm·cm² to 1.4×10⁶ ohm·cm² due to the coating deterioration. Compared to PVB, the decrease of |Z|_{0.01 Hz} for PEI/PAA-PVB was steeper and more significant. This is likely a result of the destruction of the polyelectrolyte coacervate by the local pH changes and the ingress of aggressive ions within the coating. For Ce-PVB, |Z|_{0.01 Hz} increased from 9.6×10⁴ ohm·cm² to 8.1×10⁵ ohm·cm² after 25 h immersion, followed by a decrease to 4.3×10⁵ ohm·cm². In the replicate measurement, |Z|_{0.01 Hz} continuously increased over time but the total changes were less than three-fold at the end of immersion. Additionally, Z|_{0.01 Hz} of Ce-PVB was two orders of magnitude lower than that of PVB initially and remained lower throughout the 58 h of immersion, further indicating poor corrosion protection performance. In comparison, although |Z|_{0.01 Hz} of Ce-PEI/PAA-PVB was lower than that of PVB after 1 h immersion, it continuously increased with time. The value reached 1.5×10⁷ ohm·cm² by the end of the immersion, which is one order of magnitude higher than that of PVB. Furthermore, in the Bode phase plot (FIG. 62A-62D), the time constant at high frequency is dominant and the plateau displayed at high frequency tends to broaden over time. This indicates better corrosion protection of Ce-PEI/PAA-PVB.

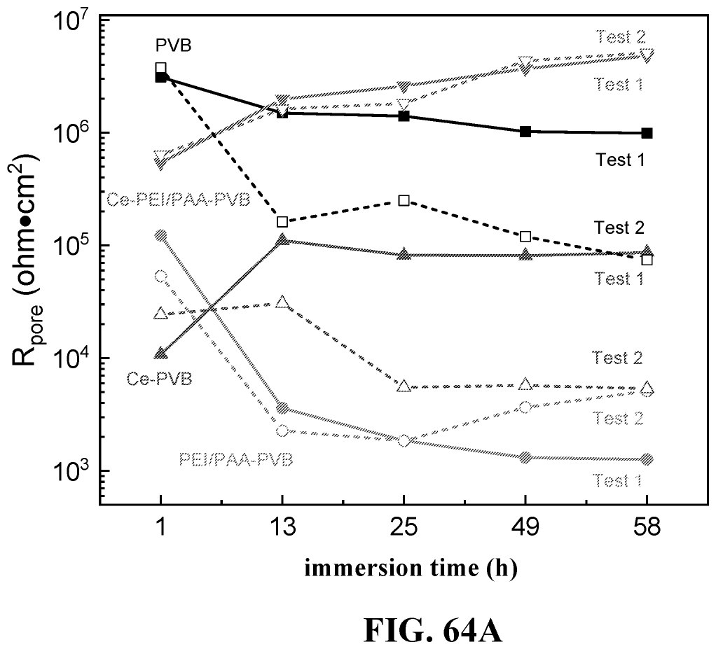

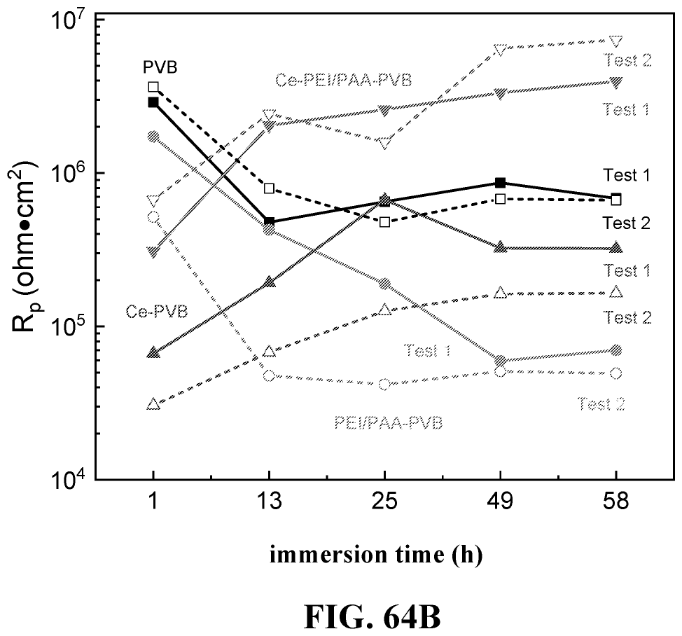

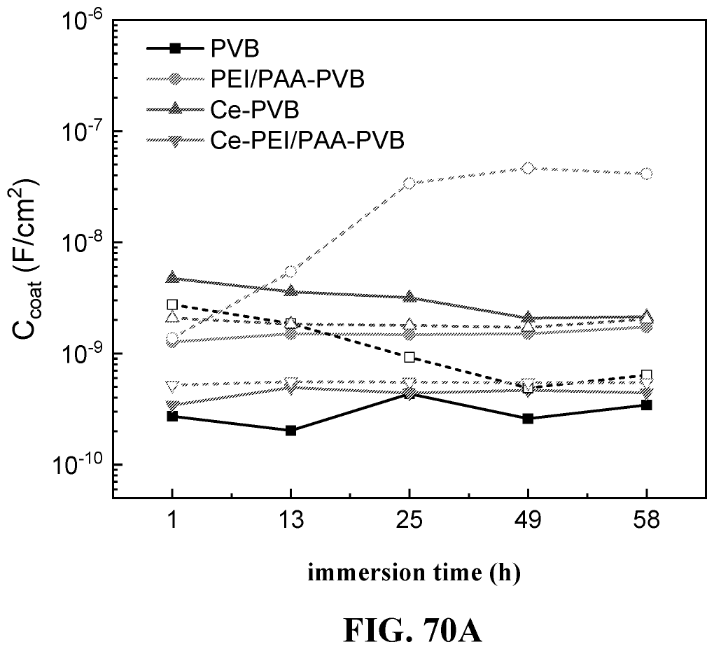

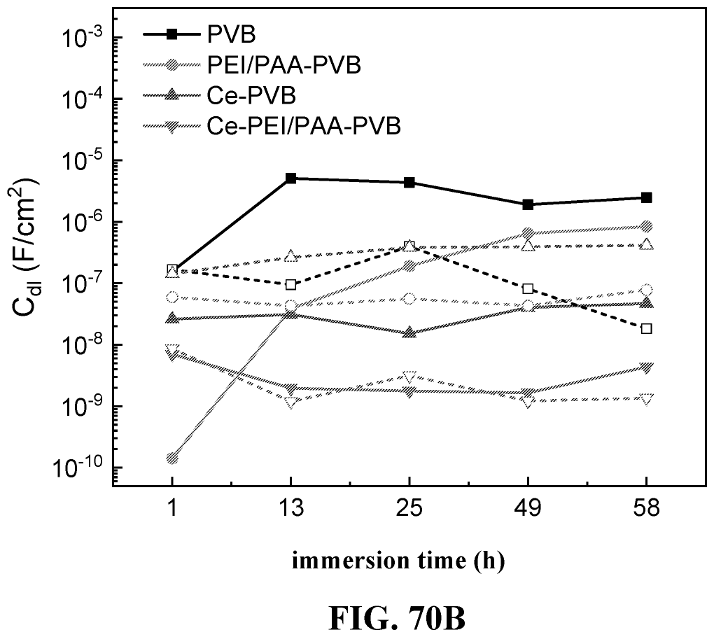

Numerical fitting was performed on EIS spectra acquired from PVB, PEI/PAA-PVB, Ce-PVB, and Ce-PEI/PAA-PVB in duplicated EIS experiments using the equivalent circuit with two time constants (FIG. 67A). To compare the corrosion performance of different coating systems, Rₚₒᵣₑ, Rₚ, C_{coat}, and C_{dl} were extracted from the fitting results and are plotted in FIGS. 64A, 64B and 70. Rₚₒᵣₑ of PVB decreased over time, especially in the repeated EIS measurement. The value greatly dropped by one order of magnitude within 13 h. Compared to PVB, the introduction of various additives into the coating matrix resulted in lower Rₚₒᵣₑ values, possibly due to the generation of pores/defects in coatings. Nevertheless, these pores/defects may be blocked by the precipitation of cerium oxides/hydroxides insoluble products, so Rₚₒᵣₑ of Ce-PEI/PAA-PVB surpassed that of PVB over time. As for Ce-PVB, an increase in Rₚₒᵣₑ is shown in the first EIS measurement on account of additional corrosion protection of Ce(NO₃)₃, but this phenomenon is not observed in the second EIS measurement. This may be related to the heterogenous distribution of Ce(NO₃)₃ inside the coating so corrosion may happen in areas where less corrosion inhibitor is stored. Rₚ of various coatings is also plotted to evaluate the corrosion activity on metal surface. As shown in (FIG. 64B), Rₚ of both PVB and PEI/PAA-PVB quickly decreased at the early stage of immersion, indicating the ingress of corrosive electrolyte to the metal substrate and the subsequent occurrence of corrosion. This observation is also consistent with the sudden increase of Cal within 13 h of immersion (FIG. 70B). On the other hand, Rₚ of Ce-PEI/PAA-PVB gradually increased and eventually became the highest among all coated samples. The corresponding C_{dl} values also remained low, ranging from 1×10⁻⁹ F/cm² to 1×10⁻⁸ F/cm² (FIG. 70B). As mentioned, the local pH changes and the presence of ions may trigger the release of Ce(NO₃)₃ from the embedded microspheres. Subsequently, the released inhibitors might form a compact barrier film on the metal surface to retard corrosion, leading to larger Rₚ and smaller C_{dl}. Notably, corrosion was not significantly impeded by directly doping Ce(NO₃)₃ into the PVB coating matrix, as illustrated by the lower Rₚ values relative to those of PVB. These EIS results again prove that superior corrosion protection performance can be accomplished by encapsulating Ce(NO₃)₃ within polymer microspheres and dispersing these inhibitor-loaded microspheres into the polymer coating matrix.

1. A pH-sensitive release system comprising:
a capsule comprising at least two weak polyelectrolytes that responds to both low pH and high pH changes and
an SrCrO₄ agent encapsulated within the capsule,
wherein the SrCrO₄ agent is released from the capsule when an environmental pH level changes to either a low pH or a high pH.

2. The pH-sensitive release system of claim 1, wherein the at least two of the polyelectrolytes comprise polyethylenimine (PEI) and polyacrylic acid (PAA).

3. The pH-sensitive release system of claim 2 wherein the capsule is a nano-capsule or a micro-capsule.

4. The pH-sensitive release system of claim 2 wherein a molar ratio of PEI to PAA is about 1:1.

5. The pH-sensitive release system of claim 2 wherein a molar ratio of PEI to PAA is about 2:1.

6. The pH-sensitive release system of claim 2 wherein a molar ratio of PEI to PAA is about 1:2.

7. The pH-sensitive release system of claim 1 wherein the system further includes a coating comprising the capsule.

8. The pH-sensitive release system of claim 7 wherein the coating is a coating for a metal substrate.

9. A method of forming a pH-sensitive release system comprising:
preparing a polyelectrolyte coacervate comprising at least two weak polyelectrolytes;
filling one portion of an electrospray apparatus with the polyelectrolyte coacervate;
filling a second, separate portion of the electrospray apparatus with an SrCrO₄ agent; and
ejecting the polyelectrolyte coacervate and the SrCrO₄ agent through a coaxial nozzle operatively connected to the electrospray apparatus,
wherein the polyelectrolyte coacervate forms a capsule having a polymer shell that is impregnated with the SrCrO₄ agent.

10. The method of claim 9, wherein at least two of the weak polyelectrolytes comprise polyethylenimine (PEI) and polyacrylic acid (PAA).

11. The method of claim 10, wherein the SrCrO₄ agent further comprises a corrosion inhibitor.

12. The method of claim 11 wherein the SrCrO₄ agent further comprises sodium vanadate.

13. The method of claim 9 wherein the pH-sensitive release system comprises:
a first layer of an organic coating;
the capsule; and
a second layer of the organic coating,
wherein the capsule is between the first layer and the second layer.

14. The method of claim 13 wherein the organic coating is an polyvinyl butyral coating.
